(19) United States
(12) Patent Application Publication
(10) Pub. No.: US 2021/0286353 A1
(43) Pub. Date: Sep. 16, 2021

(54) MOVING BODY MANIPULATION SYSTEM

(71) Applicant: Honda Motor Co., Ltd., Tokyo (JP)

(72) Inventors: Toru TAKENAKA, Saitama (JP); Shinya SHIROKURA, Saitama (JP)

(73) Assignee: Honda Motor Co., Ltd., Tokyo (JP)

(21) Appl. No.: 17/195,670

(22) Filed: Mar. 9, 2021

(30) Foreign Application Priority Data
Mar. 10, 2020 (JP) 2020-041314

(51) Int. Cl. G05D 1/00; B25J 3/04; B25J 13/04; G05D 1/08

(52) U.S. Cl. CPC G05D 1/0016; G05D 1/0891; B25J 13/04; B25J 3/04

(57) ABSTRACT

A moving body manipulation system is provided. A master device that manipulates a slave device includes an upper body support portion mounted on a base and foot mounts. When a manipulator on a master device performs a walking operation, a control device controls an operation of the master device so that a lateral position of the foot mount on a free leg side follows a foot on a free leg side of the manipulator and an upper body support portion relatively moves with respect to the foot mount on a support leg side along with the base while suppressing a lateral position of the base from deviating from a reference position.

### CROSS-REFERENCE TO RELATED APPLICATION

This application claims the priority of Japan patent application serial no. 2020-041314, filed on Mar. 10, 2020. The entirety of the above-mentioned patent application is hereby incorporated by reference herein and made a part of this specification.

### BACKGROUND

### Technical Field

The disclosure relates to a system device that manipulates a moving body.

### Description of Related Art

As a device that manipulates a moving body such as a robot, for example, one described in Patent Document 1 is known. This manipulation device includes a saddle which is supported by an upper body support mechanism to be movable and a foot bottom support mechanism which is attached to left and right feet of a manipulator sitting on the saddle. When the manipulator moves the foot bottom support mechanism to perform a walking operation, both legs of a robot which is a moving body are moved (as a walking motion) by bilateral control so that the robot moves.

Further, as the moving body manipulation device, a remote controller in which a manipulator performs a manipulation operation with his/her hand is also generally known.

### Patent Documents

[Patent Document 1] Japanese Patent Application Laid-Open No. H10-217159

### SUMMARY

A moving body manipulation system of the disclosure is a moving body manipulation system capable of manipulating a slave device which is a moving body to move, the moving body manipulation system including: a master device which includes a base movable on a floor surface, a first actuator capable of generating a driving force for moving the base on the floor surface, an upper body support portion mounted on the base to be movable together with the base and attachable to an upper body of a manipulator, two foot mounts mounted on the base to be movable in a lateral direction with respect to the base and capable of grounding two feet of the manipulators wearing the upper body support portion, and a second actuator capable of generating a driving force for moving each of the two foot mounts with respect to the base in the lateral direction; and a control device which has a function of controlling operations of the slave device and the master device, wherein the control device is configured to have a function of executing an A process and a B process. The A process controls operations of the first actuator and the second actuator so that when the manipulator wearing the upper body support portion moves each foot to perform a walking operation of intermittently grounding each foot to a corresponding foot mount, a lateral position of the foot mount on a free leg side which is the foot mount corresponding to the foot on a free leg side of the manipulator follows a lateral position of the foot on the free leg side of the manipulator and the upper body support portion relatively moves in the lateral direction with respect to the foot mount on a support leg side together with the base while suppressing a lateral position of the base or the upper body support portion in a movement environment of the base from deviating from a predetermined lateral reference position in accordance with the movement of the upper body of the manipulator in the lateral direction with respect to the foot mount on the support leg side which is the foot mount for grounding the foot on a support leg side of the manipulator. The B process controls an operation of the slave device so that the slave device moves in response to a movement of the upper body support portion with respect to the foot mount on the support leg side.

Additionally, in the disclosure, the “lateral direction” means the horizontal direction or the substantially horizontal direction.

### BRIEF DESCRIPTION OF THE DRAWINGS

FIG. 1 is a perspective view showing a configuration of a slave device (moving body) of a first embodiment.

FIG. 2 is a block diagram showing a configuration related to operation control of the slave device of the first embodiment.

FIG. 3 is a perspective view showing a configuration of a master device of the first embodiment.

FIG. 4 is a perspective view showing the master device of the first embodiment and a manipulator moving the master device.

FIG. 5 is a block diagram showing a configuration related to operation control of the master device of the first embodiment.

FIG. 6 is a block diagram showing a configuration related to the operation control of the master device of the first embodiment.

FIG. 7 is a flowchart showing a process of a main manipulation control unit shown in FIG. 5.

FIG. 8 is a flowchart showing a process of STEP 3 of FIG. 7.

FIG. 9 is a flowchart showing a process of a slave movement control unit shown in FIG. 2.

FIG. 10 is a flowchart showing a process of a master movement control unit shown in FIGS. 6 and 7.

FIG. 11 is a flowchart showing a process of STEP 25 of FIG. 10.

FIG. 12A is an explanatory diagram related to the operation control of the slave device and FIG. 12B is an explanatory diagram related to the operation control of the master device.

FIG. 13 is a block diagram showing a process of STEP 21 of FIG. 10.

FIG. 14 is a block diagram showing the process of STEP 21 of FIG. 10.

FIG. 15 is an explanatory diagram related to the process of STEP 21 of FIG. 10.

FIG. 16 is an explanatory diagram related to the process of STEP 21 of FIG. 10.

FIG. 17 is an explanatory diagram showing an operation example of the master device.

FIG. 18 is an explanatory diagram showing an operation example of the master device.

FIG. 19 is an explanatory diagram showing an operation example of the master device.

FIG. 20 is a front view showing a configuration of a slave device (moving body) of a second embodiment.

FIG. 21 is a block diagram showing a configuration related to operation control of the slave device of the second embodiment.

FIG. 22 is a block diagram showing a configuration related to operation control of a master device of the second embodiment.

FIG. 23 is a block diagram showing a configuration related to the operation control of the master device of the second embodiment.

FIG. 24 is a flowchart showing a process of a master control unit shown in FIGS. 22 and 23.

FIG. 25 is a flowchart showing a process of a slave control unit shown in FIG. 21.

FIG. 26 is an explanatory diagram showing an operation example of the master device of the second embodiment.

FIG. 27 is a block diagram showing a configuration related to operation control of a slave device of a third embodiment.

FIG. 28 is a block diagram showing a configuration related to operation control of a master device of the third embodiment.

FIG. 29 is a flowchart showing a process of a master control unit shown in FIG. 28.

FIG. 30 is an explanatory diagram of a dynamics model used in STEP 48a of FIG. 29.

### DESCRIPTION OF THE EMBODIMENTS

However, in the manipulation device disclosed in Patent Document 1, since the manipulator moves the foot bottom support mechanism while sitting on the saddle and attaching the foot bottom support mechanism to each foot, the moving method is likely to be different from the method of moving both legs during the actual walking operation of the manipulator. Further, the moving velocity or moving direction of the moving body is likely to be different from the moving velocity or moving direction assumed by the manipulator.

Further, since the manipulator needs to sufficiently recognize a corresponding relationship between the operation of the remote controller and the operation of the moving body when manipulating the moving body using the remote controller, a high degree of skill is required to perform a desired operation of the moving body. For this reason, it is difficult to stably perform the desired operation of the moving body.

Here, the present inventor has developed a manipulation system in which a manipulator can perform a walking operation (a walking operation of intermittently grounding each foot of the manipulator to a floor surface) as in a normal walking operation on a floor surface while an upper body support portion is attached to an upper body of the manipulator and moves a moving body in response to the movement of the upper body support portion due to the walking operation. In such a manipulation system, since the manipulator can comfortably and smoothly perform a normal walking operation in order to manipulate the movement of the moving body, the moving body can be easily moved without skillful manipulation for the movement.

However, in such a manipulation system, the manipulator also needs to continuously move (walk) in a certain direction in order to continuously move the moving body in a certain direction. Then, when the movement environment of the manipulator is a relatively narrow environment such as indoors, the movable range of the manipulator is limited to a narrow range. Further, the moving body cannot be moved in a wide range.

The disclosure has been made in view of such a background and an objective is to provide a manipulation system capable of smoothly performing a continuous walking operation by a manipulator to move a moving body in a wide range even when an environment of performing a manipulator's walking operation for moving the moving body is a relatively narrow environment.

### First Embodiment

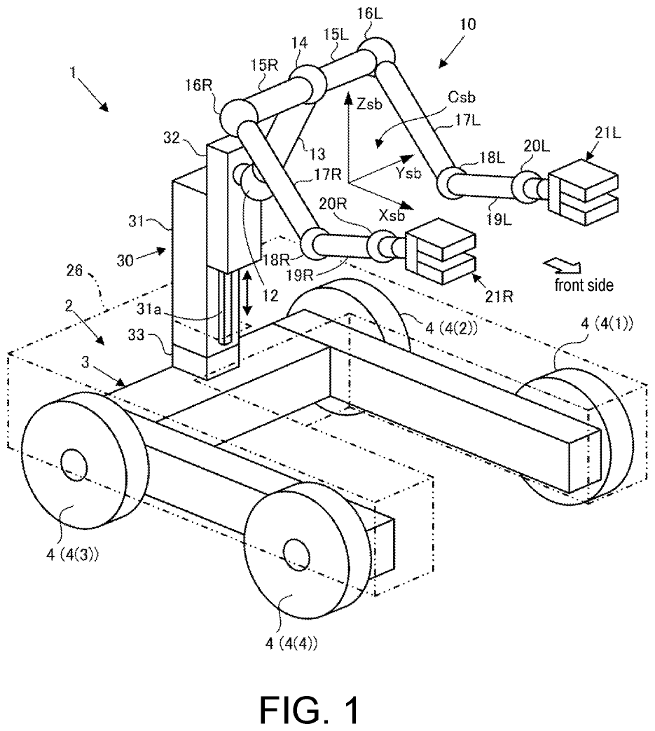

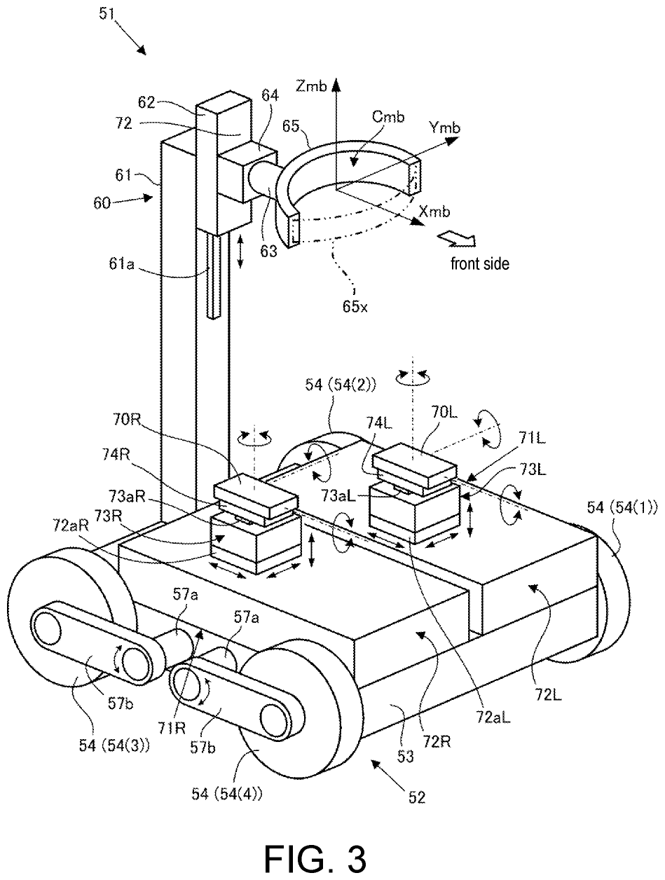

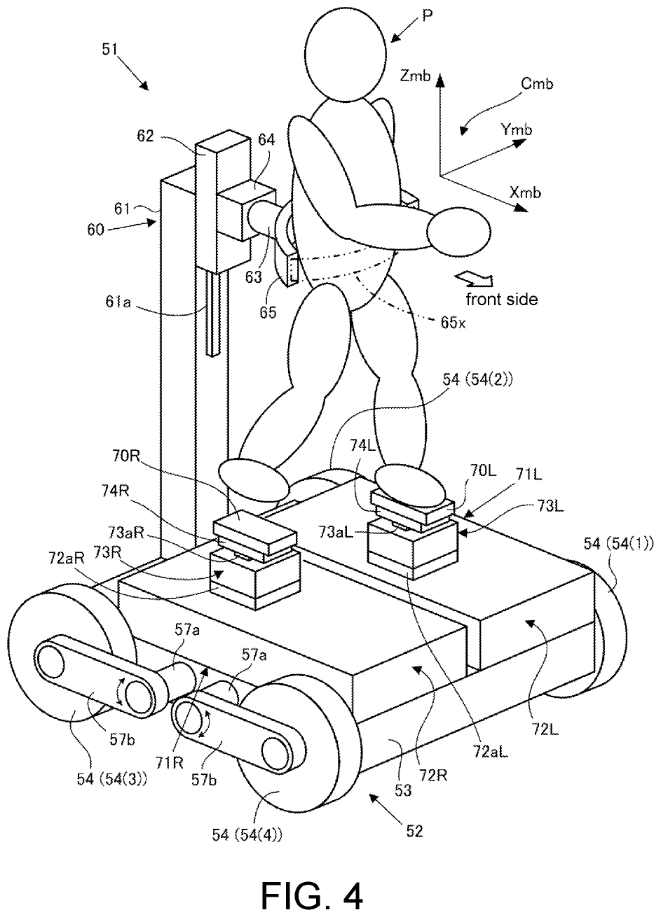

A first embodiment of the disclosure will be described below with reference to FIGS. 1 to 19. In this embodiment, as an example of the disclosure, a manipulation system that manipulates the movement of a moving body 1 shown in FIG. 1 by a manipulation device 51 shown in FIGS. 3 and 4 will be described. In the description below, the moving body 1 of the manipulation object is referred to as a slave device 1 and the manipulation device 51 for manipulating the slave device 1 is referred to as a master device 51.

Further, in the following description (including other embodiments described below), one in which “actual” is added to the beginning of the name of the arbitrary state quantity (position, velocity, force, or the like) or the subscript “_act” is added to the reference sign of the state quantity means the actual value of the state quantity or the observed value (detected value or estimated value) thereof. Further, one in which “target” is added to the beginning of the name of the arbitrary state quantity or the subscript “_aim” is added to the state quantity means the target value of the state quantity.

Further, the “movement” of the arbitrary object means any one state quantity of the position, the velocity (translational velocity), the acceleration (translational acceleration), the posture angle, the angular velocity, and the angular acceleration of the object, a set of two or more state quantities, or a time series of these state quantities. The “position” of the object is the position of the representative point of the object arbitrarily set (defined) in the object. Further, the “posture angle” of the object is an angle representing the spatial posture of the object as seen in a certain coordinate system. The “posture angle” is represented by, for example, Euler angles.

Regarding the “posture angle”, the posture angle in the direction (so-called yaw direction) around the axis in the up-down direction (the vertical direction or the substantially vertical direction) may be referred to as the “direction” and the posture angle in the direction (for example, the roll direction or the pitch direction) around the axis in the lateral direction (the horizontal direction or the substantially horizontal direction) may be referred to as the “tilt”, the “tilt posture”, or the “tilt angle”. Further, “the posture angle” may be simply referred to as the “posture”. Further, a set of the “position” and the “posture angle” of the object may be simply referred to as the “position posture”.

[Configuration of Slave Device]

Referring to FIG. 1, the slave device 1 includes a movement mechanism 2 which is movable on a floor surface of the operation environment and a manipulator 10 which is mounted on the movement mechanism 2. Additionally, in the present specification, the “floor surface” is not limited to the floor surface in the usual sense and may include the ground, the road surface, and the like. Then, in the description below, the floor of the operation environment of the slave device 1 is referred to as a “slave floor”.

Further, in the description below, the “front-rear direction”, the “left-right direction”, and the “up-down direction” of the slave device 1 are respectively an Xsb-axis direction, a Ysb-axis direction, and a Zsb-axis direction of a three-axis Cartesian coordinate system Csb shown in FIG. 1. Further, the “roll direction”, the “pitch direction”, and the “yaw direction” of the slave device 1 respectively mean the direction around the axis (around the Xsb axis) of the front-rear direction, the direction around the axis (around the Ysb axis) of the left-right direction, and the direction around the axis (around the Zsb axis) of the up-down direction of the slave device 1. Additionally, the three-axis Cartesian coordinate system Csb is a slave upper body coordinate system to be described later, but the detail will be described later.

Further, in order to distinguish the left and right components of the slave device 1, “L” and “R” are respectively added to the reference sign of the left component and the reference sign of the right component. However, when it is not necessary to distinguish the left and right, the addition of “L” and “R” to the reference sign is omitted.

The movement mechanism 2 includes a base 3 and a plurality of moving grounding portions 4 attached to the base 3 and the plurality of moving grounding portions 4 are grounded to the slave floor surface with a gap between the base 3 and the slave floor. Additionally, the shape of the base 3 is not limited to the shape of the example shown in the drawing and may be an arbitrary shape.

The movement mechanism 2 includes, for example, four moving grounding portions 4 (1), 4 (2), 4 (3), and 4 (4) as the plurality of moving grounding portions 4. Then, two moving grounding portions 4 (1) and 4 (4) are attached to both left and right sides of the front portion of the base 3 and two moving grounding portions 4 (2) and 4 (3) are attached to both left and right sides of the rear portion of the base 3.

Each moving grounding portion 4 is simply described in a wheel shape in FIG. 1, but specifically, the moving grounding portion is configured to be movable forward on the slave floor surface while being grounded to the slave floor surface. Specifically, each moving grounding portion 4 has the same structure as the main wheel described in, for example, Japanese Patent Application Laid-Open No. 2013-237329 or U.S. Pat. No. 9027693. For this reason, the detailed description of each moving grounding portion 4 and the drive mechanism thereof in the present specification will be omitted.

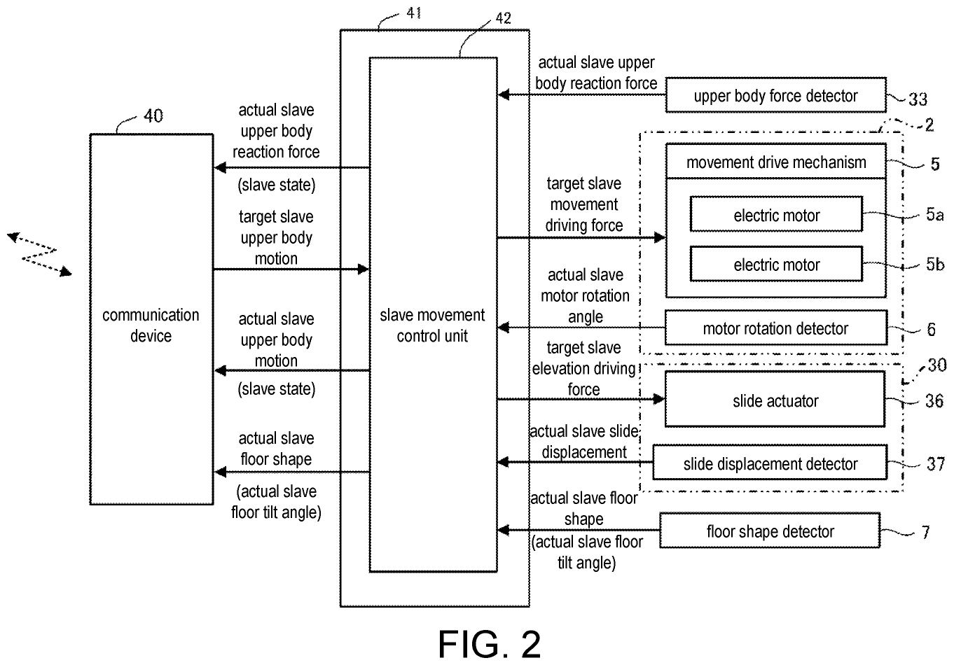

Although not shown in detail, a movement drive mechanism 5 (shown in FIG. 2) including two electric motors 5a and 5b (shown in FIG. 2) as moving power sources (actuators) are mounted for each moving grounding portion 4 on the movement mechanism 2 including such a moving grounding portion 4. Then, the movement drive mechanism 5 corresponding to each moving grounding portion 4 is configured to move the moving grounding portion 4 forward on the slave floor surface by transmitting power from two electric motors 5a and 5b to the moving grounding portion 4 as described in Japanese Patent Application Laid-Open No. 2013-237329 or U.S. Pat. No. 9027693.

In this case, each moving grounding portion 4 is driven so that the velocity component in the front-rear direction (the Xsb-axis direction) of the slave device 1 in the moving velocity vector becomes a velocity proportional to the sum of the rotational velocity values of two electric motors 5a and 5b and the velocity component in the left-right direction (the Ysb-axis direction) becomes a velocity proportional to a difference between the rotational velocity values of two electric motors 5a and 5b.

Additionally, each moving grounding portion 4 which is movable forward is not limited to one described in Japanese Patent Application Laid-Open No. 2013-237329 or U.S. Pat. No. 9027693 and may have other structures such as an omni wheel (registered trademark). Further, the number of the moving grounding portions 4 provided in the movement mechanism 2 is not limited to four and may be, for example, three or five or more. Further, the power source of each moving grounding portion 4 is not limited to the electric motors 5a and 5b and can be, for example, a hydraulic actuator.

The manipulator 10 is attached to the base 3 via an elevating mechanism 30. The elevating mechanism 30 includes a support column 31 which is erected upward at the center portion of the rear portion of the base 3 (the center portion in the left-right direction) and a slide member 32 which is assembled to be movable (elevatable) in the up-down direction with respect to the support column 31.

In this case, the support column 31 is attached to the base 3 via a force detector 33. The force detector 33 is for detecting an actual slave upper body reaction force which is an actual reaction force (excluding the floor reaction force applied from the floor surface via the movement mechanism 2) applied from an external system to the upper body portion (the portion supported on the base 3) of the slave device 1 and is referred to as an upper body force detector 33 below. The upper body force detector 33 is configured as, for example, a six-axis force sensor and is able to detect the translational force and the moment of the force as three-dimensional vectors, respectively. Additionally, in the description below, the “moment of the force” is simply referred to as the moment. Further, the upper body portion (the portion supported on the base 3) of the slave device 1 may be referred to as the slave upper body below.

As a guide mechanism that guides the movement of the slide member 32 with respect to the support column 31, for example, a guide rail 31a which extends in the up-down direction is attached to a front surface portion of the support column 31. Then, the slide member 32 engages with the guide rail 31a so as to be elevatable along the guide rail 31a. Additionally, the guide mechanism may be different from the above-described one.

Further, although not shown in detail, the elevating mechanism 30 includes a slide actuator 36 (shown in FIG. 2) which is an actuator for elevating the slide member 32 with respect to the support column 31. The slide actuator 36 is configured as, for example, an electric motor.

The slide actuator 36 is attached to the support column 31 or the slide member 32 to elevate the slide member 32 by applying a driving force for elevating the slide member 32 with respect to the support column 31 to the slide member 32 via, for example, a rotation/linear motion conversion mechanism (not shown) such as a ball screw mechanism. Additionally, the slide actuator 36 is not limited to the electric motor and can be, for example, a hydraulic actuator. Further, the slide actuator 36 is not limited to the rotation type actuator and may be a linear actuator.

In this embodiment, the manipulator 10 is attached to the slide member 32. This manipulator 10 includes a pair of left and right hands 21L and 21R and these two hands 21L and 21R are connected to the slide member 32 via a plurality of joints.

The manipulator 10 includes, for example, a first link 13 which extends from the slide member 32 via a first joint mechanism 12, a pair of left and right second links 15L and 15R which is attached to the front end portion of the first link 13 via a second joint mechanism 14, third links 17L and 17R which are respectively attached to the front end portions of the second links 15L and 15R via third joint mechanisms 16L and 16R, fourth links 19L and 19R which are respectively attached to the front end portions of the third links 17L and 17R via fourth joint mechanisms 18L and 18R, and the hands 21L and 21R which are respectively attached to the front end portions of the fourth links 19L and 19R via fifth joint mechanisms 20L and 20R.

Each of the joint mechanisms 12, 14, 16, 18, and 20 is a joint mechanism having a known structure and is driven by an actuator (not shown) such as an electric motor. Additionally, the manipulator 10 is not limited to the one having the above-described structure and may be one having other structures (for example, a structure having a three-axis slide mechanism or the like). Further, the slave device 1 may be one without the manipulator 10 (for example, one having a structure that can carry arbitrary items or the like).

Further, the slave device 1 of this embodiment is equipped with a cover 26 for preventing an external object from hitting the movement mechanism 2. This cover 26 is formed below the manipulator 10 to cover the entire circumference and the upper surface of the movement mechanism 2 as indicated by, for example, a two-dotted chain line in FIG. 1 and is fixed to the support column 31 via an appropriate mounting member (not shown).

For this reason, in the slave device 1 of this embodiment, it is possible to prevent an object or the like existing in the external system from directly hitting the movement mechanism 2 during the movement of the slave device 1. Then, when the cover 26 receives a reaction force (an external force such as a contact reaction force) from the external system, the reaction force is transmitted from the cover 26 to the upper body force detector 33 via the support column 31. Further, since the manipulator 10 is attached to the slide member 32, a reaction force (an external force such as a contact reaction force) applied from the external system to the manipulator 10 is transmitted from the manipulator 10 to the upper body force detector 33 via the slide member 32 and the support column 31. For this reason, the upper body force detector 33 is mounted on the slave device 1 to detect the actual slave upper body reaction force applied from the external system to the slave upper body by excluding the floor reaction force applied from the slave floor surface to the slave upper body via the movement mechanism 2.

Referring to FIG. 2, the slave device 1 is further equipped with a communication device 40 for wireless communication with the master device 51 and a control device 41 having a function of controlling the operation of the slave device 1. Further, the slave device 1 is provided with a motor rotation detector 6 which is a detector for detecting an actual operation state of each moving grounding portion 4, a slide displacement detector 37 for detecting an actual slave slide displacement which is an actual displacement (up-down direction position) of the slide member 32, and a floor shape detector 7 for detecting an actual slave floor shape which is an actual floor shape of the slave floor where the slave device 1 is grounded via the moving grounding portion 4 in addition to the upper body force detector 33.

The motor rotation detector 6 is a detector which is able to detect, for example, an actual slave motor rotation angle which is a rotation angle of an output shaft (or a rotation member rotating in conjunction with the output shaft) of each of the electric motors 5a and 5b of the movement drive mechanism 5 corresponding to each moving grounding portion 4 as a state quantity representing an actual operation state of each moving grounding portion 4. The motor rotation detector 6 can be configured as, for example, a rotary encoder, a resolver, a potentiometer, or the like.

The slide displacement detector 37 is configured as, for example, a known contact or non-contact displacement sensor. Further, for example, when a power transmission mechanism from the slide actuator 36 to the slide member 32 is configured so that the displacement of the slide member 32 changes in response to the rotation angle of the output shaft of the slide actuator 36, the detector capable of detecting a rotation angle of an output shaft (or a rotation member rotating in conjunction with the output shaft) of the slide actuator 36 can be used as the slide displacement detector 37. In this case, the same detector as the motor rotation detector 6 can be used as the slide displacement detector 37.

Additionally, the slave device 1 is provided with the movement drive mechanisms 5 and the motor rotation detectors 6, but only one of each is representatively shown in FIG. 2.

In this embodiment, the floor shape detector 7 is a detector which is able to detect an actual slave floor tilt angle corresponding to an actual tilt angle of the slave floor below the slave device 1 (an average tilt angle with respect to a horizontal plane) as an actual slave floor shape. The floor shape detector 7 having the above-described shape includes, for example, an inertia sensor (not shown) (an acceleration sensor and an angular velocity sensor) mounted on the base 3 of the slave device 1. Then, the floor shape detector 7 is configured to detect an actual tilt angle of the base 3 as the actual slave floor tilt angle, for example, by an arithmetic process such as a strap-down method from the output of the inertia sensor.

Additionally, the floor shape detector 7 is not limited to the one having the above-described configuration. The floor shape detector 7 may be configured to sequentially recognize the shape of the slave floor around the slave device 1 by using, for example, a camera or a distance measurement sensor (a laser range finder or the like) and to estimate the actual slave floor tilt angle related to the slave floor below the slave device 1 based on the recognized floor shape.

Further, for example, when the floor shape detector 7 can acquire the shape information of the slave floor from an external server or the like, the floor shape detector 7 may be configured to estimate the actual slave floor tilt angle related to the slave floor below the slave device 1 from the own position information of the slave device 1 and the shape information of the slave floor.

The control device 41 is configured as, for example, one or more electronic circuit units including a microcomputer, a memory, an interface circuit, and the like. Although it will be described below in detail, command data representing the operation target (the target motion) of the slave upper body is input from the master device 51 to the control device 41 via the communication device 40 and detection data of each of the detectors (the upper body force detector 33, each motor rotation detector 6, the slide displacement detector 37, and the floor shape detector 7) mounted on the slave device 1 is input thereto.

Then, the control device 41 has a function as a slave movement control unit 42 that controls the movement of the upper body of the slave device 1 via the slide actuator 36 and the electric motors 5a and 5b of each movement drive mechanism 5 as a function realized by both or one of the implemented hardware configuration and program (software configuration). Further, the control device 41 can output (transmit) data representing the operation state of the slave device 1 (hereinafter, referred to as the slave state) or data representing the actual slave floor shape (the actual slave floor tilt angle) detected by the floor shape detector 7 to the master device 51 via the communication device 40. Additionally, the control device 41 can have a function of controlling the operation of the manipulator 10 in addition to the above-described function.

In the description below, “slave” may be added to the beginning of the name of the component of the slave device 1 as appropriate. For example, the base 3 of the slave device 1 may be described as the slave base 3.

[Configuration of Master Device]

Next, a configuration of the master device 51 will be described with reference to FIGS. 3 to 6. Additionally, in the description below, the floor of the operation environment of the master device 51 is referred to as a “master floor”. Further, in the description below, the “front-rear direction”, the “left-right direction”, and the “up-down direction” of the master device 51 are respectively an Xmb-axis direction, a Ymb-axis direction, and a Zmb-axis direction of a three-axis Cartesian coordinate system Cmb shown in FIG. 3 or 4.

Further, the “roll direction”, the “pitch direction”, and the “yaw direction” of the master device 51 respectively mean the direction around the axis (around the Xmb axis) of the front-rear direction, the direction around the axis (around the Ymb axis) of the left-right direction, and the direction around the axis (around the Zmb axis) of the up-down direction of the master device 51. Additionally, the three-axis Cartesian coordinate system Cmb is a master upper body coordinate system to be described later, but the detail will be described later.

Further, similarly to the case of the slave device 1, in order to distinguish the left and right components of the master device 51, “L” and “R” are respectively added to the reference sign of the left component and the reference sign of the right component if necessary.

Referring to FIGS. 3 and 4, the master device 51 includes a movement mechanism 52 which is movable on the master floor surface, an upper body support portion 65 which is attached to an upper body of a manipulator P (shown in FIG. 4), and foot mounts 70L and 70R which are portions for respectively placing (grounding) the left and right feet of the manipulator P (hereinafter, referred to as the operator P). Additionally, the master device 51 can further include a device for manipulating the slave manipulator 10.

In this embodiment, the movement mechanism 52 includes a base 53 and a plurality of (for example, four) moving grounding portions 54 (54 (1), 54 (2), 54 (3), and 54 (4) attached to the base 53 and the plurality of moving grounding portions 54 are grounded to the master floor surface with a gap between the base 53 and the master floor surface. Additionally, the shape of the base 53 is not limited to the shape shown in the drawing and may be an arbitrary shape.

Each moving grounding portion 54 has the same structure as that of the slave moving grounding portion 4. Then, four moving grounding portions 54 (1), 54 (2), 54 (3), and 54 (4) are respectively disposed on both left and right sides of the front portion of the base 53 and both left and right sides of the rear portion thereof.

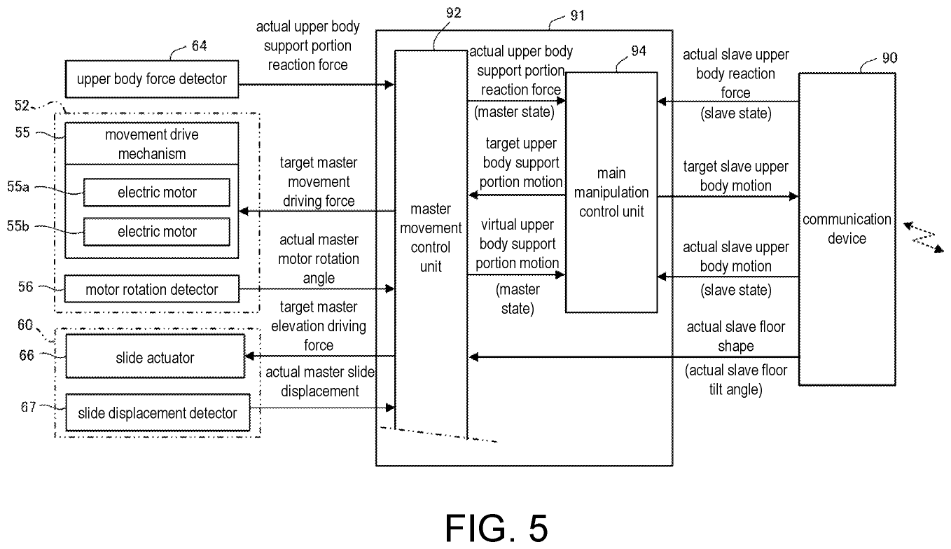

Further, although not shown in detail, similarly to the slave movement mechanism 2, the movement mechanism 52 includes a movement drive mechanism 55 including electric motors 55a and 55b for each moving grounding portion 54 as a mechanism for driving each moving grounding portion 54 as shown in FIG. 5. Additionally, only one movement drive mechanism 55 corresponding to one moving grounding portion 54 is representatively shown in FIG. 5.

In the master device 51, each moving grounding portion 54 is attached to the base 53 in order to change the inclination of the base 53 with respect to the master floor surface. Specifically, referring to FIGS. 3 and 4, a support shaft 57a corresponding to each moving grounding portion 54 is assembled to both left and right side portions of the base 53 so that the axis faces the left-right direction (the Ymb-axis direction).

Then, each moving grounding portion 54 is axially supported to the support shaft 57a via a link 57b to be swingable around the axis of the support shaft 57a corresponding thereto. Thus, each moving grounding portion 54 is relatively movable up and down with respect to the base 53 by swinging around the axis of the support shaft 57a corresponding thereto.

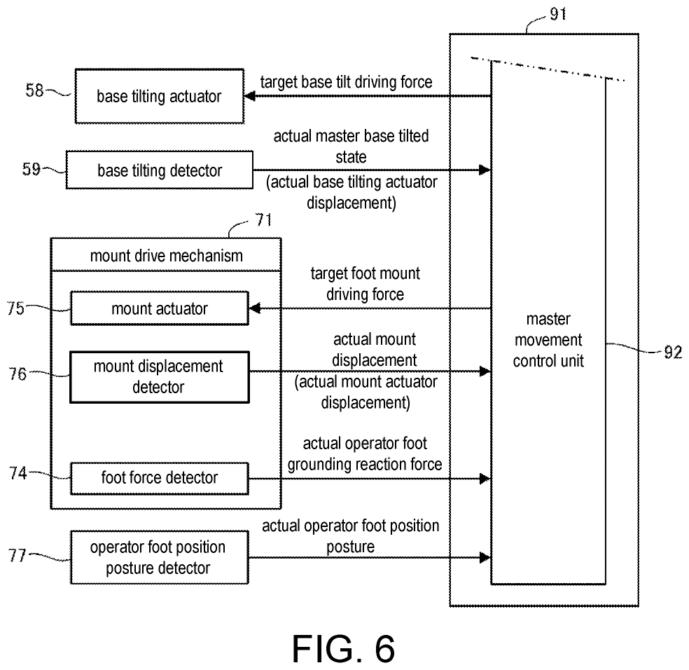

Further, although not shown in detail, the master device 51 includes an actuator swinging each moving grounding portion 54 around the axis of the support shaft 57a corresponding thereto for each moving grounding portion 54 as a base tilting actuator 58 (shown in FIG. 6) for changing the inclination of the base 53 with respect to the master floor surface. Additionally, only one base tilting actuator 58 corresponding to one moving grounding portion 54 is representatively described in FIG. 6.

Each base tilting actuator 58 is configured as, for example, an electric motor and swings the moving grounding portion 54 by rotationally driving the link 57b related to the corresponding moving grounding portion 54 around the axis of the support shaft 57a via a power transmission mechanism (not shown). Additionally, the base tilting actuator 58 is not limited to the electric motor and can be a hydraulic actuator. Further, the base tilting actuator 58 is not limited to the rotation type actuator and may be a linear actuator.

Here, when the moving grounding portion 54 is swung around the axis of the support shaft 57a by the base tilting actuator 58 corresponding to each moving grounding portion 54 in a state in which each moving grounding portion 54 is grounded to the master floor, the moving grounding portion 54 relatively moves up and down with respect to the base 53 so that the height of the arrangement portion of the support shaft 57a in the base 53 (the height from the master floor surface) changes. For this reason, it is possible to change the height for each arrangement portion of each support shaft 57a in the base 53. Accordingly, it is possible to change the inclination of the base 53 with respect to the master floor surface.

Supplementally, the attachment structure of each moving grounding portion 54, changing the inclination of the base 53 with respect to the master floor, to the base 53 is not limited to the above-described structure. For example, each moving grounding portion 54 may be attached to the base 53 via a suspension mechanism (so-called active suspension mechanism) including a damper capable of variably controlling a stroke length. Further, each moving grounding portion 54 may be attached to the base 53 via an elevating mechanism including a guide rail, a ball screw mechanism, or the like.

Further, each moving grounding portion 54 of the master device 51 is not limited to the one having the same structure as that of the slave device 1 and may have other structures such as an omni wheel (registered trademark). Further, similarly to the case of the slave device 1, the number of the moving grounding portions 4 provided in the movement mechanism 52 is not limited to four and may be, for example, three or five or more. Further, the power source of each moving grounding portion 54 is not limited to the electric motors 55a and 55b and can be, for example, a hydraulic actuator.

The foot mounts 70L and 70R are respectively mounted on the base 53 via the mount drive mechanisms 71L and 71R at the left and right sides of the base 53 to be relatively movable with respect to the base 53. Each of the mount drive mechanisms 71L and 71R is a mechanism having the same structure. In this embodiment, each mount drive mechanism 71 includes a movement mechanism 72 which includes a translational portion 72a movable in a translational manner, for example, in three axis directions (for example, the coordinate-axis directions of the coordinate system Cmb) and is attached to the base 53 and a rotation mechanism 73 which includes a rotatable portion 73a rotatable in the directions around three rotation axes (for example, the directions around the coordinate axes of the coordinate system Cmb) and is attached to the translational portion 72a of the movement mechanism 72.

Then, the foot mount 70 which is on the same side (the left side or the right side) as the mount drive mechanism 71 is attached to the rotatable portion 73a of the rotation mechanism 73 of each mount drive mechanism 71. Accordingly, each foot mount 70 is mounted on the base 53 to perform a translational motion with three degrees of freedom and a rotational motion with three degrees of freedom with respect to the base 53 (and thus have six degrees of freedom of motion).

In this case, the upper surface of each foot mount 70 (the surface for grounding each foot of the operator P) is exposed upward so that each foot can be grounded from above. Further, each foot mount 70 is attached to the rotatable portion 73a via a force detector 74 for detecting an actual foot grounding reaction force which is an actual reaction force (a grounding reaction force) applied from the foot of the operator P grounded to the upper surface. The force detector 74 (hereinafter, referred to as the foot force detector 74) is configured as, for example, a six-axis force sensor similarly to the slave upper body force detector 33.

Although not shown in detail, those having a known structure can be used as the movement mechanism 72 and the rotation mechanism 73 of each mount drive mechanism 71. For example, those having a structure described in Patent Document 1 can be used as the movement mechanism 72 and the rotation mechanism 73. Then, each mount drive mechanism 71 includes a plurality of (six) actuators (the mount actuator 75 shown in FIG. 6) for performing each of the translational motion of the translational portion 72a and the rotational motion of the rotatable portion 73a. Each mount actuator 75 is configured as, for example, an electric motor.

Additionally, one mount drive mechanism 71 (71L or 71R) and one of the plurality of mount actuators 75 provided therein are representatively shown in FIG. 6. Further, the mount actuator 75 is not limited to the electric motor and can be, for example, a hydraulic actuator.

Supplementally, the movement mechanism 72 and the rotation mechanism 73 of each mount drive mechanism 71 may have a structure different from that of Patent Document 1. Further, each mount drive mechanism 71 may be a mechanism having a structure in which a plurality of links are connected via a plurality of joints, such as an arm mechanism of a joint robot.

As described above, in the master device 51 including the foot mounts 70L and 70R, the operator P can board the master device 51 to stand up on the foot mounts 70L and 70R by grounding the left and right feet of the operator P to the respective upper surfaces of the foot mounts 70L and 70R while the foot mounts 70L and 70R are stopped.

Further, the operator P can perform a walking operation on the master device 51 by operating the mount drive mechanisms 71L and 71R so that the foot mount 70R (or 70L) on the free leg side is located directly below the foot on the free leg side while being moved relatively with respect to the foot mount 70L (or 70R) on the support leg side when the operator P on board the master device 51 moves the other foot (the foot on the free leg side) to be lifted from the foot mount 70R (or 70L) while one of left and right feet (the foot on the support leg side) is grounded to the foot mount 70L (or 70R).

That is, the operator P can perform a walking operation so that the foot on the free leg side relatively moves with respect to the foot on the support leg side while repeatedly grounding the left and right feet to the foot mounts 70L and 70R alternately and intermittently.

In this case, the foot mount 70 for grounding each foot of the operator P functions as a pseudo floor in the walking operation of the operator P. Hereinafter, the floor which is formed in a pseudo manner by the foot mount 70 for grounding each foot of the operator P is referred to as a virtual floor. The virtual floor is a floor having an upper surface (grounding surface) of the foot mount 70 in which the foot on the support leg side is grounded for each step by the walking operation of the operator P as a local floor surface.

The upper body support portion 65 is attached to the base 53 via an elevating mechanism 60 to move up and down with respect to the base 53 above the foot mounts 70L and 70R. The elevating mechanism 60 includes a support column 61 which is erected upward at the center portion of the rear portion of the base 53 (the center portion in the left-right direction) behind the mount drive mechanisms 71L and 71R and a slide member 62 which is assembled to be movable (elevatable) in the up-down direction with respect to the support column 61. The support column 61 is fixed to the base 53.

As a guide mechanism that guides the movement of the slide member 62 with respect to the support column 61, for example, a guide rail 61a extending in the up-down direction is attached to the front surface portion of the support column 61. Then, the slide member 62 engages with the guide rail 61a to be elevatable along the guide rail 61a. Additionally, the guide mechanism may be different from the above-described one.

Further, although it is not shown in detail, the elevating mechanism 60 includes a slide actuator 66 (shown in FIG. 5) which is an actuator for elevating the slide member 62 with respect to the support column 61. The slide actuator 66 is configured as, for example, an electric motor. Then, the slide actuator 66 elevates the slide member 62, for example, via the same power transmission mechanism as the power transmission mechanism from the slide actuator 36 to the slide member 32 of the slave device 1.

Additionally, the slide actuator 66 is not limited to the electric motor and can be, for example, a hydraulic actuator. Further, the slide actuator 66 is not limited to the rotation type actuator and may be a linear actuator.

In this embodiment, the upper body support portion 65 is formed to follow an outer periphery of a predetermined portion of the upper body of the operator P, for example, a waist from a back surface side. For example, the upper body support portion 65 is configured as a plate-shaped member formed in a substantially semi-arc shape (or U-shape). Then, the upper body support portion 65 is attached to the slide member 62 via a support shaft 63 and a force detector 64.

More specifically, the support shaft 63 is attached to the slide member 62 via the force detector 64 so that the axis faces the front-rear direction (the Xm-axis direction). The force detector 64 (hereinafter, referred to as the upper body force detector 64) is a detector for detecting an actual upper body support portion reaction force which is an actual reaction force (contact reaction force) applied from the upper body of the operator P to the upper body support portion 65 and is configured as, for example, a six-axis force sensor similarly to the slave upper body force detector 33.

Then, a center portion between both ends of the upper body support portion 65 is attached to the support shaft 63. In this case, the upper body support portion 65 is supported by the support shaft 63 to freely rotatable around the axis of the support shaft 63 (in other words, the roll direction) with respect to the slide member 62 and the upper body force detector 64.

Such an upper body support portion 65 is disposed to follow the outer periphery of the waist of the upper body of the operator P from the back surface side while the left and right feet of the operator P are grounded to the foot mounts 70L and 70R as shown in FIG. 4 when the operator P manipulates the slave device 1. Then, a flexible belt 65x (indicated by a two-dotted chain line in FIGS. 3 and 4) disposed to follow the outer periphery of the front surface side of the waist of the operator P is connected to both end portions of the upper body support portion 65.

Accordingly, the upper body support portion 65 is attached to the waist of the operator P via the belt 65x to surround the periphery of the waist of the upper body of the operator P by the upper body support portion 65 and the belt 65x. In this case, the upper body support portion 65 is attached to the waist of the operator P not to cause a relative displacement. Further, the upper body support portion 65 can adjust the height of the upper body support portion 65 (the position of the up-down direction) by appropriately moving the slide member 62 up and down. Further, an elastic member such as a pad (not shown) is attached to the inner peripheral surface of the upper body support portion 65 and the elastic member is in contact with the periphery of the waist of the operator P.

In this way, when the operator P performs a walking operation so that the foot mount 70 (70L or 70R) corresponding to each of the left and right feet is alternately grounded as described above in a state in which the upper body support portion 65 is attached to the waist of the operator P, the upper body support portion 65 can move relatively with respect to the foot mount 70 for grounding the foot of the operator P together with the upper body of the operator P (the waist). In this case, the actual upper body support portion reaction force which is applied from the waist of the operator P to the upper body support portion 65 is detected by the upper body force detector 64. Further, the foot force detector 74 detects the actual foot grounding reaction force applied from the foot of the operator grounded to each foot mount 70.

Referring to FIGS. 5 and 6, the master device 51 is further equipped with a communication device 90 for wireless communication with the slave device 1 and a control device 91 having a function of controlling the operation of the master device 51. Further, the master device 51 is equipped with a motor rotation detector 56 which is a detector for detecting an actual operation state of each moving grounding portion 54 by each movement drive mechanism 55, a slide displacement detector 67 which is for detecting an actual master slide displacement corresponding to an actual displacement (up-down direction position) of the slide member 62, a mount displacement detector 76 which is for detecting an actual mount displacement corresponding to an actual displacement (translational displacement and rotation angle) of each foot mount 70 by each mount drive mechanism 71, an operator foot position posture detector 77 which is for detecting an actual operator foot position posture corresponding to an actual position posture (position and posture angle) of each foot of the operator P, and a base tilting detector 59 which is for detecting an actual master base tilted state corresponding to an actual tilted state of the base 53 in addition to the upper body force detector 64 and the foot force detector 74.

In this case, the motor rotation detector 56 is a detector which is able to detect an actual master motor rotation angle corresponding to a rotation angle of each rotation shaft (or a rotation member rotating in conjunction with the rotation shaft) of the electric motors 55a and 55b for each movement drive mechanism 55 as a state quantity representing an actual operation state of each moving grounding portion 54. The motor rotation detector 56 can have the same configuration as that of the slave motor rotation detector 6. Further, the slide displacement detector 67 can also have the same configuration as that of the slave slide displacement detector 37.

Further, the mount displacement detector 76 is a detector which is able to detect, for example, an actual mount actuator displacement corresponding to an actual displacement (rotation angle or translational displacement) of an output unit (or a member moving in a rotational or translational manner in conjunction with the output unit) of each mount actuator 75 of each mount drive mechanism 71 as a state quantity representing an actual mount displacement of the foot mount 70 corresponding to the mount drive mechanism 71. Further, the base tilting detector 59 is a detector which is able to detect, for example, an actual base tilting actuator displacement corresponding to an actual displacement (rotation angle or translational displacement) of an output unit of each base tilting actuator 58 (or a member moving in a rotational or translational manner together with the output unit) as a state quantity representing an actual master base tilted state. The mount displacement detector 76 and the base tilting displacement detector 59 can be configured as, for example, a rotary encoder, a resolver, a potentiometer, or the like.

Additionally, the detector capable of detecting the actual mount displacement of each foot mount 70 may be configured to detect, for example, a rotation angle around each axis for the rotational motion of each foot mount 70 and a translational displacement in each axis direction for the translational motion of each foot mount 70 by an appropriate contact or non-contact displacement sensor.

The operator foot position posture detector 77 includes one or more cameras (not shown) mounted on the master device 51 in order to capture, for example, each of the left and right feet of the operator P on board the master device 51 and is configured to detect (estimate) an actual operator foot position posture for each foot by a known motion capture method from a video captured by the camera.

Supplementally, the operator foot position posture detector 77 may be configured to estimate the actual operator foot position posture by a method other than the motion capture method. For example, an inertia sensor including an acceleration sensor and an angular velocity sensor is attached to each foot of the operator P and the position posture of the actual operator foot can be estimated by a known method such as a strap-down method from the acceleration and the angular velocity detected by the inertia sensor. In addition, various known methods capable of estimating the own position and posture of the object can be used as a method of estimating the actual operator foot position posture.

Further, for example, a joint displacement detector capable of detecting each displacement of each joint (a hip joint, a knee joint, and an ankle joint) of each leg of the operator P is attached to each leg and an actual relative position posture of each foot with respect to the upper body of the operator P can be estimated by using a rigid link model of each leg from the displacement detected value of the joint of each leg.

Additionally, the master device 51 is provided with the motor rotation detectors 56, the foot force detectors 74, the base tilting displacement detectors 59, and the mount displacement detectors 76, but only one of each is representatively described FIGS. 5 and 6.

The control device 91 is configured as, for example, one or more electronic circuit units including a microcomputer, a memory, an interface circuit, and the like. Although it will be described below in detail, data representing the actual slave state is input from the slave device 1 to the control device 91 via the communication device 90 and detection data of each of the detectors (the upper body force detector 64, each motor rotation detector 56, each foot force detector 74, each base tilting detector 59, each mount displacement detector 76, and the operator foot position posture detector 77) mounted on the master device 51 is input thereto.

Then, the control device 91 has a function as a main manipulation control unit 94 generating an overall operation target (target motion) of the slave device 1 and the master device 51 and a function as a master movement control unit 92 controlling the motion of the base 3, the upper body support portion 65, and each foot mount 70 via the electric motors 55a and 55b of each movement drive mechanism 55, the slide actuator 66, the mount actuator 75, and the base tilting actuator 58 as a function realized by both or one of the implemented hardware configuration and program (software configuration). Further, the control device 91 is able to output (transmit) command data representing the operation target (the target motion) of the slave device 1 to the slave device 1 via the communication device 90.

In the description below, “master” may be added to the beginning of the name of the component of the master device 51 as appropriate. For example, the base 53 of the master device 51 may be described as the master base 53.

Supplementally, in this embodiment, all the electric motors 55a and 55b of the master device 51 correspond to the first actuator of the disclosure, the entire mount actuator 75 corresponds to the second actuator of the disclosure, the entire base tilting actuator 58 corresponds to the third actuator of the disclosure, the slide actuator 66 corresponds to the fourth actuator of the disclosure. Further, both the slave control device 41 and the master control device 91 correspond to the control device of the disclosure.

[Control Process and Operation]

Next, the detail of the control process of the control devices 41 and 91 and the operation of the slave device 1 and the master device 51 will be described. Here, in the following description, one in which “virtual” is added to the beginning of the name of the state quantity for the motion of an arbitrary object or the subscript “_vir” is added to the reference sign of the state quantity means the observed value of the state quantity for the motion of the object with respect to the virtual floor. Further, the reference sign with “↑” at the beginning is a reference sign representing a vector (vertical vector).

Further, a global coordinate system (a three-axis Cartesian coordinate system fixed to the slave floor) arbitrarily designed and set in the operation environment (the movement environment) of the slave device 1 is referred to as a slave side global coordinate system Cs and three coordinate axes of the slave side global coordinate system Cs are referred to as an Xs axis, a Ys axis, and a Zs axis. In this case, the Zs axis is the coordinate axis of the up-down direction (the vertical direction or the substantially vertical direction) and the Xs axis and the Ys axis are the coordinate axes of the lateral direction (the horizontal direction or the substantially horizontal direction).

Similarly, a global coordinate system (a three-axis Cartesian coordinate system fixed to the master floor) arbitrarily designed and set in the operation environment (the movement environment) of the master device 51 is referred to as a master side global coordinate system Cm and three coordinate axes of the master side global coordinate system Cm are referred to as a Xm axis, a Ym axis, and a Zm axis. In this case, the Zm axis is the coordinate axis of the up-down direction (the vertical direction or the substantially vertical direction) and the Xm axis and the Ym axis are the coordinate axes of the lateral direction (the horizontal direction or the substantially horizontal direction).

Further, in order to express the motion of the object with respect to the virtual floor, the three-axis Cartesian coordinate system fixed to the virtual floor is referred to as a virtual floor coordinate system Cvir and three coordinate axes of the virtual floor coordinate system Cvir are referred to as an Xvir axis, a Yvir axis, and a Zvir axis. In this case, the Zvir axis is the coordinate axis of the up-down direction (the vertical direction or the substantially vertical direction) and the Xvir axis and the Yvir axis are the coordinate axes of the lateral direction (the horizontal direction or the substantially horizontal direction).

[Control Process of Main Manipulation Control Unit]

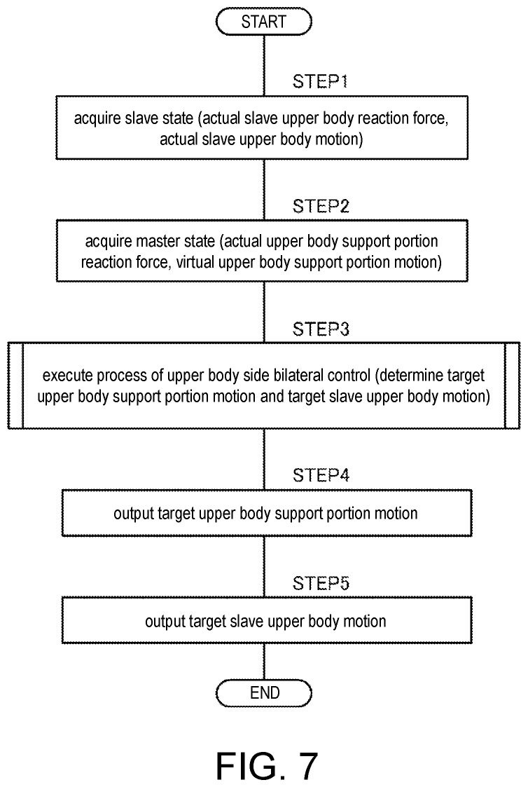

First, the control process of the main manipulation control unit 94 of the master control device 91 will be described. The main manipulation control unit 94 sequentially executes a process shown in the flowchart of FIG. 7 in a predetermined control process cycle. In STEP 1, the main manipulation control unit 94 acquires (receives) data representing the slave state as the operation state of the slave device 1 from the slave control device 41 via the communication devices 40 and 90.

The slave state includes, as shown in FIG. 5, an actual slave upper body reaction force which is a reaction force (excluding a floor reaction force) actually applied from the external system to the slave upper body and an actual slave upper body motion which is an actual motion of the slave upper body.

The actual slave upper body reaction force is, more specifically, the resultant force of the actual reaction force applied from the external system to the slave upper body via the support column 31, the cover 26, or the manipulator 10. Further, the actual slave upper body reaction force includes a pair of a translational force and a moment. Then, each of the translational force and the moment of the actual slave upper body reaction force acquired by the main manipulation control unit 94 in STEP 1 is represented as a three-dimensional vector viewed in the slave side global coordinate system Cs.

In this case, the moment of the actual slave upper body reaction force is, more specifically, the moment around a predetermined reference point (hereinafter, referred to as a slave reference point Qs) set for the slave device 1. The slave reference point Qs can be appropriately set in design in consideration of the structure or the like of the slave device 1.

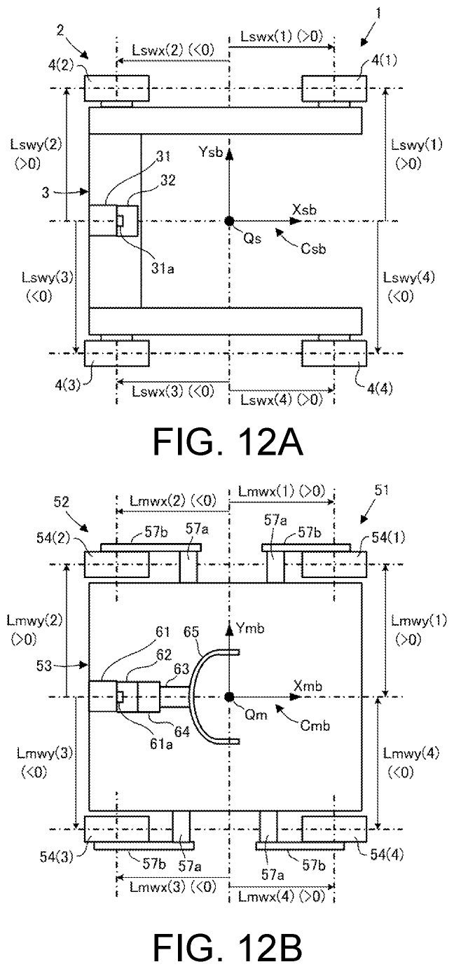

In this embodiment, since the master movement mechanism 52 and the slave movement mechanism 2 have a similar configuration, the slave reference point Qs can be set, for example, so that the positional relationship between the slave reference point Qs and the slave movement mechanism 2 and the positional relationship between the reference point Qm to be described later in the master device 51 and the master movement mechanism 52 are almost the same as or similar to each other. The slave reference point Qs shown in FIG. 12A shows a reference point set from such a view point. Additionally, the manipulator 10 is not shown in FIG. 12A. In the description below, ↑F_sb_act and ↑M_sb_act are respectively used as the reference signs respectively indicating the translational force and the moment of the actual slave upper body reaction force.

Further, the actual slave upper body motion includes the position ↑P_sb_act, the translational velocity ↑V_sb_act, the posture angle ↑θ_sb_act, and the angular velocity ↑ω_sb_act of the slave upper body viewed in the slave side global coordinate system Cs. Additionally, the position ↑P_sb_act of the slave upper body is the position of the representative point set (defined) in advance for the slave upper body, for example, the position of the slave reference point Qs. Further, in this embodiment, the yaw direction component of the posture angle ↑θ_sb_act of the slave upper body is considered to match the yaw direction component of the posture angle of the slave base 3.

Supplementally, a part or all of the slave state output from the slave control device 41 to the main manipulation control unit 94 may be a state quantity viewed in a local coordinate system (for example, a slave upper body coordinate system Csb to be described later) set for the slave device 1. In this case, in STEP 1, the main manipulation control unit 94 converts the slave state (the actual slave state viewed in the local coordinate system) given from the slave control device 41 into the actual slave state viewed in the slave side global coordinate system Cs and acquires the converted state.

Further, in this embodiment, the posture angle and the angular velocity around the axis of the lateral direction in the motion of the slave upper body are not controlled. For this reason, in STEP 1, the main manipulation control unit 94 can omit a process of acquiring the posture angle and the angular velocity around the axis of the lateral direction in the posture angle ↑θ_sb_act and the angular velocity ↑ω_sb_act of the actual slave upper body motion and a process of acquiring the moment around the axis of the lateral direction in the moment ↑M_sb_act of the actual slave upper body reaction force. In other words, the posture angle and the angular velocity of the actual slave upper body motion acquired by the main manipulation control unit 94 may be only the component in the yaw direction (the direction around the Zs axis).

Next, in STEP 2, the main manipulation control unit 94 acquires data representing the master state as the operation state of the master device 51 from the master movement control unit 92. This master state includes, as shown in FIG. 5, an actual upper body support portion reaction force which is an actual reaction force applied from the operator P to the upper body support portion 65 and a virtual upper body support portion motion which is a motion of the upper body support portion 65 with respect to the virtual floor.

The actual upper body support portion reaction force includes a pair of a translational force and a moment. Then, each of the translational force and the moment is represented as a three-dimensional vector viewed in the virtual floor coordinate system Cvir. In the virtual floor coordinate system Cvir, the position of the origin of the virtual floor coordinate system Cvir with respect to the master side global coordinate system Cm and the direction of each of the coordinate axes (the Xvir axis, the Yvir axis, and the Zvir axis) are arbitrarily and initially set before the start or the like of the walking operation of the operator P on the master device 51. In this case, the direction of the Zvir axis of the virtual floor coordinate system Cvir is the same as the direction of the Zm axis of the master side global coordinate system Cm (the up-down direction). However, in this embodiment, the virtual floor and the virtual floor coordinate system Cvir are set to move with respect to the master side global coordinate system Cm after the walking operation of the operator P starts.

Further, the moment of the actual upper body support portion reaction force is, more specifically, the moment, for example, around a predetermined reference point (hereinafter, a master reference point Qm) set for the master device 51. For example, as shown in FIG. 12B, the master reference point Qm can be set to a middle point between both left and right side portions of the upper body support portion 65 on the axis of the support shaft 63 (a point in the vicinity of the center of the waist of the operator P who wears the upper body support portion 65). Hereinafter, ↑F_mb_act and ↑M_mb_act are respectively used as the reference signs respectively indicating the translational force and the moment of the actual upper body support portion reaction force.

Further, the virtual upper body support portion motion includes the position ↑P_mb_vir, the translational velocity ↑V_mb_vir, the posture angle ↑θ_mb_vir, and the angular velocity ↑ω_mb_vir of the upper body support portion 65 viewed in the virtual floor coordinate system Cvir. The virtual upper body support portion motion means an estimated value of the motion of the upper body support portion 65 which can be realized on the assumption that the motion of the upper body support portion 65 with respect to the virtual floor is performed according to the target upper body support portion motion to be described later.

Here, the position ↑P_mb_vir of the upper body support portion 65 is the position of the representative point set in advance for the upper body support portion 65, for example, the position of the master reference point Qm. Further, in this embodiment, it is considered that the lateral position (the Xir-axis direction position and the Yvir-axis direction position) of the upper body support portion 65 matches the lateral position of the master base 53 and the posture angle (direction) in the yaw direction of the upper body support portion 65 matches the posture angle (direction) in the yaw direction of the master base 53. Additionally, in this embodiment, since the lateral position of the upper body support portion 65 is fixed to the base 53, the lateral position of the upper body support portion 65 also has a meaning as the lateral position of the base 3.

Supplementally, a part or all of the master state output from the master movement control unit 92 to the main manipulation control unit 94 may be a state quantity viewed in a local coordinate system (for example, a master upper body coordinate system Cmb to be described later) set for the master device 51. In this case, in STEP 2, the main manipulation control unit 94 converts the master state (the master state viewed in the local coordinate system) given from the master movement control unit 92 into the master state viewed in the virtual floor coordinate system Cvir and acquires the converted state.

Further, in this embodiment, the posture angle and the angular velocity around the axis of the lateral direction in the motion of the upper body support portion 65 are not controlled. For this reason, in STEP 2, the main manipulation control unit 94 can omit a process of acquiring the posture angle and the angular velocity around the axis of the lateral direction in the posture angle ↑θ_mb_vir and the angular velocity ↑ω_mb_vir of the virtual upper body support portion motion and a process of acquiring the moment around the axis of the lateral direction in the moment ↑M_mb_vir of the virtual upper body support portion reaction force. In other words, the posture angle and the angular velocity of the virtual upper body support portion motion acquired by the main manipulation control unit 94 may be only the component in the yaw direction (the direction around the Zvir axis).

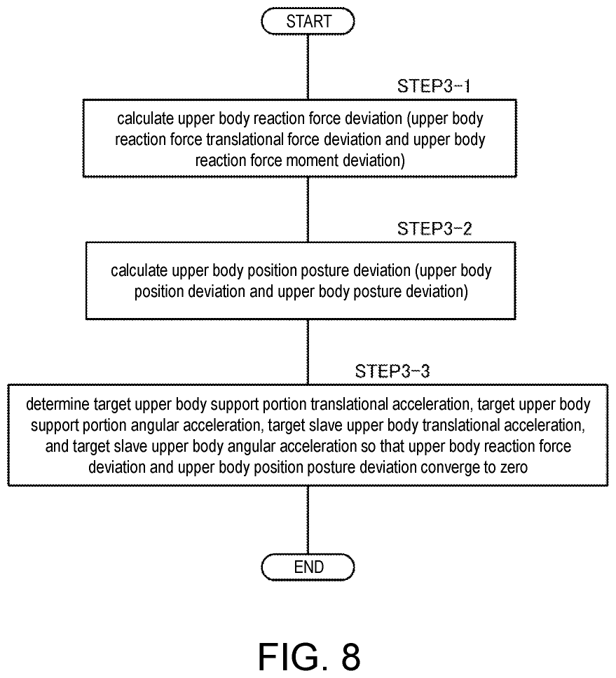

Next, in STEP 3, the main manipulation control unit 94 executes a process of upper body side bilateral control which is bilateral control for the operations of the slave upper body and the upper body support portion 65 of the master device 51. The process of the upper body side bilateral control is executed as shown in the flowchart of FIG. 8.

In STEP 3-1, the main manipulation control unit 94 calculates an upper body reaction force deviation. In this embodiment, this upper body reaction force deviation includes an upper body reaction force translational force deviation ↑Efb which is an upper body reaction force deviation for the translational force and an upper body reaction force moment deviation ↑Emb which is an upper body reaction force deviation for the moment.

Then, the upper body reaction force translational force deviation ↑Efb is defined as, for example, an index value representing a deviation degree (divergence degree) of a mutual relationship between the translational force ↑F_sb_act of the actual slave upper body reaction force and the translational force ↑F_mb_act of the actual upper body support portion reaction force from a predetermined target relationship.

Similarly, the upper body reaction force moment deviation ↑Emb is defined as, for example, an index value representing a deviation degree (divergence degree) of a mutual relationship between the moment ↑M_sb_act of the actual slave upper body reaction force and the moment ↑M_mb_act of the actual upper body support portion reaction force from a predetermined target relationship.

Specifically, in this embodiment, the upper body reaction force translational force deviation ↑Efb is an index value represented by a function formed by linearly combining the translational force ↑F_mb_act of the actual upper body support portion reaction force and the translational force ↑F_sb_act of the actual slave upper body reaction force and is defined by, for example, the following formula (1a).

Similarly, the upper body reaction force moment deviation ↑Emb is an index value represented by a function formed by linearly combining the moment ↑M_mb_act of the actual upper body support portion reaction force and the moment ↑M_sb_act of the actual slave upper body reaction force and is defined by, for example, the formula (1b). Additionally, in the present specification, “*” is used as a multiplication symbol.

↑Efb=↑F_mb_act+Ratio_fsb*↑F_sb_act (1a)

↑Emb=↑M_mb_act+Ratio_msb*↑M_sb_act (1b)

Here, Ratio_fsb and Ratio_msb in the formulas (1a) and (1b) are coefficients respectively representing the feedback rates of ↑F_sb_act and ↑M_sb_act with respect to the operator P and are respectively set to predetermined values. The coefficient may be any one of a scalar and a diagonal matrix. In this embodiment, the coefficients Ratio_fsb and Ratio_msb of the second term on the right side of each of the formulas (1a) and (1b) are set to the same values (≠0). However, Ratio_fsb and Ratio_msb can be set to different values or Ratio_fsb and Ratio_msb can be respectively set to zero.

In this embodiment, a mutual target relationship of ↑F_mb_act and ↑F_sb_act is that the upper body reaction force translational force deviation ↑Efb defined by the formula (1a) is zero (↑F_mb_act=−Ratio_fsb*↑F_sb_act) and a mutual target relationship of ↑M_mb_act and ↑M_sb_act is that the upper body reaction force moment deviation ↑Emb defined by the formula (1b) is zero (↑M_mb_act=−Ratio_msb*↑M_sb_act).

Then, in STEP 3-1, the main manipulation control unit 94 calculates the upper body reaction force deviation (↑Efb, ↑Emb) according to the above formulas (1a) and (1b) from the actual slave upper body reaction force (TF_sb_act, ↑M_sb_act) acquired in STEP 1 and the actual upper body support portion reaction force (↑F_mb_act, ↑M_mb_act) acquired in STEP 2.

Next, in STEP 3-2, the main manipulation control unit 94 calculates an upper body position posture deviation. This upper body position posture deviation includes an upper body position deviation ↑Epb regarding the positions of the upper body support portion 65 and the slave upper body and an upper body posture deviation ↑Ethb regarding the postures (directions) of the upper body support portion 65 and the slave upper body.

Then, the upper body position deviation ↑Epb is defined as an index value representing a deviation degree (divergence degree) of a mutual relationship between the position ↑P_mb_vir of the upper body support portion 65 in the virtual upper body support portion motion and the position ↑P_sb_act of the slave upper body in the actual slave upper body motion from a predetermined target relationship. Similarly, the upper body posture deviation ↑Ethb is defined as an index value representing a deviation degree (divergence degree) of a mutual relationship between the posture angle ↑θ_mb_vir of the upper body support portion 65 in the virtual upper body support portion motion and the posture angle ↑θ_sb_act of the slave upper body in the actual slave upper body motion from a predetermined target relationship.

Specifically, in this embodiment, the upper body position deviation ↑Epb is an index value represented by a function formed by linearly combining the position ↑P_mb_vir of the upper body support portion 65 with the position ↑P_sb_act of the slave upper body and is defined by, for example, the following formula (2a).

Similarly, the upper body posture deviation ↑Ethb is an index value represented by a function formed by linearly combining the posture angle ↑θ_mb_vir of the upper body support portion 65 and the posture angle ↑θ_sb_act of the slave upper body and is defined by, for example, the formula (2b).

↑Epb=↑P_mb_vir−Ratio_psb*↑P_sb_act (2a)

↑Ethb=↑θ_mb_vir−Ratio_thsb*↑θ_sb_act (2b)

Here, the coefficients Ratio_psb and Ratio_thsb of the formulas (2a) and (2b) are respectively predetermined coefficients (scalar or diagonal matrix) set in advance. Further, in this embodiment, Ratio_psb and Ratio_thsb are set to the same values (≠0). However, Ratio_psb and Ratio_thsb can be set to different values or Ratio_psb and Ratio_thsb can be respectively set to zero.

In this embodiment, a mutual target relationship of ↑P_mb_vir and ↑P_sb_act is that the upper body position deviation ↑Epb defined by the formula (2a) is zero (↑P_mb_vir=Ratio_psb*↑P_sb_act) and a mutual target relationship of ↑θ_mb_vir and ↑θ_sb_act is that the upper body posture deviation ↑Ethb defined by the formula (2b) is zero (↑θ_mb_vir =Ratio_thsb*↑θ_sb_act).

Then, in STEP 3-2, the main manipulation control unit 94 calculates the upper body position posture deviation (↑Epb, ↑Ethb) according to the above formulas (2a) and (2b) from the position ↑P_sb_act and the posture angle ↑θ_sb_act in the actual slave upper body motion acquired in STEP 1 and the position ↑P_mb_vir and the posture angle ↑θ_mb_vir in the virtual upper body support portion motion acquired in STEP 2.

Next, in STEP 3-3, the main manipulation control unit 94 determines the target upper body support portion translational acceleration ↑Acc_mb_aim and the target upper body support portion angular acceleration ↑β_mb_aim which are the target values of the translational acceleration and the angular acceleration of the upper body support portion 65 and the target slave upper body translational acceleration ↑Acc_sb_aim and the target slave upper body angular acceleration ↑β_sb_aim which are the target values of the translational acceleration and the angular acceleration of the slave upper body so that the upper body reaction force deviation and the upper body position posture deviation converge to zero.

In this case, more specifically, the target upper body support portion translational acceleration ↑Acc_mb_aim and the target slave upper body translational acceleration ↑Acc_sb_aim are determined so that the upper body reaction force translational force deviation ↑Efb and the upper body position deviation ↑Epb respectively converge to zero and the target upper body support portion angular acceleration ↑β_mb_aim and the target slave upper body angular acceleration ↑β_sb_aim are determined so that the upper body reaction force moment deviation ↑Emb and the upper body posture deviation ↑Ethb respectively converge to zero. Additionally, the target upper body support portion translational acceleration ↑Acc_mb_aim and the target upper body support portion angular acceleration ↑β_mb_aim are the target values of the translational acceleration and the angular acceleration of the upper body support portion 65 viewed in the virtual floor coordinate system Cvir.

A method of determining the target upper body support portion translational acceleration ↑Acc_mb_aim and the target slave upper body translational acceleration ↑Acc_sb_aim and a method of determining the target upper body support portion angular acceleration ↑β_mb_aim and the target slave upper body angular acceleration ↑β_sb_aim are the same methods. Hereinafter, a method of determining ↑Acc_mb_aim and ↑Acc_sb_aim will be described in detail.

When the coefficient representing the rigidity between the upper body support portion 65 and the operator P is indicated by Kmb and the coefficient representing the rigidity between the slave upper body and the external object (excluding the floor surface) is indicated by Ksb, it can be considered that the relationship of the following formula (3a) is approximately established between the translational force ↑F_mb_act↑ of the actual upper body support portion reaction force and the position ↑P_mb_vir in the virtual upper body support portion motion. Similarly, it can be considered that the relationship of the following formula (4a) is approximately established between the translational force ↑F_sb_act↑ of the actual slave upper body reaction force and the position ↑P_sb_act in the actual slave upper body motion.

↑F_mb_act=−Kfmb*↑P_mb_vir+↑Cfmb (3a)

↑F_sb_act=−Kfsb*↑P_sb_act+↑Cfsb (4a)

Additionally, the coefficients Kfmb and Kfsb are respectively coefficients (scalar or diagonal matrix) of predetermined values corresponding to so-called spring constants. Further, ↑Cfmb and ↑Cfsb are respectively constant vectors (vectors in which each component is a constant of a certain value).

The following formula (5a) can be obtained from the above formulas (1a), (3a), and (4a).

↑Efb=(−Kfmb*↑P_mb_vir+↑Cfmb) +Ratio_fsb*(−Kfsb*↑P_sb_act +↑Cfsb) =−Kfmb*↑P_mb_vir−Ratio_fsb*Kfsb*↑P_sb_act +↑Cfmb+Ratio_fsb*↑Cfsb (5a)

Here, the variables ↑ua and ↑va are defined by the following formulas (6a) and (7a).

↑ua=−Kfmb*↑P_mb_vir−Ratio_fsb*Kfsb*↑P_sb_act (6a)

↑va=↑P_mb_vir−Ratio_psb*↑P_sb_act (7a)

At this time, the following formulas (8a) and (9a) can be obtained from the above formulas (2a), (5a), (6a), and (7a).

↑Efb=↑ua+↑Cfmb+Ratio_fsb*↑Cfsb (8a)

↑Epb=↑va (9a)

Further, in order to allow the upper body reaction force translational force deviation ↑Efb to converge to zero, the second-order differential value of the upper body reaction force translational force deviation ↑Efb may match a target value ↑Efb_dotdot_aim satisfying the relational expression of the following formula (10a). Similarly, in order to allow the upper body position deviation ↑Epb to converge to zero, the second-order differential value of the upper body position deviation ↑Epb may match a target value ↑Epb_dotdot_aim satisfying the relational expression of the following formula (11a).

↑Efb_dotdot_aim=−Kfbp*↑Efb −Kfbv*↑Efb_dot (10a)

↑Epb_dotdot_aim=−Kpbp*↑Epb −Kpbv*↑Epb_dot (11a)

Additionally, the coefficients Kfbp and Kfbv on the right side of the formula (10a) are gains (scalar or diagonal matrix) of predetermined values and ↑Efb_dot is the first-order differential value (the temporal change rate) of ↑Efb. Further, the coefficients Kpbp and Kpbv on the right side of the formula (11a) are gains (scalar or diagonal matrix) of predetermined values and ↑Epb_dot is the first-order differential value (the temporal change rate) of ↑Epb.

Supplementally, in the present specification, the reference sign with “_dot” added thereto represents the first-order differential value (the temporal change rate) of the state quantity indicated by the reference sign with “_dot” removed therefrom and the reference sign with “_dotdot” added thereto represents the second-order differential value of the state quantity indicated by the reference sign with “_dotdot” removed therefrom.

On the other hand the following formulas (12a) and (13a) can be obtained by second-order differentiation of both sides of each of the above formulas (8a) and (9a).

↑Efb_dotdot=↑ua_dotdott (12a)

↑Epb_dotdot=↑va_dotdot (13a)

Thus, when the target value of ↑ua_dotdot for allowing the upper body reaction force translational force deviation ↑Efb to converge to zero is indicated by ua_dotdot_aim and the target value of ↑va_dotdot for allowing the upper body position deviation ↑Epb to converge to zero is indicated by ↑va_dotdot_aim, the following formulas (14a) and (15a) can be obtained from the formulas (12a) and (13a).

↑Efb_dotdot_aim=↑ua_dotdot_aim (14a)

↑Epb_dotdot_aim=↑va_dotdot_aim (15a)

Then, the following formulas (16a) and (17a) can be obtained from the above formulas (10a), (11a), (14a), and (15a).

↑ua_dotdot_aim =−Kfbp*↑Efb−Kfbv*↑Efb_dot (16a)

↑va_dotdot_aim =−Kpbp*↑Epb−Kpbv*↑Epb_dot (17a)

Further, the following formulas (18a) and (19a) for the target upper body support portion translational acceleration ↑Acc_mb_aim and the target slave upper body translational acceleration ↑Acc_sb_aim can be obtained from the relational expression obtained by second-order differentiation of both sides of each of the formulas (6a) and (7a).

↑ua_dotdot_aim=−Kfmb*↑Acc_mb_aim −Ratio_fsb*Kfsb*↑Acc_sb_aim (18a)

↑va_dotdot_aim=↑Acc_mb_aim−Ratio_psb*↑Acc_sb_aim (19a)

The following formulas (20a) and (21a) can be obtained by obtaining ↑Acc_mb_aim and ↑Acc_sb_aim using the formulas (18a) and (19a) as simultaneous formulas.

↑Acc_mb_aim =−(Ratio_psb/(Kfmb*Ratio_psb+Ratio_fsb*Kfsb))*↑ua_dotdot_aim +(Ratio_fsb*Kfsb/(Kfmb*Ratio_psb+Ratio_fsb*Kfsb))*↑va_dotdot_aim (20a)

↑Acc_sb_aim =−(1/(Kfmb*Ratio_psb+Ratio_fsb*Kfsb))*↑ua_dotdot_aim −(Kfmb/(Kfmb*Ratio_psb+Ratio_fsb*Kfsb))*↑va_dotdot_aim (21a)

The above formulas (16a), (17a), (20a), and (21a) are formulas for determining the target upper body support portion translational acceleration ↑Acc_mb_aim and the target slave upper body translational acceleration ↑Acc_sb_aim.

In this case, ↑ua_dotdot_aim is calculated according to the formula (16a) from the upper body reaction force translational force deviation ↑Efb obtained in STEP 3-1 and ↑Efb_dot obtained as the first-order differential value (the temporal change rate) thereof. Further, ↑va_dotdot_aim is calculated according to the formula (17a) from the upper body position deviation ↑Epb obtained in STEP 3-2 and ↑Epb_dot obtained as the first-order differential value (the temporal change rate) thereof.

Then, the target upper body support portion translational acceleration ↑Acc_mb_aim and the target slave upper body translational acceleration ↑Acc_sb_aim are calculated according to the formulas (20a) and (21a) from the calculated values of ↑ua_dotdot_aim and ↑va_dotdot_aim. Accordingly, ↑Acc_mb_aim and ↑Acc_sb_aim are determined so that the upper body reaction force translational force deviation ↑Efb and the upper body position deviation ↑Epb converge to zero.

Supplementally, the following formulas (22a) and (23a) can be obtained from the formulas (1 a) and (2a), the relational expression obtained by differentiation of both sides of each of the formulas (1a) and (2a), and the formulas (16a) and (17a).

↑ua_dotdot_aim =−Kfbp*↑Efb −Kfbv*↑Efb_dot =−Kfbp*(↑F_mb_vir+Ratio_fsb*↑F_sb_act) −Kfbv*(↑F_mb_dot_vir+Ratio_fsb*↑F_sb_dot_act) (22a)

↑va_dotdot_aim =−Kpbp*↑Epb−Kpbv*↑Epb_dot =−Kpbp*(↑P_mb_vir−Ratio_psb*↑P_sb_act) −Kpbv*(↑P_mb_dot_vir−Ratio_psb*↑P_sb_dot_act) =−Kpbp*(↑P_mb_vir−Ratio_psb*↑P_sb_act) −Kpbv*(↑V_mb_vir−Ratio_psb*↑V_sb_act) (23a)

Thus, ↑ua_dotdot_aim can be calculated according to the formula (22a) from each of the translational force ↑F_mb_act of the actual upper body support portion reaction force acquired in STEP 2, the translational force ↑F_sb_act of the actual slave upper body reaction force acquired in STEP 1, and ↑F_mb_dot_act and ↑F_sb_dot_act obtained as the first-order differential values (the temporal change rates) thereof.

Further, ↑va_dotdot_aim can be calculated according to the formula (23a) from the position ↑P_mb_vir and the translational velocity ↑V_mb_vir in the virtual upper body support portion motion acquired in STEP 2 and the position ↑P_sb_act and the translational velocity TV_sb_act in the actual slave upper body motion acquired in STEP 1.

In this case, it is not necessary to calculate the upper body reaction force translational force deviation ↑Efb and the upper body position deviation ↑Epb in STEP 3-1 and STEP 3-2, respectively.

Further, ↑Acc_mb_aim and ↑Acc_sb_aim can be calculated by the relational expression that integrates a set of the formulas (16a) and (17a), a set of the formulas (22a) and (23a), or a set of the formulas (20a) and (21a) (the relational expression that does not include ↑ua_dotdot_aim and ↑va_dotdot_aim).

The relational expression for determining the target upper body support portion angular acceleration ↑β_mb_aim and the target slave upper body angular acceleration ↑β_sb_aim can be also obtained as described above. In this case, the following formulas (3b), (4b), (6b), (7b), (10b), and (11b) are respectively defined as the relational expressions respectively corresponding to the above formulas (3a), (4a), (6a), (7a), (10a), and (11a).

↑M_mb_vir=−Kmmb*↑θ_mb_vir+↑Cmmb (3b)

↑M_sb_act=−Kmsb*↑θ_sb_act+↑Cmsb (4b)

↑ub=−Kmmb*↑θ_mb_vir−Ratio_msb*Kmsb*↑θ_sb_act (6b)

↑vb=↑θ_mb_vir−Ratio_thsb*↑θ_sb_act (7b)

↑Emb_dotdot_aim=−Kmbp*↑Emb−Kmbv*↑Emb_dot (10b)

↑Ethb_dotdot_aim=−Kthbp*↑Ethb−Kthbv*↑Ethb_dot (11b)

Additionally, similarly to the coefficient Kfmb of the formula (3a) and the coefficient Kfsb of the formula (4a), the coefficient Kmmb of the formulas (3b) and (6b) and the coefficient Kmsb of the formulas (4b) and (6b) are respectively coefficients (scalar or diagonal matrix) of predetermined values representing the rigidity and TCmmb of the formula (3b) and TCmsb of the formula (4b) are respectively constant vectors. Further, the coefficients Kmbp and Kmbv of the formula (10b) and the coefficients Kthbp and Kthbv of the formula (11b) are respectively gains (scalar or diagonal matrix) of predetermined values.

Then, the following formulas (16b), (17b), (20b), and (21b) respectively corresponding to the above formulas (16a), (17a), (20a), and (21a) can be obtained from these formulas (3b), (4b), (6b), (7b), (10b), and (11b) and the above formulas (1b) and (2b).

↑ub_dotdot_aim=−Kmbp*↑Emb−Kmbv*↑Emb_dot (16b)

↑vb_dotdot_aim=−Kthbp*↑Ethb−Kthbv*↑Ethb_dot (17b)

↑β_mb_aim =−(Ratio_thsb/(Kmmb*Ratio_thsb+Ratio_msb*Kmsb))*↑ub_dotdot_aim +(Ratio_msb*Kmsb/(Kmmb*Ratio_thsb+Ratio_msb*Kmsb))*↑vb_dotdot_aim (20b)

↑β_sb_aim =−(1/(Kmmb*Ratio_thsb+Ratio_msb*Kmsb))*↑ub_dotdot_aim −(Kmmb/(Kmmb*Ratio_thsb+Ratio_msb*Kmsb))*↑vb_dotdot_aim (21b)

The above formulas (16b), (17b), (20b), and (21b) are formulas for determining the target upper body support portion angular acceleration ↑β_mb_aim and the target slave upper body angular acceleration ↑β_sb_aim. In this case, ↑ub_dotdot_aim is calculated according to the formula (16b) from the upper body reaction force moment deviation ↑Emb obtained in STEP 3-1 and ↑Emb_dot obtained as the first-order differential value (the temporal change rate). Further, Tvb dotdot_aim is calculated according to the formula (17b) from the upper body posture deviation ↑Ethb obtained in STEP 3-2 and ↑Ethb_dot obtained as the first-order differential value (the temporal change rate) thereof.

Then, the target upper body support portion angular acceleration ↑β_mb_aim and the target slave upper body angular acceleration ↑β_sb_aim are calculated according to the formulas (20b) and (21b) from the calculated values of ↑ub_dotdot_aim and Tvb dotdot_aim. Accordingly, ↑β_mb_aim and ↑β_sb_aim are determined so that the upper body reaction force moment deviation ↑Emb and the upper body posture deviation ↑Ethb converge to zero.

Supplementally, the following formulas (22b) and (23b) can be obtained from the formulas (1b) and (2b), the relational expression obtained by differentiation of both sides of each of the formulas (1b) and (2b), and the formulas (16b) and (17b).

↑ub_dotdot_aim =−Kmbp*(↑M_mb_act+Ratio_msb*↑M_sb_act) Kmbv*(↑M_mb_dot_act+Ratio_msb*↑M_sb_dot_act) (22b)

↑vb_dotdot_aim =−Kthbp*(↑θ_mb_vir−Ratio_thsb*↑θ_sb_act) −Kthbv*(↑ω_mb_vir−Ratio_thsb*↑ω_sb_act) (23b)

Thus, ↑ub_dotdot_aim can be calculated according to the formula (22b) from each of the moment ↑M_mb_act of the actual upper body support portion reaction force acquired in STEP 2, the moment ↑M_sb_act of the actual slave upper body reaction force acquired in STEP 1, and ↑M_mb_dot_act and ↑M_sb_dot_act obtained as the first-order differential values (the temporal change rates) thereof.

Further, ↑vb_dotdot_aim can be calculated according to the formula (23b) from the posture angle ↑θ_mb_vir and the angular velocity ↑ω_mb_vir in the virtual upper body support portion motion acquired in STEP 2 and the posture angle ↑θ_sb_act and the angular velocity ↑θ_sb_act in the actual slave upper body motion acquired in STEP 1. In this case, a process of calculating the upper body reaction force moment deviation ↑Emb and the upper body posture deviation ↑Ethb in each of STEP 3-1 and STEP 3-2 is not necessary.

Further, ↑β_mb_aim and ↑β_sb_aim can be calculated by the relational expression that integrates a set of the formulas (16b) and (17b), a set of the formulas (22b) and (23b), or a set of the formulas (20b) and (21b) (the relational expression that does not include ↑ub_dotdot_aim and ↑vb_dotdot_aim).

Additionally, in this embodiment, in the motion of each of the upper body support portion 65 and the slave upper body, the posture angle and the angular velocity around the axis of the lateral direction are not controlled. For this reason, the calculation of the angular acceleration around the axis of the lateral direction in ↑β_mb_aim and ↑β_sb_aim may be omitted.

The process of the upper body side bilateral control of STEP 3 is executed as described above. Accordingly, the target upper body support portion translational acceleration ↑Acc_mb_aim and the target upper body support portion angular acceleration ↑β_mb_aim which are components of the target upper body support portion motion corresponding to the target motion of the upper body support portion 65 and the target slave upper body translational acceleration ↑Acc_sb_aim and the target slave upper body angular acceleration ↑β_sb_aim which are components of the target slave upper body motion corresponding to the target motion of the slave upper body are determined.

Additionally, the target upper body support portion translational acceleration ↑Acc_mb_aim and the target upper body support portion angular acceleration ↑β_mb_aim are the translational acceleration and the angular acceleration viewed in the virtual floor coordinate system Cvir and the target slave upper body translational acceleration ↑Acc_sb_aim and the target slave upper body angular acceleration ↑β_sb_aim are the translational acceleration and the angular acceleration viewed in the slave side global coordinate system Cs.

Returning to FIG. 7, the main manipulation control unit 94 executes the output of the target upper body support portion motion (↑Acc_mb_aim, ↑βmb_aim) and the target slave upper body motion (↑Acc_sb_aim, ↑βmsb_aim) determined as described above in STEP 4 and STEP 5. The above is the process of the main manipulation control unit 94.

[Control Process of Slave Movement Control Unit]

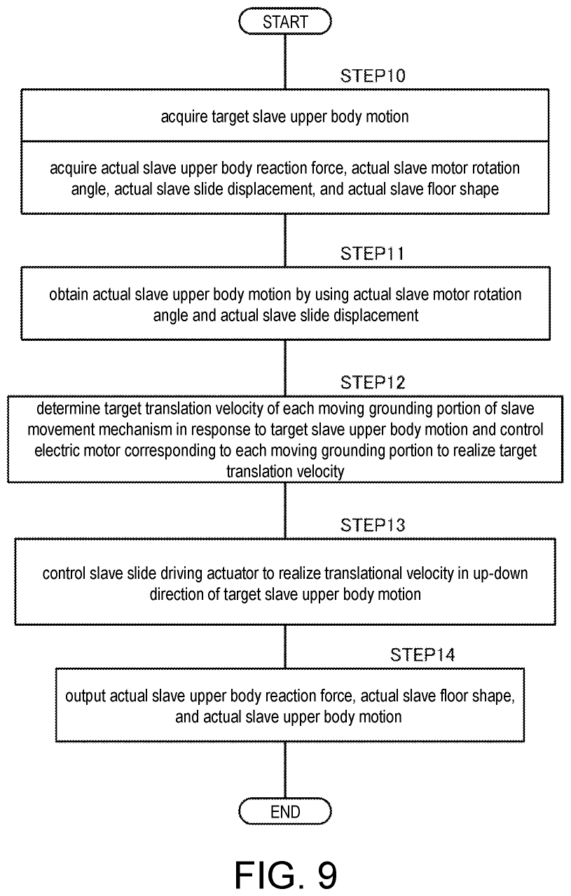

Next, a control process of the slave movement control unit 42 of the slave control device 41 will be described with reference to FIG. 9. The slave movement control unit 42 sequentially executes a process shown in the flowchart of FIG. 9 in a predetermined control process cycle.

In STEP 10, the slave movement control unit 42 acquires the target slave upper body motion. Specifically, the slave movement control unit 42 acquires (receives) the target slave upper body translational acceleration ↑Acc_sb_aim and the target slave upper body angular acceleration ↑β_sb_aim determined by the main manipulation control unit 94 from the main manipulation control unit 94 via the communication devices 40 and 90.

Further, the slave movement control unit 42 acquires the target slave upper body translational velocity ↑V_sb_aim which is the target translation velocity of the slave upper body and the target slave upper body angular velocity ↑ω_sb_aim which is the target angular velocity of the slave upper body by integrating each of the target slave upper body translational acceleration ↑Acc_sb_aim and the target slave upper body angular acceleration ↑β_sb_aim.

Further, the slave movement control unit 42 acquires the target slave upper body position ↑P_sb_aim which is the target position of the slave upper body and the target slave upper body posture angle ↑θ_sb_aim which is the target posture angle of the slave upper body by integrating each of the target slave upper body translational velocity ↑V_sb_aim and the target slave upper body angular velocity ↑ω_sb_aim.

Additionally, a process of obtaining ↑V_sb_aim, ↑P_sb_aim, ↑ω_sb_aim, and ↑θ_sb_aim may be executed by the main manipulation control unit 94. Then, in STEP 10, the slave movement control unit 42 may acquire ↑V_sb_aim, ↑P_sb_aim, ↑ω_sb_aim, and ↑θ_sb_aim from the main manipulation control unit 94 together with ↑Acc_sb_aim and ↑β_sb_aim or instead of ↑Acc_sb_aim and ↑β_sb_aim.

In STEP 10, the slave movement control unit 42 further acquires the actual slave upper body reaction force indicated by the output of the slave upper body force detector 33, the actual slave motor rotation angle of each of the electric motors 5a and 5b indicated by the output of the motor rotation detector 6 for each slave movement drive mechanism 5, the actual slave slide displacement indicated by the output of the slave slide displacement detector 37, and the actual slave floor shape (the actual slave floor tilt angle) indicated by the output of the slave floor shape detector 7.

In this case, the actual slave upper body reaction force acquired by the slave movement control unit 42 in STEP 10 is specifically the reaction force (the translational force and the moment) viewed in the slave upper body coordinate system Csb to be described below. The slave upper body coordinate system Csb is a local coordinate system set for the slave upper body and is, for example, the three-axis Cartesian coordinate system in which the Xsb-axis direction, the Ysb-axis direction, and the Zsb-axis direction are set as shown in FIG. 1. The origin of the slave upper body coordinate system Csb is set to, for example, the slave reference point Qs (the representative point of the slave upper body) (see FIG. 12A).

Then, the moment of the actual slave upper body reaction force acquired by the slave movement control unit 42 in STEP 10 is, specifically, the moment around the origin (the slave reference point Qs) of the slave upper body coordinate system Cs. Hereinafter, the reference sign of the translational force of the actual slave upper body reaction force viewed in the slave upper body coordinate system Cs acquired in STEP 10 is referred to as μF_sb_local_act and the reference sign of the moment is referred to as ↑M_sb_local_act.

The actual slave upper body reaction force (μF_sb_local_act, ↑M_sb_local_act) can be obtained by converting the detected value of the actual slave upper body reaction force (the translational force and the moment) viewed in the sensor coordinate system set for the slave upper body force detector 33 into the actual slave upper body reaction force viewed in the slave upper body coordinate system Csb.

Further, the actual slave floor tilt angle which is the actual slave floor shape acquired by the slave movement control unit 42 in STEP 10 is also the tilt angle viewed in the slave upper body coordinate system Csb. The actual slave floor tilt angle can be obtained as a set of the tilt angle in the direction around the Xsb axis (the roll direction) of the slave upper body coordinate system Csb and the tilt angle in the direction around the Ysb axis (the pitch direction).

Next, in STEP 11, the slave movement control unit 42 obtains the actual slave upper body motion by using the actual slave motor rotation angle (the observed value) and the actual slave slide displacement (the observed value) acquired in STEP 10.

Specifically, the slave movement control unit 42 first obtains the actual motor rotational velocity as the observed value of the actual rotational velocity (the angular velocity) of each rotation shaft of the electric motors 5a and 5b by a differential process for obtaining the temporal change rate of the actual slave motor rotation angle of each of the electric motors 5a and 5b for each slave movement drive mechanism 5. In this case, in order to suppress the influence of the high frequency noise component of the observed value of the actual slave motor rotation angle, it is preferable to use a pseudo differential (in other words, inexact differential) process as the differential process.

In the description below, ω_sw_mota_act (n) and ω_sw_motb_act (n) (n=1, 2, 3, and 4) are respectively used as the reference signs representing the actual motor rotational velocity of each of the electric motors 5a and 5b of the slave movement drive mechanism 5 corresponding to each of four moving grounding portions 4 (n) (n=1, 2, 3, and 4) of the slave device 1.

Further, the slave movement control unit 42 calculates the translational velocity V_sw_local_x_act (n) of the moving grounding portion 4 (n) in the Xsb-axis direction (the front-rear direction) of the slave upper body coordinate system Csb and the translational velocity V_sw_local_y_act (n) of the moving grounding portion 4 (n) in the Ysb-axis direction (the left-right direction) of the slave upper body coordinate system Csb for each slave moving grounding portion 4 (n) by the following formulas (31a) and (31b) from the actual motor rotational velocities ω_sw_mota_act (n) and ω_sw_motb_act (n) of the electric motors 5a and 5b.

V_sw_local_x_act (n) =Cswx*(ω_sw_mota_act (n)+ω_sw_motb_act (n)) (31a)

V_sw_loxal_y_act (n) =Cswy*(ω_sw_mota_act (n)−ω_sw_motb_act (n)) (31b)

The coefficients Cswx and Cswy are respectively coefficients of predetermined values defined depending on the structure or the like of the slave movement drive mechanism 5.

Then, as represented by the following formulas (32a) and (32b), the slave movement control unit 42 obtains an average value of the translational velocities V_sw_local_x_act (1) to V_sw_local_x_act (4) of four moving grounding portions 4 (1) to 4 (4) in the Xsb-axis direction as the translational velocity V_sb_local_x_act of the slave upper body in the Xsb-axis direction of the slave upper body coordinate system Csb and obtains an average value of the translational velocities V_sw_local_y_act (1) to V_sw_local_y_act (4) of four moving grounding portions 4 (1) to 4 (4) in the Ysb-axis direction as the translational velocity V_sb_local_y_act of the slave upper body in the Ysb-axis direction of the slave upper body coordinate system Csb.

V_sb_local_x_act =(V_sw_local_x_act (1)+V_sw_local_x_act (2) +V_sw_local_x_act (3)+V_sw_local_x_act (4))/4 (32a)

V_sb_local_y_act =(V_sw_local_y_act (1)+V_sw_local_y_act (2) +(V_sw_local_y_act (3) +V_sw_local_y_act (4))/4 (32b)

Further, the slave movement control unit 42 calculates the angular velocity ω_sb_local_z_act of the slave base 3 in the direction around the Zsb axis (the yaw direction) of the slave upper body coordinate system Csb by the following formula (33).

ω_sb_local_z_act =(V_sw_local_x_act (1)−V_sw_local_x_act (4))/(2*(Lswy (1)+Lswy (4))) +(V_sw_local_x_act (2)−V_sw_local_x_act (3))/(2*(Lswy (2)+Lswy (3))) (33)

As shown in FIG. 12A, Lswy (1), Lswy (2), Lswy (3), and Lswy (4) of the above formula (33) are respectively distances between the slave reference point Qs and the grounded portions of the moving grounding portion 4 (1) of the left front portion of the slave base 3, the moving grounding portion 4 (2) of the left rear portion, the moving grounding portion 4 (3) of the right rear portion, and the moving grounding portion 4 (4) of the right front portion in the Ysb-axis direction (the left-right direction). Additionally, in this case, the positive and negative polarities of Lswy (1), Lswy (2), Lswy (3), and Lswy (4) are defined as Lswy (1)>0, Lswy (2)>0, Lswy (3)<0, and Lswy (4)<0. Additionally, the angular velocity ω_sb_local_z_act of the slave base 3 in the yaw direction can be detected by using, for example, an angular velocity sensor.

Here, in this embodiment, the Zs-axis direction of three coordinate-axis directions (the Xs-axis direction, the Ys-axis direction, and the Zs-axis direction) of the slave side global coordinate system Cs (the three-axis Cartesian coordinate system) is set as the same direction (the up-down direction) as the Zsb-axis direction of the slave upper body coordinate system Csb. For this reason, the angular velocity ω_sb_local_z_act calculated by the above formula (63) matches the angular velocity ω_sb_z_act in the direction around the Zs axis (the yaw direction) in the angular velocity ↑ω_sb_act of the actual slave upper body motion viewed in the slave side global coordinate system Cs. Thus, the angular velocity ω_sb_z_act in the direction around the Zs axis (the yaw direction) in the angular velocity ↑ω_sb_act of the actual slave upper body motion viewed in the slave side global coordinate system Cs is obtained by the formula (33).

Then, the slave movement control unit 42 further calculates the posture angle θ_sb_z_act in the direction around the Zs axis (in other words, the direction of the slave upper body) in the posture angle ↑θ_sb_act of the actual slave upper body motion viewed in the slave side global coordinate system Cs by integrating the angular velocity ω_sb_z_act obtained as described above.

Additionally, in this embodiment, the calculation of the angular velocity in the direction around the Xs axis and the angular velocity in the direction around the Ys axis of the slave side global coordinate system Cs in the angular velocity ↑ω_sb_act of the actual slave upper body motion (in other words, the calculation of the angular velocity around the axis in the direction (the lateral direction) orthogonal to the up-down direction) is omitted. The same applies to the posture angle ↑θ_sb_act of the actual slave upper body motion.

Further, the slave movement control unit 42 obtains components other than the Zs-axis direction (the translational velocity V_sb_x_act in the Xs-axis direction and the translational velocity V_sb_y_act in the Ys-axis direction of the slave side global coordinate system Cs) in the translational velocity ↑V_sb_act of the actual slave upper body motion viewed in the slave side global coordinate system Cs by rotationally converting vectors in which V_sb_local_x_act and V_sb_local_y_act obtained by the above formulas (32a) and (32b) are two components (two-dimensional vectors on the XsbYsb coordinate plane of the slave upper body coordinate system Csb) in the direction around the Zs axis only by an angle matching the posture angle θ_sb_z_act in the direction around the Zs axis obtained as described above.

Then, the slave movement control unit 42 obtains the position P_sb_x_act in the Xs-axis direction and the position P_sb_y_act in the Ys-axis direction in the position ↑P_sb_act of the actual slave upper body motion by integrating the translational velocities V_sb_x_ac and V_sb_y_act.

Further, the slave movement control unit 42 obtains the position P_sb_z_act in the Zs-axis direction in the position ↑P_sb_act of the actual slave upper body motion from the actual slave slide displacement (the observed value) acquired in STEP 10 and further obtains the translational velocity V_sb_z_act in the Zs-axis direction in the translational velocity ↑V_sb_act of the actual slave upper body motion by a differential process of obtaining the temporal change rate of P_sb_z_act.

In this embodiment, the actual slave upper body motion (the position ↑P_sb_act, the translational velocity ↑V_sb_act, the posture angle ↑θ_sb_act, and the angular velocity ↑ω_sb_act) is obtained by the above-described process of STEP 11. Supplementally, the position ↑P_sb_act and the posture angle ↑θ_sb_act in the actual slave upper body motion may be corrected at any time based on the environmental recognition information such as landmarks around the slave device 1 in order to prevent the accumulation of integration errors.

Next, in STEP 12, the slave movement control unit 42 determines the target translation velocity of each moving grounding portion 4 of the slave movement mechanism 2 in response to the target slave upper body motion and controls the electric motors 5a and 5b corresponding to each moving grounding portion 4 to realize the target translation velocity.

Specifically, the slave movement control unit 42 obtains the target translation velocity V_sb_local_x_aim of the slave upper body in the Xsb-axis direction of the slave upper body coordinate system Csb and the target translation velocity V_sb_local_y_aim of the slave upper body in the Ysb-axis direction of the slave upper body coordinate system Csb by rotationally converting vectors including the translational velocity V_sb_x_aim in the Xs-axis direction and the translational velocity V sb y aim in the Ys-axis direction in the target slave upper body translational velocity ↑V_sb_aim acquired in STEP 10 (two-dimensional vectors on the XsYs coordinate plane of the slave side global coordinate system Cs) only by the angle (=−θ_sb_z_aim) that is (−1) times the component θ_sb_z_aim in the direction around the Zs axis of the target slave upper body posture angle ↑θ_sb_aim acquired in STEP 10 in the direction around the Zs axis.

Then, the slave movement control unit 42 determines the target translation velocity V_sw_local_x_aim (n) in the Xsb-axis direction and the target translation velocity V_sw_local_y_aim (n) in the Ysb-axis direction of each of the moving grounding portions 4 (n) (n=1, 2, 3, and 4) viewed in the slave upper body coordinate system Csb by the following formulas (34a) and (34b) to realize the target translation velocities V_sb_local_x_aim and V_sb_local_y_aim in the slave upper body coordinate system Csb and the component ω_sb_z_aim in the direction around the Zs axis in the slave upper body angular velocity ↑ω_sb_aim viewed in the slave side global coordinate system Cs.

V_sw_local_x_aim (n)=V_sb_local_x_aim−Lswy (n)*ω_sb_z_aim (34a)

V_sw_local_y_aim (n)=V_sb_local_y_aim+Lswx (n)*ω_sb_z_aim (34b)

Further, the slave movement control unit 42 calculates the target motor rotational velocities ω_sw_mota_aim (n) and ω_sw_motb_aim (n) which are the target values of the rotational velocities of the electric motors 5a and 5b for realizing the target translation velocities V_sw_local_x_aim (n) and V_sw_local_y_aim (n) for each moving grounding portion 4 (n) by the following formulas (35a) and (35b) obtained from the above formulas (31a) and (31b).

ω_sw_mota_aim (n) =(Cswy*V_sw_local_x_aim (n)+Cswx*V_sw_local_y_aim (n))/(2*Cswx*Cswy) (35a)

ω_sw_motb_aim (n) =(Cswy*V_sw_local_x_aim (n)−Cswx*V_sw_local_y_aim (n))/(2*Cswx*Cswy) (35b)

Next, the slave movement control unit 42 determines the target motor driving forces Tq_sw_mota_aim (n) and Tq_sw_motb_aim (n) which are the target values of the driving forces (the rotational driving forces) of the electric motors 5a and 5b for allowing the actual motor rotational velocities ω_sw_mota_act (n) and ω_sw_motb_act (n) of the electric motors 5a and 5b to follow the target motor rotational velocities ω_sw_mota_aim (n) and ω_sw_motb_aim (n) for each moving grounding portion 4 (n) by the following formulas (36a) and (36b). These target motor driving forces Tq_sw_mota_aim (n) and Tq_sw_motb_aim (n) (n=1, 2, 3, and 4) are the target slave movement driving forces shown in FIG. 2.

Tq_sw_mota_aim (n) =Kv_sw_mota*(ω_sw_mota_aim (n)−ω_sw_mota_act (n)) (36a)

Tq_sw_motb_aim (n) =Kv_sw_motb*(ω_sw_motb_aim (n)−ω_sw_motb_act (n)) (36b)

Additionally, Kv_sw_mota and Kv_sw_motb are gains of predetermined values. Supplementally, the formulas (36a) and (36b) are formulas for determining Tq_sw_mota_aim (n) and Tq_sw_motb_aim (n) by a proportional law as an example of a feedback control law, but Tq_sw_mota_aim (n) and Tq_sw_motb_aim (n) may be determined by other feedback control laws (for example, a proportional/differential law and the like).

Next, the slave movement control unit 42 operates the electric motors 5a and 5b corresponding to each moving grounding portion 4 (n) to output the target motor driving forces Tq_sw_mota_aim (n) and Tq_sw_motb_aim (n) determined as described above. Accordingly, the movement of the slave movement mechanism 2 is controlled to realize the translational velocity V_sb_x_aim in the X-axis direction and the translational velocity V_sb_y_aim in the Y-axis direction in the target slave upper body translational velocity ↑V_sb_aim.

In this embodiment, the target motor driving forces Tq_sw_mota_aim (n) and Tq_sw_motb_aim (n) of the electric motors 5a and 5b corresponding to each moving grounding portion 4 (n) which are the target slave movement driving forces of the slave movement mechanism 2 are determined to realize a motion other than the translational velocity in the Zs-axis direction (the up-down direction) in the target slave upper body translational velocity ↑V_sb_aim by the above-described process of STEP 12. Then, the electric motors 5a and 5b corresponding to each moving grounding portion 4 (n) are controlled to generate the target motor driving forces Tq_sw_mota_aim (n) and Tq_sw_motb_aim (n). Accordingly, the movement of the slave movement mechanism 2 is controlled to realize a motion other than the translational velocity in the Zs-axis direction (the up-down direction) in the target slave upper body translational velocity ↑V_sb_aim.

Next, in STEP 13, the slave movement control unit 42 controls the slave slide actuator 36 to realize the translational velocity V_sb_z_aim in the Zs-axis direction (the up-down direction) in the target slave upper body translational velocity ↑V_sb_aim.

Specifically, the slave movement control unit 42 determines the target driving force of the slide actuator 36 by a feedback control law such as a proportional law or a proportional/differential law in response to the deviation between the translational velocity V_sb_z_aim in the Zs-axis direction in the target slave upper body translational velocity ↑V_sb_aim acquired in STEP 10 and the translational velocity Vsb_z_act in the Zs-axis direction in the translational velocity ↑V_sb_act of the actual slave upper body motion obtained in STEP 12.

Accordingly, the target driving force of the slide actuator 36 is determined so that the deviation approaches zero. Then, the slave movement control unit 42 controls the slide actuator 36 to generate the target driving force.

Next, in STEP 14, the slave movement control unit 42 outputs (transmits) the actual slave upper body reaction force (μF_sb_local_act, ↑M_sb_local_act) and the actual slave floor shape (the actual slave floor tilt angle) acquired in STEP 10 and the actual slave upper body motion (↑V_sb_act, ↑P_sb_act, ↑ω_sb_act, ↑θ_sb_act) obtained in STEP 12 to the main manipulation control unit 94. The process of the slave movement control unit 42 is executed as described above.

Supplementally, since the actual slave upper body reaction force (↑F_sb_local_act, ↑M_sb_local_act) output to the main manipulation control unit 94 in STEP 14 is the actual slave upper body reaction force viewed in the slave upper body coordinate system Csb, the main manipulation control unit 94 converts the actual slave upper body reaction force input from the slave movement control unit 42 into the actual slave upper body reaction force (↑F_sb_act, ↑M_sb_act) viewed in the slave side global coordinate system by using the position ↑P_sb_act and the posture angle ↑θ_sb_act of the actual slave upper body motion input from the slave movement control unit 42 together with the actual slave upper body reaction force. Then, the above-described process is executed by using the converted actual slave upper body reaction force.

However, the actual slave upper body reaction force viewed in the slave upper body coordinate system Csb may be converted into the actual slave upper body reaction force viewed in the slave side global coordinate system Cs by the slave movement control unit 42. In this case, the converting process in the main manipulation control unit 94 is not necessary.

[Control Process of Master Movement Control Unit]

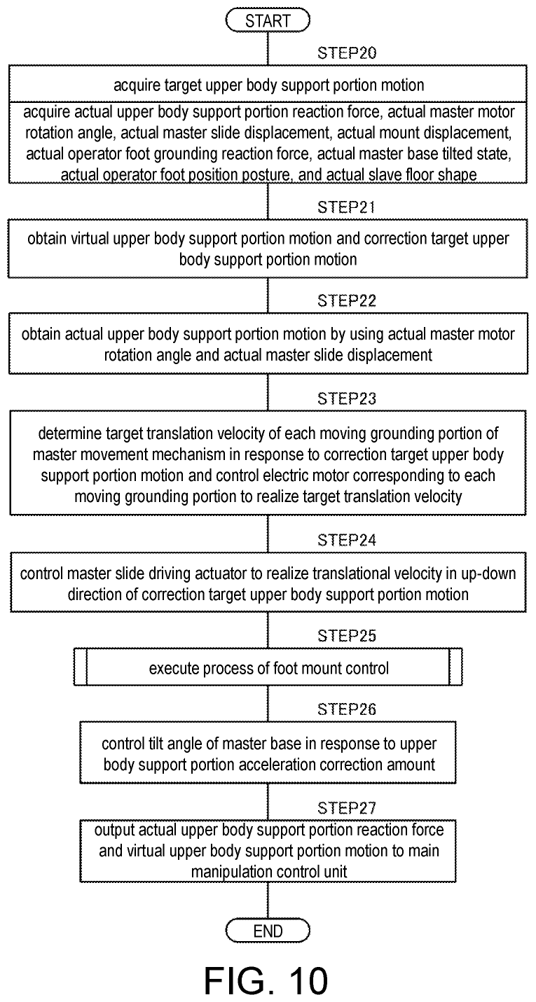

Next, a control process of the master movement control unit 92 of the master control device 91 will be described with reference to FIG. 10. The master movement control unit 92 sequentially executes a process shown in the flowchart of FIG. 10 in a predetermined control process cycle.

In STEP 20, the master movement control unit 92 acquires the target upper body support portion motion. Specifically, the master movement control unit 92 acquires (receives) the target upper body support portion translational acceleration ↑Acc_mb_aim and the target upper body support portion angular acceleration ↑β_mb_aim determined by the main manipulation control unit 94 as the components of the target upper body support portion motion from the main manipulation control unit 94.

In STEP 20, the master movement control unit 92 further acquires the actual upper body support portion reaction force indicated by the output of the master upper body force detector 64, the actual master motor rotation angle detected value of each of the electric motors 55a and 55b and indicated by the output of the motor rotation detector 56 for each master movement drive mechanism 55, the actual master slide displacement indicated by the output of the master slide displacement detector 67, the actual mount displacement (the actual mount actuator displacement) indicated by the output of the mount displacement detector 76 corresponding to each of the left and right feet mounts 90L and 90R, the actual foot grounding reaction force indicated by the foot force detector 74 corresponding to each of the left and right feet of the operator P, the actual master base tilted state (the actual base tilting actuator displacement) indicated by the output of the base tilting detector 59, the actual operator foot position posture (a set of the actual operator foot position and the actual operator foot posture angle) indicated by the output of the operator foot position posture detector 77 for each of the left and right feet of the operator P, and the actual slave floor shape (the actual slave floor tilt angle) input from the slave control device 41 to the master control device 91.

In this case, the actual upper body support portion reaction force acquired by the master movement control unit 92 in STEP 20 is specifically the reaction force (the translational force and the moment) viewed in the master upper body coordinate system Cmb to be described later. The master upper body coordinate system Cmb is a local coordinate system set for the upper body support portion 65 and is, for example, the three-axis Cartesian coordinate system Cm in which the Xmb-axis direction, the Ymb-axis direction, and the Zmb-axis direction are set as shown in FIG. 3 or 4. The origin of the master upper body coordinate system Cmb is set to, for example, the master reference point Qm (the representative point of the upper body support portion 65) (see FIG. 12B).

Then, the moment of the actual upper body support portion reaction force acquired by the master movement control unit 92 in STEP 20 is specifically the moment around the origin of the master upper body coordinate system Cmb (the master reference point Qm). Hereinafter, the reference sign of the translational force of the actual upper body support portion reaction force viewed in the master upper body coordinate system Cmb acquired in STEP 20 is indicated by ↑F_mb_local_act and the reference sign of the moment is indicated by ↑M_mb_local_act.

The actual upper body support portion reaction force (↑F_mb_local_act, ↑M_mb_local_act) can be obtained by converting the detected value of the actual upper body support portion reaction force (the translational force and the moment) viewed in the sensor coordinate system set for the master upper body force detector 64 into the actual upper body support portion reaction force viewed in the master upper body coordinate system Cmb.

Further, the actual operator foot grounding reaction force and the actual operator foot position posture acquired by the master movement control unit 92 in STEP 20 are also the grounding reaction force and the position posture viewed in each master upper body coordinate system Cmb. Additionally, in this embodiment, the operator foot grounding reaction force acquired in STEP 20 may by only the translational force in the Zmb-axis direction (the up-down direction) of the master upper body coordinate system Cmb. Further, the posture angle in the actual operator foot position posture may be only the posture angle (the actual foot direction) in the yaw direction (the direction around the Zmb axis).

Next, in STEP 21, the master movement control unit 92 determines the virtual upper body support portion motion and the correction target upper body support portion motion. Here, the virtual upper body support portion motion means the motion of the upper body support portion 65 virtually realized with respect to the virtual floor on the assumption that the motion of the upper body support portion 65 on the virtual floor is performed according to the target upper body support portion motion determined as described above by the main manipulation control unit 94.

In this embodiment, the operation of the master device 51 is controlled so that the virtual upper body support portion motion with respect to the virtual floor follows the target upper body support portion motion. For this reason, the master movement control unit 92 determines the virtual upper body support portion motion by considering that the virtual upper body support portion motion matches the target upper body support portion motion.

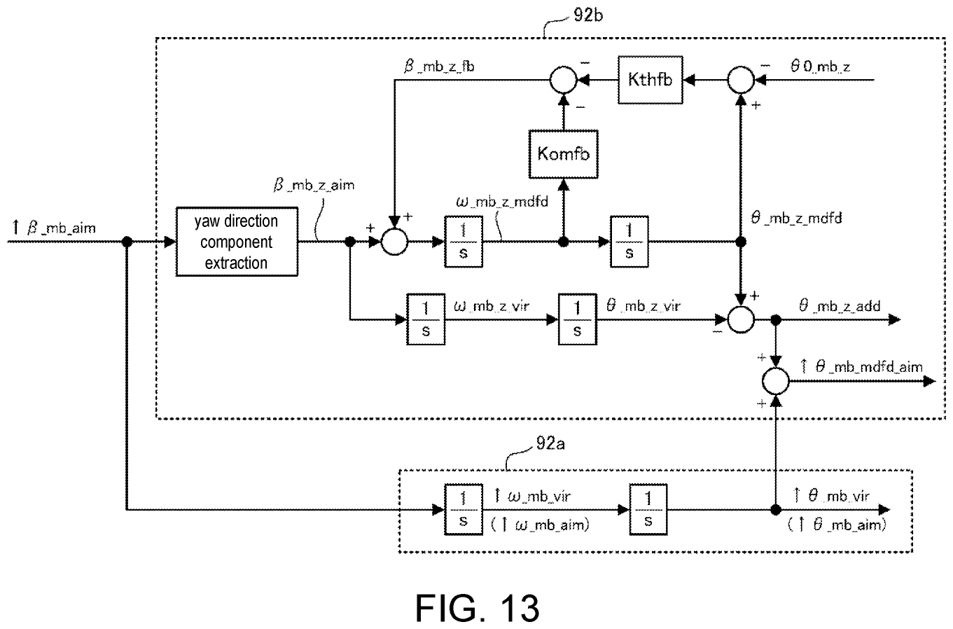

Specifically, as shown by the processing unit 92a of FIG. 13, the master movement control unit 92 calculates the virtual upper body support angular velocity ↑ω_mb_vir as the observed value (pseudo-estimated value) of the angular velocity of the upper body support portion 65 with respect to the virtual floor by integrating the target upper body support portion angular acceleration ↑β_mb_aim in the target upper body support portion motion. Further, the master movement control unit 92 calculates the virtual upper body support portion posture angle ↑θ_mb_vir as the observed value (pseudo-estimated value) of the posture angle of the upper body support portion 65 with respect to the virtual floor by integrating the virtual upper body support angular velocity ↑ω_mb_vir.

In other words, the master movement control unit 92 determines the target upper body support angular velocity ↑ω_mb_aim (the target angular velocity of the upper body support portion 65) obtained by integrating the target upper body support portion angular acceleration ↑β_mb_aim and the target upper body support posture angle ↑θ_mb_aim (the target posture angle of the upper body support portion 65) obtained by integrating the target upper body support angular velocity ↑ω_mb_aim as the virtual upper body support angular velocity ↑ω_mb_vir and the virtual upper body support portion posture angle ↑θ_mb_vir, respectively.

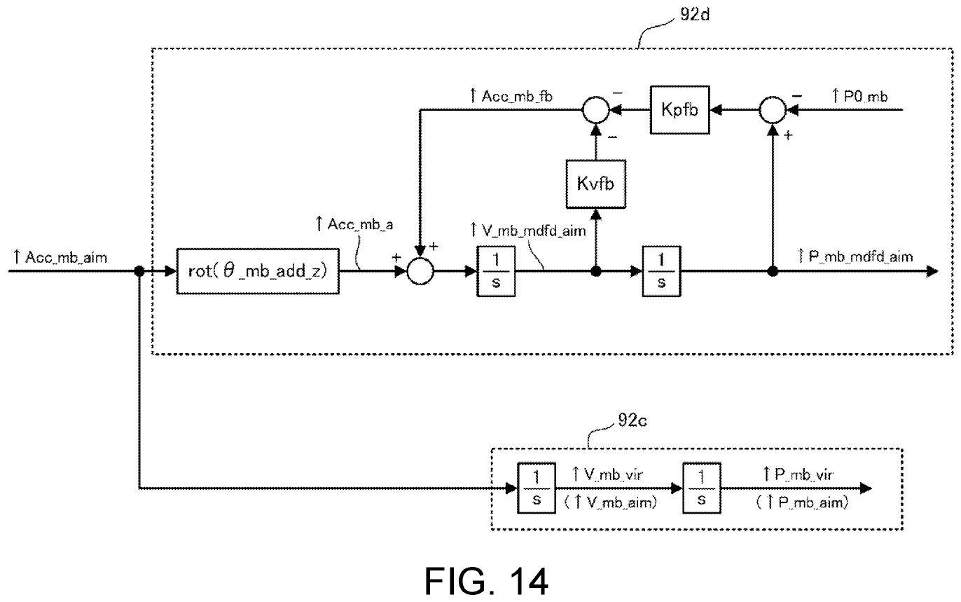

Further, as shown by the processing unit 92c of FIG. 14, the master movement control unit 92 calculates the virtual upper body support portion translational velocity ↑V_mb_vir as the observed value (pseudo-estimated value) of the translational velocity of the upper body support portion 65 with respect to the virtual floor by integrating the target upper body support portion translational acceleration ↑Acc_mb_aim in the target upper body support portion motion. Further, the master movement control unit 92 calculates the virtual upper body support portion position ↑P_mb_vir as the observed value (pseudo-estimated value) of the position of the upper body support portion 65 with respect to the virtual floor by integrating the virtual upper body support portion translational velocity ↑V_mb_vir.

In other words, the master movement control unit 92 determines the target upper body support portion translational velocity ↑V_mb_aim (the target translation velocity of the upper body support portion 65) obtained by integrating the target upper body support portion translational acceleration ↑Acc_mb_aim and the target upper body support portion position ↑P_mb_aim (the target position of the upper body support portion 65) obtained by integrating the target upper body support portion translational velocity ↑V_mb_aim as the virtual upper body support portion translational velocity ↑V_mb_vir and the virtual upper body support portion position ↑P_mb_vir, respectively.

In STEP 21, as described above, the virtual upper body support angular velocity ↑ω_mb_vir, the virtual upper body support portion posture angle ↑θ_mb_vir, the virtual upper body support portion translational velocity ↑V_mb_vir, and the virtual upper body support portion position ↑P_mb_vir are obtained as the components of the virtual upper body support portion motion.

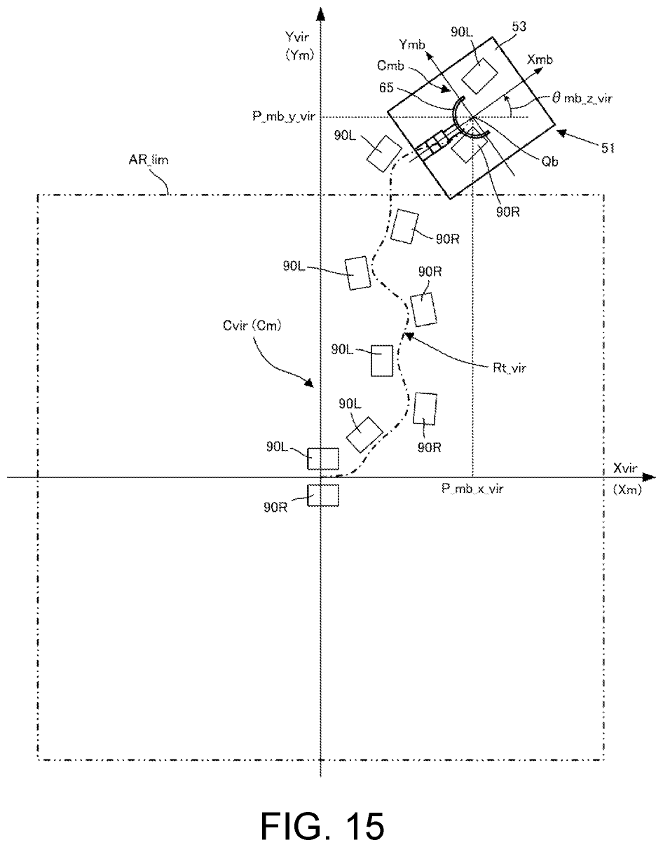

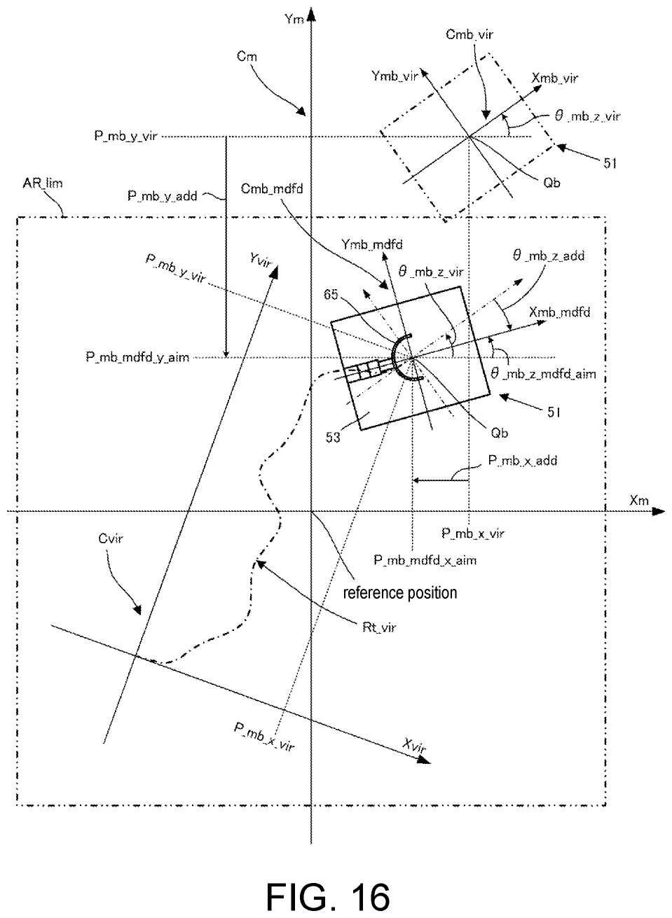

FIG. 15 shows the posture angle θmb_z_vir in the yaw direction (the direction around the Zvir axis in the virtual floor coordinate system Cvir) in the virtual upper body support portion posture angle ↑θ_mb_vir obtained as described above and the position P_mb_x_vir in the Xvir-axis direction and the position P_mb_y_vir in the Yvir-axis direction in the virtual upper body support portion position ↑P_mb_vir. Additionally, only the main configuration of the master device 51 is simply shown in FIG. 15. The same applies to FIG. 16 to be described later.

The foot mounts 70L and 70R shown in FIG. 15 show the positions of the foot mounts 70L and 70R (the positions on the virtual floor) while each of the left and right feet of each operator P on the foot mounts 70L and 70R is grounded during the walking operation of the operator P on the master device 51.

Further, a route Rt_vir indicated by a one-dotted chain line shows the movement route (the movement route viewed in the XvirYvir coordinate plane of the virtual floor coordinate system Cvir) of the representative point (the master reference point Qm) of the upper body support portion 65 by the virtual upper body support portion motion according to the walking operation of the operator P.

Supplementally, as a result of a process of obtaining the virtual upper body support portion motion in STEP 21, the target upper body support angular velocity ↑ω_mb_aim (=↑ω_mb_vir), the target upper body support posture angle ↑θ_mb_aim (=↑θ_mb_vir), the target upper body support portion translational velocity ↑V_mb_aim (=↑V_mb_vir), and the target upper body support portion position ↑P_mb_aim (=↑P_mb_vir) which are the components of the target upper body support portion motion (the target upper body support portion motion viewed in the virtual floor coordinate system Cvir) with respect to the virtual floor are also obtained.

Additionally, a process of obtaining ↑ω_mb_vir, ↑θ_mb_vir, ↑V_mb_vir, and ↑P_mb_vir (or ↑ω_mb_aim, ↑θ_mb_aim, ↑V_mb_aim, and ↑P_mb_aim) may be executed by the main manipulation control unit 94. Then, the master movement control unit 92 may acquire ↑ω_mb_vir, ↑θ_mb_vir, ↑V_mb_vir, and ↑P_mb_vir (or ↑ω_mb_aim, ↑θ_mb_aim, ↑V_mb_aim, and ↑P_mb_aim) from the main manipulation control unit 94.

In STEP 21, the correction target upper body support portion motion determined by the master movement control unit 92 means the target motion (the target motion viewed in the master side global coordinate system Cm) of the upper body support portion 65 with respect to the master floor. Here, it is possible to perform the operation control of the master device 51 (the motion control of the upper body support portion 65 and each foot mount 70) so that the virtual floor as a pseudo floor surface on which the operator P performs the walking operation on the master device 51 is maintained in a stationary state with respect to the master floor.

Specifically, it is possible to maintain the virtual floor in a stop state with respect to the master floor by controlling the operation of the master device 51 so that the foot mount 70R (or 70L) on the free leg side and the upper body support portion 65 move relatively with respect to the foot mount 70L (or 70R) on the support leg side in such a manner that the foot mount 70L (or 70R) on the support leg side which is the foot mount 70L (or 70R) for grounding the foot on the support leg side of the operator P is stopped with respect to the master floor and the foot mount 70R (or 70L) on the free leg side which is the foot mount 70R (or 70L) corresponding to the foot on the free leg side of the operator P follows a position directly below the foot (in other words, the lateral position of the foot mount 70R (or 70L) on the free leg side follows the lateral position of the foot on the free leg side of the operator P during the walking operation of the operator P on the master device 51.

Hereinafter, the operation control of such a master device 51 (the operation control of fixing the virtual floor to the master floor) will be referred to as strict virtual floor control. When the operation of the master device 51 is controlled by the strict virtual floor control, the operator P can walk on the virtual floor in the same manner as the walking operation on the master floor.

However, the position of the master device 51 with respect to the master floor or the movable range of the posture angle (direction) in the yaw direction is restricted by the wall or installed object present in the operation environment of the master device 51 or the cable or the like connected to the master device 51. For this reason, in the strict virtual floor control, a situation is likely to occur in which the master device 51 cannot move in the operation environment even when the operator P tries to move the slave device 1 to an arbitrary position or an arbitrary direction on the slave floor by the walking operation on the virtual floor. Further, a situation is likely to occur in which the slave device 1 cannot be manipulated to move.

For example, as shown in FIG. 15, when the virtual floor is fixed with respect to the master floor (the virtual floor coordinate system Cvir is fixed with respect to the master side global coordinate system Cm), even when the operator P performs the walking operation to move the master device 51 along the route Rt_vir (shown in the drawings) on the virtual floor, the master device 51 cannot move to a portion departing from a movable area AR_lim (indicated by a two-dotted chain line in FIG. 15) of the master device 51 in the route Rt_vir during the strict virtual floor control.

Here, in this embodiment, the master movement control unit 92 determines the correction target upper body support portion motion as the target motion of the upper body support portion 65 with respect to the master floor to suppress the representative point of the master device 51, for example, the position of the master reference point Qm from deviating from a predetermined reference position set in advance in the operation environment of the master device 51 and suppress the posture angle (direction) of the upper body support portion 65 in the yaw direction from deviating from a predetermined reference posture angle (reference direction) in the yaw direction set in the operation environment of the master device 51.

Additionally, in this embodiment, since the position of the master reference point Qm is set as described above, that position has a meaning as the position of the upper body support portion 65. In addition, the lateral position of the master reference point Qm also has a meaning as the lateral position of the base 53. Further, in this embodiment, the reference position of the master device 51 includes the lateral position (the Xm-axis direction position and the Ym-axis direction position) and the up-down direction position (the Zm-axis direction position).

The correction target upper body support portion motion is determined by correcting the target upper body support portion motion (this corresponds to the target upper body support portion motion in the strict virtual floor control) on the assumption that the virtual floor is fixed to the master floor. In this case, as the components of the correction target upper body support portion motion, the correction target upper body support posture angle ↑θ_mb_mdfd_aim which is the target posture angle of the upper body support portion 65 viewed in the master side global coordinate system Cm and the correction target upper body support portion position ↑P_mb_mdfd_aim which is the target position of the upper body support portion 65 viewed in the master side global coordinate system Cm are determined.

The correction target upper body support posture angle ↑θ_mb_mdfd_aim is determined by the process shown by the processing unit 92b of FIG. 13. Additionally, in the description below, for convenience of description, the origin of the master side global coordinate system Cm, the Xm-axis direction, the Ym-axis direction, and the Zm-axis direction are set to respectively match the origin of the virtual floor coordinate system Cvir, the Xvir-axis direction, the Yvir-axis direction, and the Zvir-axis direction when starting the walking operation of the operator P on the master device 51 (when starting the manipulation of the slave device 1).

In the process of the processing unit 92b, the master movement control unit 92 extracts the angular acceleration β_mb_z_aim which is the yaw direction component (the component in the direction around the Zvir axis of the virtual floor coordinate system Cvir) in the target upper body support portion angular acceleration ↑β_mb_aim (the target upper body support portion angular acceleration ↑β_mb_aim viewed in the virtual floor coordinate system Cvir) acquired in STEP 20.

Then, the master movement control unit 92 obtains the non-correction angular velocity ω_mb_z_vir which is the angular velocity obtained by integrating the angular acceleration β_mb_z_aim and further obtains the non-correction posture angle θ_mb_z_vir which is the posture angle obtained by integrating the non-correction angular velocity ω_mb_z_vir. In other words, the non-correction angular velocity ω_mb_z_vir and the non-correction posture angle θ_mb_z_vir are the angular velocity (the angular velocity viewed in the master side global coordinate system Cm) and the posture angle (the posture angle viewed in the master side global coordinate system Cm) in the yaw direction of the upper body support portion 65 defined by the target upper body support portion motion while the virtual floor is fixed to the master floor.

Supplementally, the non-correction angular velocity ω_mb_z_vir and the non-correction posture angle θ_mb_z_vir respectively match the components in the yaw direction (the direction around the Zvir axis) of the virtual upper body support angular velocity ↑ω_mb_vir and the virtual upper body support portion posture angle ↑θ_mb_vir calculated by the processing unit 92a. Thus, the yaw direction components of ↑ω_mb_vir and ↑θ_mb_vir may be extracted as the non-correction angular velocity ω_mb_z_vir and the non-correction posture angle θ_mb_z_vir.

Further, the master movement control unit 92 obtains the correction angular acceleration (=β_mb_z_aim+β_mb_z_fb) obtained by correcting the angular acceleration β_mb_z_aim in the yaw direction extracted from the target upper body support portion angular acceleration ↑β_mb_aim by the feedback correction amount β_mb_z_fb. Then, the master movement control unit 92 obtains the correction angular velocity ω_mb_z_mdfd as the angular velocity obtained by integrating the correction angular acceleration and further obtains the correction posture angle θ_mb_z_mdfd as the posture angle (the direction of the yaw direction) obtained by integrating the correction angular velocity ω_mb_z_mdfd.

In this case, the feedback correction amount β_mb_z_fb is calculated by the arithmetic process of the following formula (41) using the updated values of the correction angular velocity ω_mb_z_mdfd and the correction posture angle θ_mb_z_mdfd and the reference posture angle θ0_mb_z in the yaw direction of the upper body support portion 65 viewed in the master side global coordinate system Cm.

β_mb_z_fb=−Kthfb*(θ_mb_z_mdfd−θ0_mb_z)−Komfb*ω_mb_z_mdfd (41)

Additionally, the coefficients Kthfb and Komfb are gains of predetermined values of the formula (41). The values of the coefficients Kthfb and Komfb are set so that an absolute value of the feedback correction amount β_mb_z_fb converges to a comparatively small value.

Thus, the feedback correction amount β_mb_z_fb is determined so that the correction posture angle θ_mb_z_mdfd gradually converges to the reference posture angle θ0_mb_z. Additionally, the process of obtaining the feedback correction amount β_mb_z_fb by the formula (41) is a process of obtaining β_mb_z_fb by a proportional/differential law, but β_mb_z_fb may be obtained by using other feedback control laws (a proportional law and the like).

The master movement control unit 92 further obtains a difference (=θ_mb_z_mdfd−θ_mb_z_vir) between the correction posture angle θ_mb_z_mdfd and the non-correction posture angle θ_mb_z_vir obtained as described above as the posture angle correction amount θmb_z_add of the upper body support portion 65 in the yaw direction. Then, the master movement control unit 92 obtains the correction target upper body support posture angle ↑θ_mb_mdfd_aim viewed in the master side global coordinate system Cm by adding the posture angle correction amount θmb_z_add to the component (the yaw direction component) in the direction around the Zvir axis of the virtual upper body support portion posture angle ↑θ_mb_vir (or the target upper body support posture angle ↑θ_mb_aim) determined by the process of the processing unit 92a.

Thus, the correction target upper body support posture angle ↑θ_mb_mdfd_aim is determined by replacing the yaw direction component of the virtual upper body support portion posture angle ↑θ_mb_vir (or the target upper body support posture angle ↑θ_mb_aim) determined by the process of the processing unit 92a with the correction posture angle θ_mb_z_mdfd.

Additionally, the correction target upper body support angular velocity ↑ω_mb_mdfd_aim which is the target angular velocity of the upper body support portion 65 with respect to the master floor may be determined instead of the correction target upper body support posture angle ↑θ_mb_mdfd_aim or in addition to the correction target upper body support posture angle ↑θ_mb_mdfd_aim. The correction target upper body support angular velocity ↑ω_mb_mdfd_aim can be determined by replacing, for example, the yaw direction component of the virtual upper body support angular velocity ↑ω_mb_vir (or the target upper body support angular velocity ↑ω_mb_aim) determined by the process of the processing unit 92a with the correction angular velocity ω_mb_z_mdfd.

Further, the correction target upper body support portion position ↑P_mb_mdfd_aim is determined by the process shown by the processing unit 92d of FIG. 14. In the process of the processing unit 92d, the master movement control unit 92 first obtains the rotation conversion translational acceleration ↑Acc_mb_a by performing the rotational conversion in which the target upper body support portion translational acceleration ↑Acc_mb_aim (the target upper body support portion translational acceleration ↑Acc_mb_aim viewed in the virtual floor coordinate system Cvir) acquired in STEP 20 is rotated in the yaw direction (the direction around the Zvir axis) by the posture angle correction amount θmb_z_add obtained as described above.

Thus, the rotation conversion translational acceleration ↑Acc_mb_a is the translational acceleration capable of allowing the direction (the direction in the yaw direction) of the rotation conversion translational acceleration ↑Acc_mb_a with respect to the upper body support portion 65 after the correction of the posture angle of the yaw direction by the posture angle correction amount θmb_z_add to match the direction assumed by the target upper body support portion translational acceleration ↑Acc_mb_aim (specifically, the direction (the direction of the yaw direction) of the target upper body support portion translational acceleration ↑Acc_mb_aim with respect to the upper body support portion 65 having the posture angle of the virtual upper body support portion posture angle ↑θ_mb_vir).

Next, the master movement control unit 92 obtains the correction translational acceleration (=↑Acc_mb_a+↑Acc_mb_fb) in which the rotation conversion translational acceleration ↑Acc_mb_a is corrected by the feedback correction amount ↑Acc_mb_fb. Then, the master movement control unit 92 obtains the correction target upper body support portion translational velocity ↑V_mb_mdfd_aim (the target translation velocity subjected to the correction of the upper body support portion 65) which is the translational velocity obtained by integrating the correction translational acceleration and further obtains the correction target upper body support portion position ↑P_mb_mdfd_aim (the target position subjected to the correction of the upper body support portion 65) which is the position obtained by integrating the correction target upper body support portion translational velocity ↑V_mb_mdfd_aim. The correction target upper body support portion translational velocity ↑V_mb_mdfd_aim and the correction target upper body support portion position ↑P_mb_mdfd_aim are respectively the translational velocity and the position viewed in the master side global coordinate system Cm.

In this case, the feedback correction amount ↑Acc_mb_fb is calculated by an arithmetic process of the following formula (42) using the updated values of the correction target upper body support portion translational velocity TV_mb_mdfd_aim and the correction target upper body support portion position ↑P_mb_mdfd_aim and the reference position TPO of the upper body support portion 65 viewed in the master side global coordinate system Cm.

↑Acc_mb_fb=−Kpfb*(↑P_mb_mdfd_aim−↑P0)−Kvfb*↑V_mb_mdfd_aim (42)

Additionally, the coefficients Kpfb and Kvfb of the formula (42) are gains (scalar or diagonal matrix) of predetermined values. The values of the coefficients Kpfb and Kvfb are set so that an absolute value of the feedback correction amount ↑Acc_mb_fb converges to a comparatively small value.

Thus, the feedback correction amount ↑Acc_fb is determined so that the correction target upper body support portion position ↑P_mb_mdfd_aim gradually converges to the reference position ↑P0a. Additionally, the process of obtaining the feedback correction amount ↑Acc_mb_fb by the formula (42) is a process of obtaining ↑Acc_mb_fb by a proportional/differential law, but ↑Acc_mb_fb may be obtained by using other feedback control laws (a proportional law and the like).

The process of STEP 21 is executed as described above.

FIG. 16 shows the master device 51 in which the posture angle θmb_z_mdfd_aim in the yaw direction (the direction around the Zm axis of the master global coordinate system Cm) in the correction target upper body support posture angle ↑θ_mb_mdfd_aim and the position P_mb_x_mdfd_aim in the Xm-axis direction and the position P_mb_y_mdfd_aim in the Ym-axis direction of the master global coordinate system Cm in the correction target upper body support portion position ↑P_mb_mdfd_aim obtained as described above by the process of STEP 21 are indicated by a solid line.

Further, this drawing shows the master device 51 in which the position P_mb_x_vir in the Xm-axis direction and the position P_mb_y_vir in the Ym-axis direction in the virtual upper body support portion position ↑P_mb_vir and the posture angle θ_mb_z_vir in the yaw direction (the direction around the Zm axis) in the virtual upper body support portion posture angle ↑θ_mb_vir defined by the target upper body support portion motion (↑Acc_mb_aim, ↑β_mb_aim) viewed in the master side global coordinate system Cm are indicated by a two-dotted chain line on the assumption that the virtual floor is fixed to the master floor.

Then, P_mb_x_add and P_mb_y_add shown in FIG. 16 respectively show the correction amount in the Xm-axis direction and the correction amount in the Ym-axis direction in the correction amount from the virtual upper body support portion position ↑P_mb_vir to the correction target upper body support portion position ↑P_mb_mdfd_aim viewed in the master side global coordinate system Cm. Further, θmb_z_add shown in FIG. 16 shows the posture angle correction amount θmb_z_add in the yaw direction obtained by the process of the processing unit 92b.

Further, in the example shown in FIG. 16, the position of the origin of the master side global coordinate system Cm is the reference position ↑P0_mb of the representative point (the master reference point Qm) of the upper body support portion 65 and the Xm-axis direction of the master side global coordinate system Cm is the reference direction θ0_mb_z of the upper body support portion 65 in the yaw direction.

In this embodiment, since the correction target upper body support portion motion is determined as described above, as shown in FIG. 16, the virtual floor coordinate system Cvir which is the coordinate system fixed to the virtual floor moves with respect to the master floor (moves with respect to the master side global coordinate system Cm) so that the position and the direction (the posture angle in the yaw direction) of the upper body support portion 65 viewed in the virtual floor coordinate system Cvir are suppressed from deviating from the reference position and the reference direction.

Additionally, the coordinate system Cmb_vir attached to the master device 51 indicated by a two-dotted chain line in FIG. 16 and the coordinate system Cmb_mdfd attached to the master device 51 indicated by a solid line in FIG. 16 correspond to the master upper body coordinate system Cmb which is the coordinate system indicating the position posture of the upper body support portion 65 of each corresponding master device 51.

Returning to the description of FIG. 10, as a next step, in STEP 22, the master movement control unit 92 obtains the actual upper body support portion motion which is an actual motion of the upper body support portion 65 viewed in the master side global coordinate system Cm using the actual master motor rotation angle (the observed value) and the actual master slide displacement (the observed value) acquired in STEP 20. The process of STEP 23 is executed in the same manner as the process of STEP 11 relating to the slave movement control unit 42.

In this case, STEP 23 will be described by respectively replacing the “slave”, the “slave upper body”, the “slave device 1”, the “slave movement control unit 42”, the “base 3”, the “moving grounding portion 4”, the “movement drive mechanism 5”, the “electric motors 5a and 5b”, “FIG. 12A”, and “STEP 10” in the description of the process of STEP 11 with the “master”, the “upper body support portion” (or the “upper body support portion 65”), the “master device 51”, the “master movement control unit 92”, the “base 53”, the “moving grounding portion 54”, the “movement drive mechanism 55”, the “electric motors 55a and 55b”, “FIG. 12B”, and “STEP 20” and replacing “s” of the reference sign with “m”.

In this embodiment, the actual upper body support portion motion (the position ↑P_mb_act, the translational velocity ↑V_mb_act, the posture angle ↑θ_mb_act, and the angular velocity ↑ω_mb_act) is obtained by the process of STEP 22. Additionally, in this embodiment, the calculation of the angular velocity in the direction around the Xm axis and the angular velocity in the direction around the Ym axis of the master side global coordinate system Cm (in other words, the calculation of the angular velocity around the axis in the direction (the lateral direction) orthogonal to the up-down direction) in the angular velocity ↑ω_mb_act of the actual upper body support portion motion is omitted. The same applies to the posture angle ↑θ_mb_act of the actual upper body support portion motion.

Supplementally, the position ↑P_mb_act and the posture angle ↑θ_mb_act in the actual upper body support portion motion may be corrected at any time based on the environmental recognition information such as landmarks around the master device 51 in order to prevent the accumulation of integration error.

Next, in STEP 23, the master movement control unit 92 determines the target translation velocity of each moving grounding portion 54 of the master movement mechanism 52 in response to the correction target upper body support portion motion and controls the electric motors 55a and 55b corresponding to each moving grounding portion 54 to realize the target translation velocity. The process of STEP 23 is executed in the same manner as the process of STEP 12 relating to the slave movement control unit 42.

Specifically, the master movement control unit 92 obtains the target translation velocity V_mb_local_x_aim of the upper body support portion 65 in the Xmb-axis direction of the master upper body coordinate system Cmb and the target translation velocity V_mb_local_y_aim of the upper body support portion 65 in the Ymb-axis direction of the master upper body coordinate system Cmb by rotationally converting vectors including the translational velocity V_mb_x_mdfd_aim in the Xm-axis direction and the translational velocity V_mb_y_mdfd_aim in the Ym-axis direction in the correction target upper body support portion translational velocity ↑V_mb_mdfd_aim obtained in STEP 21 (two-dimensional vectors on the XmYm coordinate plane of the master side global coordinate system Cm) only by the angle (=−θ_mb_z_mdfd_aim) that is (−1) times the component θ_mb_z_mdfd_aim in the direction around the Zm axis (the yaw direction) of the correction target upper body support posture angle ↑θ_mb_mdfd_aim obtained in STEP 21 in the direction around the Zm axis (the yaw direction).

Then, the master movement control unit 92 determines the target translation velocity V_mw_local_x_aim (n) in the Xmb-axis direction and the target translation velocity V_mw_local_y_aim (n) in the Ymb-axis direction of each moving grounding portion 54 (n) (n=1, 2, 3, and 4) viewed in the master upper body coordinate system Cmb by the following formulas (44a) and (44b) to realize the target translation velocities V_mb_local_x_aim and V_mb_local_y_aim in the master upper body coordinate system Cmb and the component ω_mb_z_mdfd_aim in the direction around the Zm axis in the correction target upper body support angular velocity ↑ω_mb_mdfd_aim viewed in the master side global coordinate system Cm.

Additionally, the correction target upper body support angular velocity Cω_mb_mdfd_aim is obtained by differentiating, for example, the correction target upper body support posture angle ↑θ_mb_mdfd_aim obtained in STEP 21. Alternatively, for example, in the process of STEP 21, the correction target upper body support angular velocity ↑ω_mb_mdfd_aim may be obtained by replacing the yaw direction component of the virtual upper body support angular velocity ↑ω_mb_vir (or the target upper body support angular velocity ↑ω_mb_aim) determined by the process of the processing unit 92a with the correction angular velocity ω_mb_z_mdfd obtained by the processing unit 92b.

V_mw_local_x_aim (n)=V_mb_local_x_aim−Lmwy (n)*ω_mb_z_mdfd_aim (44a)

V_mw_local_y_aim (n)=V_mb_local_y_aim+Lmwx (n)*ω_mb_z_mdfd_aim (44b)

Further, the master movement control unit 92 calculates the target motor rotational velocities ωmw_mota_aim (n) and ω_mw_motb_aim (n) which are the target values of the rotational velocities of the electric motors 55a and 55b for realizing the target translation velocities V_mw_local_x_aim (n) and V_mw_local_y_aim (n) for each moving grounding portion 54 (n) by the following formulas (45a) and (45b).

ω_mw_mota_aim (n) =(Cmwy*V_mw_local_x_aim (n)+Cmwx*V_mw_local_y_aim (n))/(2*Cmwx*Cmwy) (45a)

ω_mw_motb_aim (n) =(Cmwy*V_mw_local_x_aim (n)−Cmwx*V_mw_local_y_aim (n))/(2*Cmwx*Cmwy) (45b)

Next, the master movement control unit 92 determines the target motor driving forces Tq_mw_mota_aim (n) and Tq_mw_motb_aim (n) which are the target values of the driving forces (the rotational driving forces) of the electric motors 55a and 55b for allowing the actual motor rotational velocities ω_mw_mota_act (n) and ω_mw_motb_act (n) of the electric motors 55a and 55b to follow the target motor rotational velocities ωmw_mota_aim (n) and ω_mw_motb_aim (n) for each moving grounding portion 54 (n) by the following formulas (46a) and (46b). These target motor driving forces Tq_mw_mota_aim (n) and Tq_mw_motb_aim (n) (n=1, 2, 3, and 4) are the target master movement driving forces shown in FIG. 5.

Tq_mw_mota_aim (n) =Kv_mw_mota*(ω_mw_mota_aim (n)−ω_mw_mota_act (n)) (46a)

Tq_sw_motb_aim (n) =Kv_mw_motb*(ω_mw_motb_aim (n)−ω_mw_motb_act (n)) (46b)

Additionally, Kv_mw_mota and Kv_mw_motb are gains of predetermined values. Supplementally, the formulas (46a) and (46b) are formulas for determining Tq_mw_mota_aim (n) and Tq_mw_motb_aim (n) by a proportional law as an example of a feedback control law, but Tq_mw_mota_aim (n) and Tq_mw_motb_aim (n) may be determined by other feedback control laws (for example, a proportional/differential law and the like).

Next, the master movement control unit 92 operates the electric motors 55a and 55b corresponding to each moving grounding portion 54 (n) to output the target motor driving forces Tq_mw_mota_aim (n) and Tq_mw_motb_aim (n) determined as described above. Accordingly, the movement of the master movement mechanism 52 is controlled to realize the translational velocity V_mb_x_mdfd_aim in the X-axis direction and the translational velocity V_mb_y_mdfd_aim in the Y-axis direction in the correction target upper body support portion translational velocity ↑V_mb_mdfd_aim.

In this embodiment, the target motor driving forces Tq_mw_mota_aim (n) and Tq_mw_motb_aim (n) of the electric motors 55a and 55b corresponding to each moving grounding portion 54 (n) which are the target master movement driving forces of the master movement mechanism 52 are determined to realize a motion other than the translational velocity in the Zm-axis direction (the up-down direction) in the correction target upper body support portion translational velocity ↑V_mb_mdfd_aim by the above-described process of STEP 23. Then, the electric motors 55a and 55b corresponding to each moving grounding portion 54 (n) are controlled to generate the target motor driving forces Tq_mw_mota_aim (n) and Tq_mw_motb_aim (n). Accordingly, the movement of the master movement mechanism 52 is controlled to realize a motion other than the translational velocity in the Zm-axis direction (the up-down direction) in the correction target upper body support portion translational velocity ↑V_mb_mdfd_aim.

Next, in STEP 24, the master movement control unit 92 controls the master slide actuator 66 to realize the translational velocity V_mb_z_mdfd_aim in the Zm-axis direction (the up-down direction) in the correction target upper body support portion translational velocity ↑V_mb_mdfd_aim.

Specifically, similarly to the process of STEP 13 for the slave movement control unit 42, the master movement control unit 92 determines the target driving force of the slide actuator 66 so that the deviation between the component V_mb_z_mdfd_aim in the Zm-axis direction of the correction target upper body support portion translational velocity ↑V_mb_mdfd_aim and the translational velocity Vmb_z_act in the Zm-axis direction of the translational velocity ↑V_mb_act of the actual upper body support portion motion obtained in STEP 23 approaches zero in response to the deviation. Then, the master movement control unit 92 controls the slide actuator 66 to generate a target driving force.

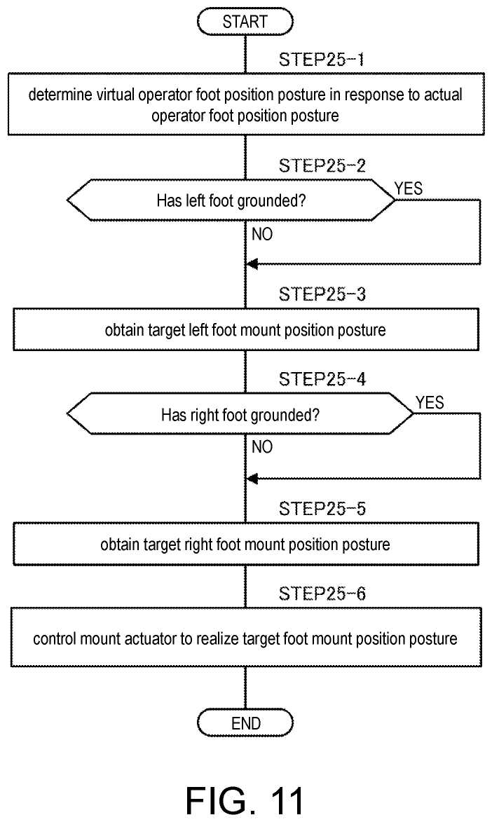

Next, in STEP 25, the master movement control unit 92 executes a process of the foot mount control which is the operation control of each foot mount 70. This control process is executed as shown in the flowchart of FIG. 11.

In STEP 25-1, the master movement control unit 92 obtains the virtual operator foot position posture which is a set of the position and the posture angle of each foot of the operator P with respect to the virtual floor in response to the actual operator foot position posture of each of the left and right feet of the operator P acquired in STEP 20. In this case, the virtual operator foot position posture is obtained by converting the coordinates of the actual operator foot position posture (the position posture viewed in the master upper body coordinate system Cmb) of each of the left and right feet of the operator P acquired in STEP 20 into the position posture viewed in the virtual floor coordinate system Cvir using the virtual upper body support portion position ↑P_mb_vir and the virtual upper body support portion posture angle ↑θ_mb_vir obtained in STEP 21.

Hereinafter, the position and the posture angle in the virtual operator foot position posture for the left foot of the operator P are respectively referred to as the virtual operator left foot position ↑P_mp_L_vir and the virtual operator left foot posture angle ↑θ_mp_L_vir and the position and the posture angle in the virtual operator foot position posture for the right foot of the operator P are respectively referred to as the virtual operator right foot position ↑P_mp_R_vir and the virtual operator right foot posture angle ↑θ_mp_R_vir. Further, a set of the virtual upper body support portion position ↑P_mb_vir and the virtual upper body support portion posture angle ↑θ_mb_vir is referred to as the virtual upper body support portion position posture.

Next, in STEP 25-2, the master movement control unit 92 determines whether or not the left foot of the operator P is grounded to the left foot mount 70L (in other words, whether or not the left foot is the foot on the support leg side). This determination is based on whether or not the magnitude of the translational force in the up-down direction (the Zmb-axis direction) in the actual operator foot grounding reaction force (the observed value) acquired in STEP 20 exceeds a predetermined value in response to the left foot.

When the determination result of STEP 25-2 is negative (the left foot of the operator P is the foot on the free leg side), the master movement control unit 92 obtains the target left foot mount position posture which is a set of the target position and the target posture angle(the target position and the target posture angle viewed in the virtual floor coordinate system Cvir) of the left foot mount 95L in STEP 25-3. Hereinafter, the target position and the target posture angle in the target left foot mount position posture are respectively referred to as the target left foot mount position ↑P_mp_L_aim and the target left foot mount posture angle βθ_mp_L_aim.

The lateral position (the position P_mp_L_x_aim in the Xvir-axis direction and the position P_mp_L_y_aim in the Yvir-axis direction) in the target left foot mount position ↑P_mp_L_aim is set to match the lateral position (the position P_mp_L_x_vir in the Xvir-axis direction and the position P_mp_L_y_vir in the Yvir-axis direction) in the virtual operator left foot position ↑P_mp_L_vir. Further, the posture angle θ_mp_L_z_aim in the direction around the Zvir axis (the yaw direction) in the target left foot mount posture angle βθ_mp_L_aim is set to match the posture angle θ_mp_L_z vir in the direction around the Zvir axis of the virtual operator left foot posture angle ↑θ_mp_L_vir.

Further, the position in the up-down direction (the position P_mp_L_z_aim in the Zvir-axis direction) in the target left foot mount position ↑P_mp_L_aim and the posture angle in the direction around the axis in the lateral direction (the posture angle θ_mp_L_x_vir in the direction around the Xvir axis and the posture angle θ_mp_L_y_vir in the direction around the Yvir axis) in the target left foot mount posture angle βθ_mp_L_aim are determined in response to, for example, the actual slave floor shape (the actual slave floor tilt angle) acquired in STEP 20.

Specifically, for example, the tilt angle of the virtual floor surface is set in response to the actual slave floor tilt angle. In this case, the tilt angle of the virtual floor is set so that the tilt angle in the roll direction (the direction around the Xmb axis) of the virtual floor surface viewed in the master upper body coordinate system Cmb and the tilt angle in the pitch direction (the direction around the Ymb axis) respectively match the tilt angle in the roll direction (the direction around the Xsb axis) in the actual slave floor tilt angle viewed in the slave upper body coordinate system Csb and the tilt angle in the pitch direction (the direction around the Ysb axis).

Then, the position P_mp_L_z_aim in the up-down direction (the Zvir-axis direction) of the target left foot mount position ↑P_mp_L_aim and the posture angle θ_mp_L_x_vir in the direction around the Xvir axis and the posture angle θ_mp_L_y_vir in the direction around the Yvir axis in the target left foot mount posture angle βθ_mp_L_aim are set so that the upper surface (the surface for grounding the left foot of the operator P) of the left foot mount 70L moves along the virtual floor surface having the tilt angle set as described above from a position immediately before the time when the determination result of STEP 25-2 changes from positive to negative.

In this case, P_mp_L_z_aim, θ_mp_L_x_vir, and θ_mp_L_y_vir are calculated by using the target left foot mount position posture immediately before a time point at which the determination result of STEP 25-2 changes from positive to negative, the tilt angle of the virtual floor surface, the position P_mp_L_x_aim in the Xvir-axis direction and the position P_mp_L_y_aim in the Yvir-axis direction in the target left foot mount position ↑P_mp_L_aim determined as described above in STEP 25-3, and the posture angle θ_mp_L_z_aim in the direction around the Zvir axis (the yaw direction) of the target left foot mount posture angle βθ_mp_L_aim determined as described above in STEP 25-3.

Further, when the determination result of STEP 25-2 is positive, the master movement control unit 92 does not execute a process of STEP 25-3 and maintains the target left foot mount position posture at a value immediately before a time point at which the determination result of STEP 25-2 changes from negative to positive.

Next, in STEP 25-4, the master movement control unit 92 determines whether or not the right foot of the operator P is grounded to the right foot mount 70R (in other words, whether or not the right foot is the foot on the support leg side). This determination is based on whether or not the magnitude of the translational force in the up-down direction (the Zmb-axis direction) in the actual foot grounding reaction force (the observed value) acquired in STEP 20 corresponding to the right foot exceeds a predetermined value.

When the determination result of STEP 25-4 is negative (the right foot of the operator P is the foot on the free leg side), the master movement control unit 92 obtains the target right foot mount position posture which is a set of the target position and the target posture angle (the target position and the target posture angle viewed in the virtual floor coordinate system Cvir) of the right foot mount 95L in STEP 25-5. Hereinafter, the target position and the target posture angle in the target right foot mount position posture are respectively referred to as the target right foot mount position ↑P_mp_R_aim and the target right foot mount posture angle ↑θ_mp_R_aim.

The target right foot mount position ↑P_mp_R_aim and the target right foot mount posture angle ↑θ_mp_R_aim are determined by the same process as the process of STEP 25-3 for the left foot mount 70L.

Further, when the determination result of STEP 25-4 is positive, the master movement control unit 92 does not execute a process of STEP 25-5 and maintains the target right foot mount position posture at a value immediately before a time point at which the determination result of STEP 25-4 changes from negative to positive.

Next, in STEP 25-6, the master movement control unit 92 controls each mount actuator 75 of the mount drive mechanisms 71L and 71R so that a relationship (a positional relationship and a posture relationship) between the actual position posture for the left and right feet mounts 70L and 70R and the actual position posture of the upper body support portion 65 matches a relationship between the target foot mount position posture (the target left foot mount position posture and the target right foot mount position posture) and the virtual upper body support portion position posture (or the target upper body support portion position posture).

Specifically, the master movement control unit 92 calculates the target left foot mount local position posture and the target right foot mount local position posture which are the target values of the position posture (the position and the posture angle) of each of the foot mounts 70L and 70R viewed in the master upper body coordinate system Cmb from the virtual upper body support portion position posture (↑P_mb_vir, ↑θ_mb_vir) obtained in STEP 21 and the target left foot mount position posture and the target right foot mount position posture. In other words, the target left foot mount local position posture and the target right foot mount local position posture are the target values of the relative position posture of each of the foot mounts 70L and 70R for the upper body support portion 65.

In this case, the target left foot mount local position posture is obtained by converting the coordinate of the target left foot mount position posture viewed in the virtual floor coordinate system Cvir into the position posture viewed from the master upper body coordinate system Cmb defined by the virtual upper body support portion position posture (↑P_mb_vir, ↑θ_mb_vir). Further, the target right foot mount local position posture is obtained by converting the coordinate of the target right foot mount position posture viewed in the virtual floor coordinate system Cvir into the position posture viewed from the master upper body coordinate system Cmb defined by the virtual upper body support portion position posture (↑P_mb_vir, ↑θ_mb_vir).

Next, the master movement control unit 92 determines the target displacement (the target displacement capable of realizing the target left foot mount local position posture) of the output unit of each mount actuator 75 (each mount actuator 75 rotationally driving the left foot mount 70L in the direction around each coordinate axis and each mount actuator 75 driving the left foot mount 70L in a translational manner in each coordinate-axis direction of the master upper body coordinate system Cmb) of the left mount drive mechanism 71L from the target left foot mount local position posture.

Similarly, the master movement control unit 92 determines the target displacement (the target displacement capable of realizing the target right foot mount local position posture) of the output unit of each mount actuator 75 (each mount actuator 75 rotationally driving the right foot mount 70R in the direction around each coordinate axis and each mount actuator 75 driving the right foot mount 70R in a translational manner in each coordinate-axis direction of the master upper body coordinate system Cmb) of the right mount drive mechanism 71R from the target right foot mount local position posture.

Next, the master movement control unit 92 determines the target driving force of the mount actuator 75 so that the deviation between the actual mount actuator displacement (the observed value) acquired in STEP 20 corresponding to the mount actuator 75 and the target displacement of the output unit of each mount actuator 75 of each of the left and right mount drive mechanisms 71 approaches zero by a feedback control law (a proportional law, a proportional/differential law, or the like) in response to the deviation. Then, the master movement control unit 92 controls each mount actuator 75 to output the target driving force determined by each mount actuator 75 of each of the left and right mount drive mechanisms 71.

The master movement control unit 92 executes a process (foot mount control process) of STEP 25 as described above and executes a process of STEP 26. In STEP 26, the master movement control unit 92 controls the tilt angle of the master base 53 in response to the translational acceleration (hereinafter, referred to as the upper body support portion acceleration correction amount ↑Acc_mb_fb) added to suppress the feedback correction amount ↑Acc_mb_fb (the position of the upper body support portion 65 (the position of the master reference point Qm)) obtained by the process of the processing unit 92d in STEP 21 from deviating from the reference position. The upper body support portion acceleration correction amount ↑Acc_mb_fb corresponds to the additional translational acceleration of the disclosure.

In this case, the tilt angle of the master base 53 is controlled so that the translational acceleration in the direction of canceling the translational acceleration correction amount ↑Acc_mb_fb by the component in the slope direction of gravity generated due to the inclination of the master base 53 is applied to the upper body support portion 65.

Specifically, the master movement control unit 92 converts the coordinate of the upper body support portion acceleration correction amount ↑Acc_mb_fb viewed in the master side global coordinate system Cm into the local acceleration correction amount ↑Acc_mb_fb_local which is the translational acceleration viewed in the master upper body coordinate system Cmb defined by the correction target upper body support portion position ↑P_mb_mdfd_aim and the correction target upper body support posture angle ↑θ_mb_mdfd_aim.

Then, the master movement control unit 92 obtains the target local base tilt angle θ_base_y_local which is the tilt angle of the master base 53 in the direction around the Ymb axis (the pitch direction) in the master upper body coordinate system Cmb and the target local base tilt angle θ_base_x_local which is the target tilt angle of the master base 53 in the direction around the Xmb axis (the roll direction) of the master upper body coordinate system Cmb by the following formulas (50a) and (50b) using the component Acc_mb_fb_x_local in the Xmb-axis direction and the component Acc_mb_fb_y_local in the Ymb-axis direction in the local acceleration correction amount ↑Acc_mb_fb_local.

θ_base_x_local=−atan(Acc_mb_fb_y_local/g) (50a)

θ_base_y_local=atan(Acc_mb_fb_x_local/g) (50b)

Additionally, atan( ) is an inverse tangent function and g is a gravitational acceleration constant.

Next, the master movement control unit 92 obtains the target displacement of the output unit of each base tilting actuator 58 for realizing the target local base tilt angles θ_base_x_local and θ_base_y_local. Further, the master movement control unit 92 determines the target driving force of the base tilting actuator 58 so that the deviation between the target displacement of the output unit of each base tilting actuator 58 and the actual base tilting actuator displacement (the observed value) acquired in STEP 20 approaches zero by a feedback control law (a proportional law and a proportional/differential law) in response to the deviation. Then, the master movement control unit 92 controls each base tilting actuator 58 to output the target driving force determined by each base tilting actuator 58.

The master movement control unit 92 executes a process of STEP 26 as described above and further executes a process of STEP 27. In STEP 27, the master movement control unit 92 outputs the actual upper body support portion reaction force acquired in STEP 20 and the virtual upper body support portion motion determined in STEP 21 to the main manipulation control unit 94. The process of the master movement control unit 92 is executed as described above.

Supplementally, since the actual upper body support portion reaction force output to the main manipulation control unit 94 in STEP 27 is the actual upper body support portion reaction force viewed in the master upper body coordinate system Cmb, the main manipulation control unit 94 converts the actual upper body support portion reaction force input from the master movement control unit 92 into the actual upper body support portion reaction force viewed in the virtual floor coordinate system Cvir using the virtual upper body support portion position posture (↑P_mb_vir, ↑θ_mb_vir) input from the master movement control unit 92 together with the actual upper body support portion reaction force. Then, the above-described process is executed by using the converted actual upper body support portion reaction force.

However, the actual upper body support portion reaction force viewed in the master upper body coordinate system Cmb may be converted into the actual upper body support portion reaction force viewed in the virtual floor coordinate system Cvir by the master movement control unit 92. In this case, the converting process in the main manipulation control unit 94 is not necessary.

Additionally, in this embodiment, a process in which the main manipulation control unit 94 determines the target upper body support portion motion in STEP 3 corresponds to the A1 process of the disclosure and all of this process and the control process of the master movement control unit 92 include processes corresponding to the A process, the C process, the D process, and the E process of the disclosure. Further, the control process of the slave movement control unit 42 corresponds to the B process of the disclosure.

(Operation and Effect)

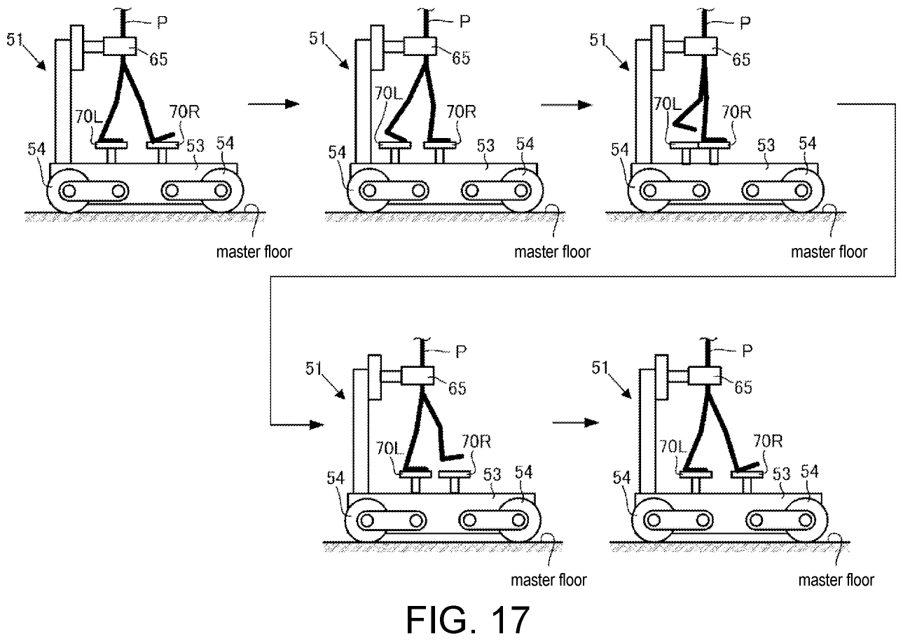

According to the manipulation system of this embodiment described above, the operation of the master device 51 is controlled so that the operator P can perform the same walking operation as the normal walking operation on the master device 51. For example, as shown in FIG. 17, when the operator P performs the walking operation on the master device 51, the operation of the master device 51 is controlled to perform a relative motion of the upper body support portion 65 and each of the foot mounts 70L and 70R in accordance with the walking operation. Additionally, FIG. 17 schematically shows an operation of the master device 51 in a state in which the upper body support portion acceleration correction amount ↑Acc_mb_fb is sufficiently small. Further, the master device 51 is shown in FIG. 17 in a simplified manner.

As shown in FIG. 17, when the operator P moves the left and right legs to perform the walking operation on the master device 51, the upper body support portion 65 relatively moves with respect to the foot mount 70R for grounding the right foot in accordance with the motion of the upper body of the operator P with respect to the right foot and the left foot mount 90L relatively moves with respect to the foot mount 70R on the support leg side to be located directly below the foot on the free leg side (the left foot) in a case in which the support leg of the operator P is a right leg. The same applies to a case in which the support leg of the operator P is the left leg.

Accordingly, the operator P can perform the walking operation on the virtual floor surface as if walking on the actual floor while smoothly grounding the foot on the free leg side to the corresponding foot mount 70.

Then, in this case, the upper body support portion acceleration correction amount (the feedback correction amount) ↑Acc_mb_fb is added to the translational acceleration of the upper body support portion 65 so that the position of the master reference point Qm which is the position of the upper body support portion 65 gradually converges to a predetermined reference position ↑P0 of the master side global coordinate system Cvir. For this reason, as shown in FIG. 16, the lateral position of the upper body support portion 65 (or the lateral position of the master base 53) is suppressed from deviating from the reference position (the lateral reference position) and the master device 51 can be moved to stay in the movable range AR_lim even when the operator P continuously performs the walking operation.

Further, since the operation of the master device 51 is also controlled so that the up-down direction position of the upper body support portion 65 does not deviate from the up-down direction reference position, the operator P can perform the walking operation as if going up and down a staircase or a slope so that the up-down direction position of the upper body support portion 65 does not greatly change from the up-down direction reference position even when a difference between the up-down direction positions of the foot mounts 70L and 70R in the target foot mounts is set so that the virtual floor becomes a staircase or a slope in response to the slave floor shape.

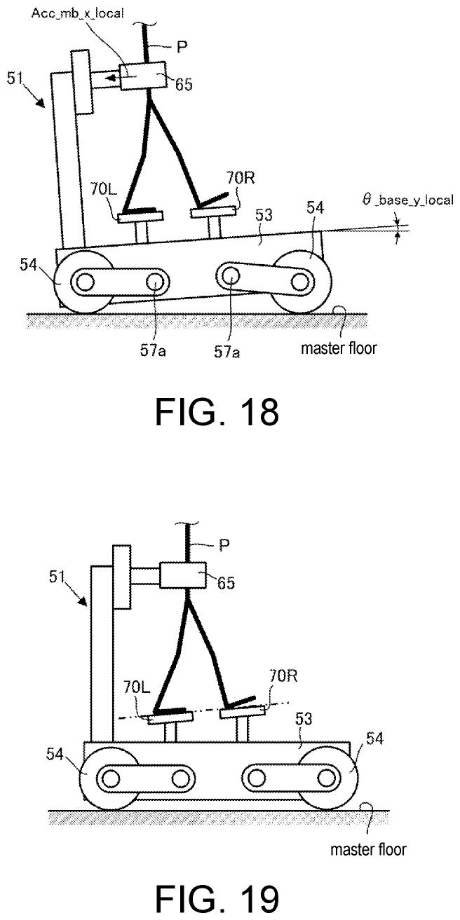

Further, as shown in FIG. 18, since all of the master base 53, the upper body support portion 65, and the foot mounts 70L and 70R are tilted in response to the upper body support portion acceleration correction amount (the feedback correction amount) ↑Acc_mb_fb, the component in the slope direction of the gravitational acceleration applied to the operator P (the slope direction of the master base 53) is applied to operate the translational acceleration by the upper body support portion acceleration correction amount ↑Acc_mb_fb. Further, the operator P can perform the walking operation as if the upper body support portion acceleration correction amount ↑Acc_mb_fb is not added.

Further, as shown in FIG. 19, since the foot mounts 70L and 70R are tilted in response to the inclination of the slave floor below the slave device 1, the operator P can perform the walking operation in a suitable manner while sensibly recognizing the inclination of the slave floor surface on which the slave device 1 moves.

As described above, the operator P can perform the walking operation on the master device 51 in the same manner as on the actual floor with the virtual floor having a shape conforming to the floor shape of the slave floor. Further, the slave device 1 can be easily moved in a desired manner on the slave floor.

Further, in this embodiment, since the target upper body support portion motion and the target slave upper body motion are determined by the process of the upper body side bilateral control, the upper body of the operator P receives a reaction force corresponding to an external force from the upper body support portion 65, for example, when the external force caused by, for example, a contact with the obstacle acts on the slave upper body. Further, the operator P can sensibly and easily recognize that an external force that hinders the movement of the slave device 1 has acted on the slave upper body. Further, the operator P can appropriately execute a corresponding measure such as stopping the movement of the slave device 1.

### Second Embodiment

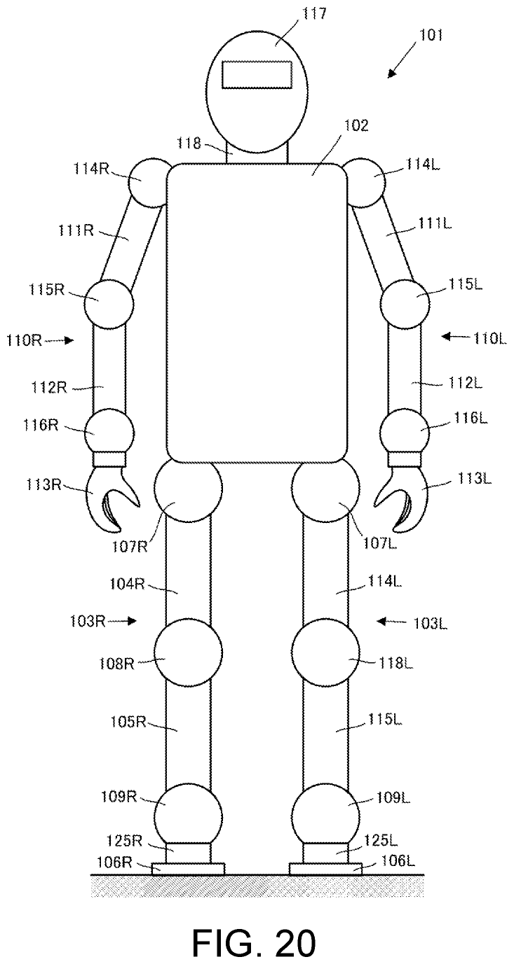

Next, a second embodiment of the disclosure will be described below with reference to FIGS. 20 to 25. In this embodiment, as an example of the disclosure, a manipulation system which manipulates a moving body 101 shown in FIG. 20 by the manipulation device 51 having the same structure as that of the first embodiment will be described. In the description below, similarly to the first embodiment, the moving body 101 of the manipulation object is referred to as the slave device 101 and the manipulation device 51 for manipulating the slave device 101 is referred to as the master device 51.

Additionally, in this embodiment, the slave side global coordinate system Cs, the master side global coordinate system Cm, the virtual floor coordinate system Cvir, and the master upper body coordinate system Cmb are coordinate systems set in the same manner as in the first embodiment.

[Configuration of Slave Device]

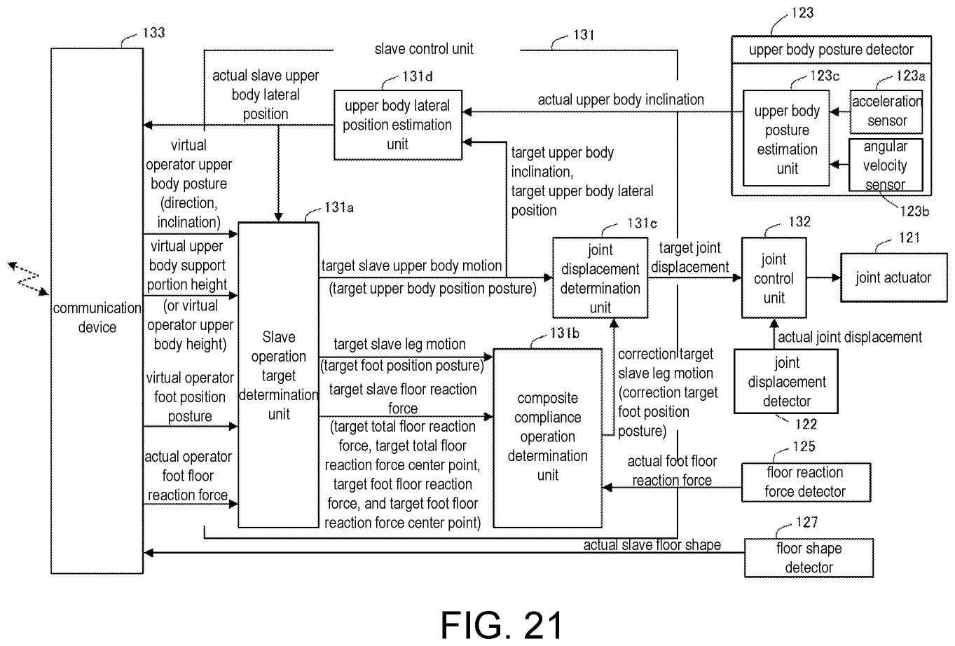

The configuration of the slave device 101 of this embodiment will be described with reference to FIGS. 20 and 21. Additionally, similarly to the first embodiment, the floor of the operation environment of the slave device 101 is referred to as the “slave floor”. Further, in order to distinguish the left and right components of the slave device 101, “L” and “R” are respectively added to the reference sign of the left component and the reference sign of the right component if necessary.

Referring to FIG. 20, the slave device 101 of this embodiment is, for example, a human-shaped leg type moving body and includes an upper body 102 which is a base, a pair of left and right (two) legs 103L and 103R which extends from the lower portion of the upper body 102, a pair of left and right (two) arms 110L and 11OR which extends from the upper portion of the upper body 102, and a head portion 117 which is attached to the upper end of the upper body 102. Additionally, in FIG. 17, a direction perpendicular to the paper surface is the front-rear direction of the slave device 101.

Each leg 103 includes a thigh portion 104, a lower leg portion 105, and a foot 106 as links of components and the thigh portion 104, the lower leg portion 105, and the foot 106 are sequentially connected to each other from the side of the upper body 102 via a hip joint mechanism 107, a knee joint mechanism 108, and an ankle joint mechanism 109. Each of the joint mechanisms 107, 108, and 109 of each leg 103 is a joint mechanism having a known structure and includes one or more joints (not shown).

For example, as the joint, a joint having a known structure with a degree of freedom of rotation of one axis (a joint including two members connected so as to be rotatable relative to each other around one rotation shaft) can be used. Then, the hip joint mechanism 107, the knee joint mechanism 108, and the ankle joint mechanism 109 of each leg 3 respectively include, for example, three joints, one joint, and two joints. Accordingly, each leg 103 is configured such that the foot 106 as its tip portion has six degrees of freedom of motion with respect to the upper body 102.

Each arm 110 includes an upper arm portion 111, a forearm portion 112, and a hand portion 113 as links of components and the upper arm portion 111, the forearm portion 112, and the hand portion 113 are sequentially connected to each other from the side of the upper body 102 via a shoulder joint mechanism 114, an elbow joint mechanism 115, and a wrist joint mechanism 116. Each of the joint mechanisms 114, 115, and 116 of each arm 110 includes one or more joints (not shown).

For example, the shoulder joint mechanism 114, the elbow joint mechanism 115, and the wrist joint mechanism 116 of each arm 110 are configured as joints having a degree of freedom of rotation of one axis similarly to each leg 103 and respectively include three joints, one joint, and two joints. Accordingly, each arm 110 is configured such that the hand portion 113 as its tip portion has six degrees of freedom of motion with respect to the upper body 102.

Further, the hand portion 113 of each arm 110 can be configured to perform necessary tasks such as gripping an object. For example, each hand portion 113 can be configured as a clamp mechanism, a plurality of finger mechanisms capable of performing the same operation as a human finger, a tool, or the like.

The head portion 117 is attached to the upper end portion of the upper body 102 via the neck joint mechanism 118. The neck joint mechanism 118 may include one or more joints to have, for example, a degree of freedom of rotation of one axis, two axes, or three axes. Alternatively, the head portion 117 may be fixed to the upper end portion of the upper body 102.

The slave device 101 which is configured as described above can move (walk) on the slave floor surface by moving each leg 103 so that the foot 106 of each leg 103 is alternately moved in the air and landed (grounded) on the floor surface in the same manner as, for example, a human walking operation.

Supplementally, each of the leg 103 and the arm 110 of the slave device 101 is not limited to six degrees of freedom of motion and may be configured to have, for example, seven or more degrees of freedom of motion. Further, each of the leg 103 and the arm 110 is not limited to a rotation type joint and may include a linear motion type joint. Further, the slave device 101 is not limited to the moving body having two arms 110L and 11OR and may be a moving body having one or three or more arms or a moving body without an arm. Further, the slave device 101 may be a moving body without the head portion 117. Further, the upper body 102 of the slave device 101 may be configured to include, for example, one or more joints between the upper and lower portions so that the upper and lower portions can be relatively displaced.

Referring to FIG. 21, the slave device 101 further includes a joint actuator 121 for driving each joint. Further, the slave device 101 includes a joint displacement detector 122 which detects an actual joint displacement corresponding to an actual displacement of each joint, an upper body posture detector 123 which detects an actual upper body posture corresponding to an actual posture of the upper body 102, a floor reaction force detector 125 which detects an actual foot floor reaction force corresponding to a floor reaction force applied from the grounded slave floor surface to each foot 106, and a floor shape detector 127 which detects an actual slave floor shape corresponding to an actual floor shape of the slave floor to which the slave device 101 is grounded via each foot 106 as detectors for detecting the operation state of the slave device 101.

Each of the joint actuator 121 and the joint displacement detector 122 is provided for each joint of the slave device 101 and the floor reaction force detector 125 is provided for each leg 103. However, only one of each of the joint actuator 121, the joint displacement detector 122, and the floor reaction force detector 125 is representatively shown in FIG. 2.

Each joint actuator 121 is configured as, for example, an electric motor and is connected to the joint to drive a joint of a driving object via an appropriate power transmission mechanism such as a speed reducer (not shown). Additionally, each joint actuator 121 is not limited to the electric motor and may be configured as, for example, a hydraulic actuator. Further, each joint actuator 121 is not limited to the rotation type actuator and may be a linear actuator.

Each joint displacement detector 122 is configured as, for example, a rotary encoder, a resolver, a potentiometer, or the like and is connected to the joint (or the rotation member rotating in accordance with the displacement of the joint) of the detection object so as to detect the actual joint displacement of the joint.

The upper body posture detector 123 includes, for example, an inertia sensor having an acceleration sensor 123a capable of detecting a three-axis acceleration (three-dimensional translational acceleration vector) and an angular velocity sensor 123b capable of detecting a three-axis angular velocity (three-dimensional angular velocity vector) and is mounted on the upper body 102 to detect the acceleration and the angular velocity generated in the upper body 102.

In this embodiment, the upper body posture detector 123 includes a posture estimation unit 123c which executes a process of estimating an actual upper body inclination corresponding to the inclination (the posture angle in the direction around the axis in the lateral direction) in the actual upper body posture from the acceleration and the angular velocity respectively detected from the acceleration sensor 123a and the angular velocity sensor 123b. The posture estimation unit 123c is configured as, for example, a microcomputer or an electronic circuit unit including a processor, a memory, an interface circuit, and the like.

Then, the posture estimation unit 123c estimates the actual upper body inclination from the observed values of the acceleration and the angular velocity by, for example, a known arithmetic process method such as a strap-down method and outputs the estimated value (the observed value). Additionally, the actual upper body inclination which is estimated by the posture estimation unit 123c is more specifically a set of the inclinations of the upper body 102 in the directions around two orthogonal lateral axes (for example, X and Y axes of a slave side global coordinate system Cgs to be described below).

Supplementally, the posture estimation unit 123c may be mounted on the slave device 1 at a position separated from the mounting positions of the acceleration sensor 123a and the angular velocity sensor 123b. Further, the posture estimation unit 123c may be included in a slave control unit 131 to be described later. Further, the posture estimation unit 123c can be configured to estimate not only the inclination of the upper body 102 of the slave device 101 but also the posture including the direction of the upper body 102.

Further, the upper body posture detector 123 may be configured to estimate the inclination of the upper body 102 (or the posture of the upper body 102 including a direction) by performing a known motion capture process, for example, using a video captured by the slave device 101 by a camera. In addition, as a method of estimating the inclination (or the posture including a direction) of the upper body 102, various known methods capable of estimating the own position and the posture of an arbitrary object can be employed.

Each floor reaction force detector 125 is configured as, for example, a six-axis force sensor capable of detecting the translational force and the moment (the moment of the force) as a three-dimensional vector and is attached to the slave device 101 to detect the actual foot floor reaction force (the translational force and the moment) applied to the foot 106 of each leg 103. For example, as shown in FIG. 1, each floor reaction force detector 125 is interposed between the foot 106 of each leg 103 and the ankle joint mechanism 109.

In this embodiment, for example, the floor shape detector 127 is configured to sequentially recognize the shape of the slave floor in the periphery of the slave device 101 using a camera or a distance measurement sensor (laser range finder or the like) and to estimate the actual slave floor shape below each foot 106 (specifically, the tilt angle and the height of the slave floor below each foot 106) of the slave device 101 based on the recognized floor shape.

Additionally, for example, when the floor shape detector 127 can acquire the shape information of each part of the slave floor from an external server or the like, the floor shape detector 127 may be configured to estimate the floor shape of the slave floor below each foot 106 from the position information of each foot 106 of the slave device 1 and the shape information of the slave floor.

The slave device 101 further includes a slave control unit 131 which has a function of executing an operation target determination process of the entire operation of the slave device 101, a joint control unit 132 which has a function of controlling the operation of each joint via the joint actuator 121, and a communication device 133 which performs a wireless communication with a master control unit 141 to be described later. These are mounted at arbitrary positions on the slave device 101 such as the upper body 102.

Each of the slave control unit 131 and the joint control unit 132 is configured as, for example, an electronic circuit unit including a microcomputer, a memory, an interface circuit, and the like. Observation data detected or estimated by each of the upper body posture detector 123 and each floor reaction force detector 125 is input to the slave control unit 131 and command information on the operation of the slave device 101 is input from the master control unit 141 to be described later thereto via the communication device 133. Additionally, the observation data or command information input to the slave control unit 131 may be filtering values subjected to a filtering process such as a low-pass filter.

Then, the slave control unit 131 includes a slave operation target determination unit 131a which determines a basic operation target of the slave device 101 based on the command information or the like input from the master control unit 141, a composite compliance operation determination unit 131b which appropriately corrects the operation target for the motion of each leg 103 in the basic operation target by using a process of compliance control, a joint displacement determination unit 131c which determines a target joint displacement corresponding to a target value of the displacement (the rotation angle) of each joint in response to the operation target of the slave device 101, and an upper body lateral position estimation unit 131d which estimates an actual slave upper body lateral position corresponding to the actual lateral position of the upper body 102 of the slave device 101 as a function realized by both or one of the implemented hardware configuration and program (software configuration).

In this embodiment, the basic operation target which is determined by the slave operation target determination unit 131a includes a target slave upper body motion which is a target motion of the upper body 102, a target slave leg motion which is a target motion of each leg 103, and a target slave floor reaction force which is a target value of a floor reaction force applied from the slave floor surface to the slave device 101.

In this case, the target slave upper body motion is specifically represented by the time series of the target upper body position posture which is a target value of a set of the position and the posture of the upper body 102 and the target slave leg motion is specifically represented by the time series of the target foot position posture which is a target value of a set of the position and the posture of the foot 106 of each leg 103.

Here, unless otherwise specified, the target position and the target posture of each of the upper body 102 of the slave device 101 and each foot 106 are represented as the target values of the position and the posture viewed in the slave side global coordinate system Cs (the three-axis Cartesian coordinate system including three coordinate axes Xs, Ys, and Zs) set (defined) in the operation environment of the slave device 101 similarly to the case of the first embodiment.

Further, in this embodiment, the target slave floor reaction force in the basic operation target which is determined by the slave operation target determination unit 131a is represented by each of the time series of the target total floor reaction force which is the target value of the total floor reaction force applied from the floor surface to the slave device 101, the target total floor reaction force center point which is the target position of the pressure center point (COP) of the target total floor reaction force, the target foot floor reaction force which is the target value of the floor reaction force applied from the floor surface to each foot 106 of the slave device 101, and the target foot floor reaction force center point which is the target position of the pressure center point (COP) of the target foot floor reaction force in each foot 106. Additionally, the “total floor reaction force” is a resultant force of the floor reaction forces respectively applied to two feet 106 and 106 of the slave device 101. Further, when the slave device 101 does not receive an external force other than the floor, the target total floor reaction force center point is the target position of a zero moment point (ZMP).

Additionally, although not shown in FIG. 21, since the slave device 101 of this embodiment includes the arm 110 and the head portion 117 which are movable with respect to the upper body 102, the slave operation target determination unit 131a also further has a function of determining the target slave arm motion which is the target motion of each arm 110 and the target slave head motion which is the target motion of the head portion 117.

In this case, the target slave arm motion is represented by, for example, the time series of the relative target position posture of the hand portion 113 of each arm 110 with respect to the upper body 102 (the target position posture viewed in the local coordinate system set for the upper body 102). Similarly, the target slave head motion is represented by, for example, the time series of the relative target position posture of the head portion 117 with respect to the upper body 102 (the target position posture viewed in the local coordinate system set for the upper body 102).

Alternatively, the target slave arm motion may be formed by, for example, the time series of the target joint displacement of each joint of each arm 110 and similarly, the target slave head motion may be formed by, for example, the time series of the target joint displacement of each joint of the neck joint mechanism 118.

The actual joint displacement (the observed value) of each joint detected by each joint displacement detector 122 is input to the joint control unit 132 and the target joint displacement of each joint determined by the slave control unit 131 is input thereto. Then, the joint control unit 132 controls each joint actuator 121 so that the actual joint displacement for each joint follows the target joint displacement by the function realized by the implemented hardware configuration and program (software configuration).

Specifically, the joint control unit 132 determines the target driving force of the joint actuator 121 so that the deviation between the target joint displacement and the actual joint displacement detected by the joint displacement detector 122 converges to zero by a feedback control law using the deviation for each joint. Then, the joint control unit 132 controls the joint actuator 121 to output the determined target driving force from the joint actuator 121. In this case, as feedback control laws, for example, known feedback control laws such as a P law (proportional law), a PD law (proportional/differential law), and a PID law (proportional/integral/differential law) can be used.

[Configuration of Master Device]

Next, a configuration of the master device 51 will be described with reference to FIGS. 3 and 4 and FIGS. 22 and 23 described in the first embodiment. The mechanical configuration of the master device 51 of this embodiment is the same as that of the first embodiment. For this reason, since the same reference signs as those of the first embodiment is used for the mechanical configuration of the master device 51 of this embodiment, the description thereof will be omitted.

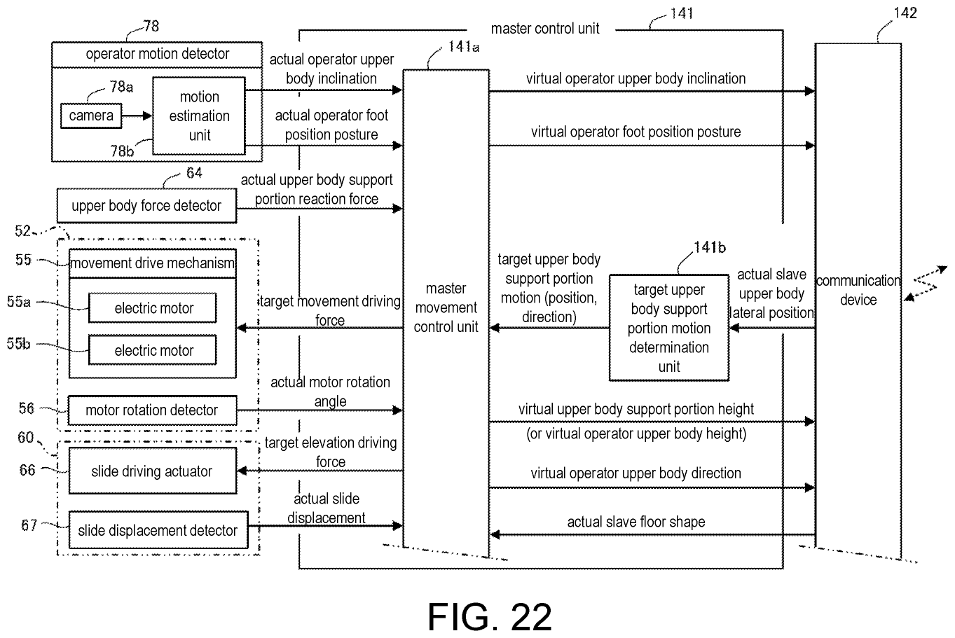

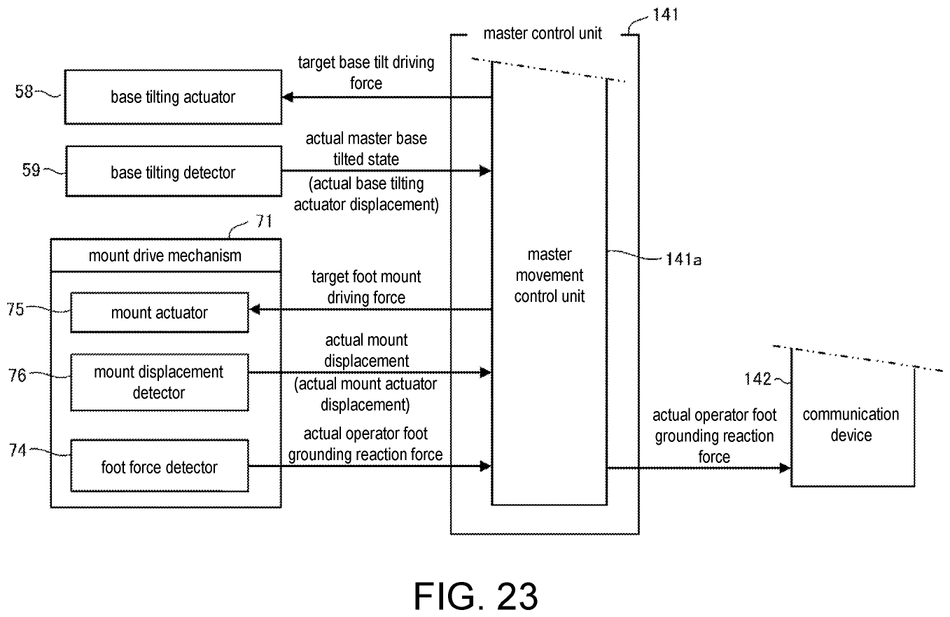

On the other hand the master device 51 of this embodiment is different from the master device 51 of the first embodiment in some configurations relating to the control and the detector. Specifically, referring to FIGS. 22 and 23, similarly to the first embodiment, the master device 51 of this embodiment includes the upper body force detector 64 which detects an actual upper body support portion reaction force, the motor rotation detector 56 which detects the actual motor rotation angle of each of the electric motors 55a and 55b of the movement drive mechanism 55, the slide displacement detector 67 which detects an actual slide displacement for the master elevating mechanism 60, the base tilting detector 59 which detects an actual master base tilted state (an actual base tilting actuator displacement) for the master base 53, the mount displacement detector 76 which detects an actual mount displacement (an actual mount actuator displacement) for the mount drive mechanism 71, and the foot force detector 74 which detects an actual operator foot grounding reaction force for each foot of the operator P. These detectors are the same as those of the first embodiment.

On the other hand in this embodiment, the master device 51 includes an operator motion detector 78 (shown in FIG. 22) which detects an actual motion of the operator P including an actual operator foot position posture corresponding to the actual position posture of each foot of the operator P and an actual operator upper body inclination corresponding to the actual inclination (the posture angle in the direction around the axis in the lateral direction) of the upper body of the operator P.

In this embodiment, this operator motion detector 78 includes one or more cameras 78a mounted on the master device 51. The camera 78a is attached to the support column 61 or the base 53 of the master device 51 to photograph the movement of the upper body of the operator P on the master device 51 and the movement of each leg thereof. Additionally, a marker may be attached to the upper body or each leg of the operator P.

The operator motion detector 78 further includes a motion estimation unit 78b which executes a process of estimating the motion state of the operator P from the video captured by the camera 78a. The motion estimation unit 78b is configured as, for example, a microcomputer or an electronic circuit unit including a processor, a memory, an interface circuit, and the like and is mounted at an arbitrary appropriate position of the master device 51 such as a base 53. Additionally, the motion estimation unit 78b may be included in the master control unit 141 to be described later.

This motion estimation unit 78b estimates the motion state of the operator P from the captured video input from the camera 78a, for example, by executing a known motion capture process and outputs data indicating the estimated motion state. In this case, in this embodiment, the motion state which is estimated by the motion estimation unit 78b includes an actual operator foot position posture of each foot of the operator P and an actual operator upper body inclination in an actual operator upper body posture which is an actual posture of the upper body of the operator P.

In this case, the motion estimation unit 78b can estimate the actual operator upper body inclination and the actual operator foot position posture viewed in the local coordinate system set for the master device 51, for example, the master upper body coordinate system Cmb set (defined) similarly to the case of the first embodiment. Additionally, the motion estimation unit 78b can be configured to estimate the actual direction (the actual operator upper body direction) of the upper body of the operator P in addition to the actual operator upper body inclination.

Supplementally, a method of estimating the motion state of the upper body and each foot of the operator P by the operator motion detector 78 may be a method other than the motion capture method using a video captured by the camera 78a. For example, an inertia sensor including an acceleration sensor and an angular velocity sensor can be attached to each of the upper body and each foot of the operator P and the motion state of the upper body and each foot of the operator P can be estimated by a known method such as a strap-down method from the acceleration and the angular velocity detected by the inertia sensor. In addition, various known methods capable of estimating the own position and posture of the object can be used as a method of estimating the motion state of the upper body and each foot of the operator P.

Further, for example, a joint displacement sensor capable of detecting the displacement of each of joints (the hip joint, the knee joint, and the ankle joint) of each leg of the operator P may be attached to each leg and the relative position posture of each foot with respect to the upper body of the operator P may be estimated by using a rigid link model of each leg from the displacement detected value of the joint of each leg. Then, the actual operator foot position posture may be estimated from the observed value of the relative position posture of each foot of the operator and the observed value of the actual position posture (the actual operator upper body position posture) of the upper body of the operator P estimated by an appropriate method such as a motion capture method.

Further, the operator motion detector 78 can be configured to estimate the actual operator upper body inclination and the actual operator foot position posture viewed in the master side global coordinate system Cm set in the operation environment of the master device 51 similarly to the case of the first embodiment.

The master device 51 further includes the master control unit 141 which has a function of executing the operation control of the master device 51 or a function of outputting (transmitting) the command information related to the operation of the slave device 1 to the slave control unit 131 and a communication device 142 which performs a radio communication with the slave control unit 131. These are mounted at arbitrary appropriate positions on the master device 51 such as the base 53.

The master control unit 141 is configured as, for example, an electronic circuit unit including a microcomputer, a memory, an interface circuit, and the like. The observation data which is detected or estimated by each of the upper body force detector 64, each motor rotation detector 56, the slide displacement detector 67, the operator motion detector 78, the base tilting detector 59, the mount displacement detector 76, and the foot force detector 74 is input to the master control unit 141 and the observed value of the actual slave floor shape and the observed value of the actual slave upper body lateral position are input from the slave control unit 131 thereto via the communication device 142. Additionally, each observation data input to the master control unit 141 may be filtering values subjected to a filtering process such as a low-pass filter.

Then, the master control unit 141 includes a master movement control unit 141a which controls the motion of the base 3, the upper body support portion 65, and each foot mount 70 via the electric motors 55a and 55b of each movement drive mechanism 55, the slide actuator 66, the mount actuator 75, and the base tilting actuator 58 and a target upper body support portion motion determination unit 141b which determines the target upper body support portion motion corresponding to the target motion of the upper body support portion 65 as a function realized by both or one of the implemented hardware configuration and program (software configuration).

Here, in this embodiment, the target upper body support portion motion which is determined by the target upper body support portion motion determination unit 141b includes the target upper body support portion position which is the target position of the upper body support portion 65 and the target upper body support portion direction which is the target direction of the upper body support portion 65. The target upper body support portion position and the target upper body support portion direction are the target motion with respect to the virtual floor (viewed in the virtual floor coordinate system Cvir) described in the first embodiment.

Further, the master control unit 141 has a function of transmitting the observed values of the virtual operator upper body posture (direction and inclination) which is the posture of the upper body of the operator P with respect to the virtual floor, the virtual upper body support portion height which is the height (the up-down direction position) of the upper body support portion 65 with respect to the virtual floor (or the virtual operator upper body height which is the height (the up-down direction position)) of the upper body of the operator P with respect to the virtual floor, the virtual operator foot position posture which is the position posture of each foot of the operator P with respect to the virtual floor, and the actual operator foot grounding reaction force of each foot of the operator P to the slave control unit 131 via the communication device 142 as the command information for the operation of the slave device 1.

Supplementally, in this embodiment, both the master control unit 141 and the slave control unit 131 correspond to the control device of the disclosure. Further, the target upper body support portion motion determination unit 141b, the slave operation target determination unit 131a, and the composite compliance operation determination unit 131b correspond to the operation target determination unit of the disclosure, the joint control unit 132 corresponds to the slave side control unit of the disclosure, and the master movement control unit 141a corresponds to the master side control unit of the disclosure.

[Control Process and Operation]

Next, the specific control processes of the slave control unit 131 and the master control unit 141 and the operations of the slave device 101 and the master device 51 will be described.

[Control Process of Master Control Unit]

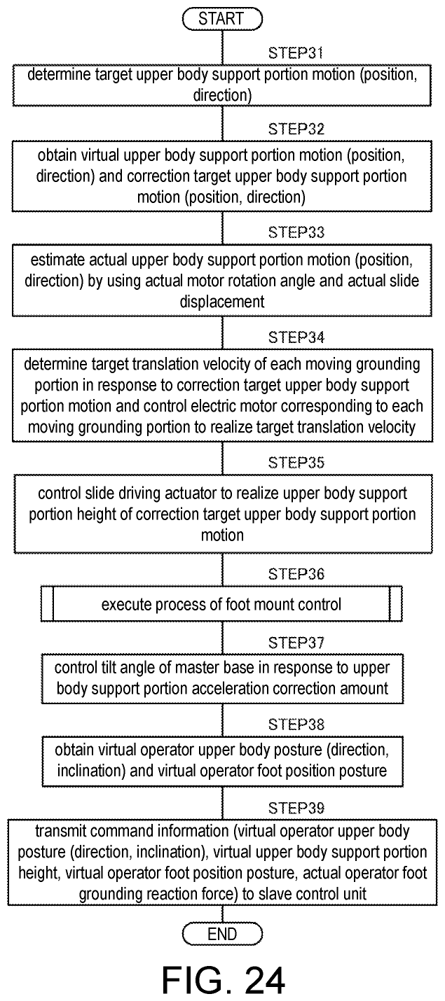

First, a control process of the master control unit 141 will be described. The master control unit 141 sequentially executes a control process shown in the flowchart of FIG. 24 in a predetermined control process cycle. In STEP 31, the master control unit 141 determines the target upper body support portion motion (the target upper body support portion position and the target upper body support portion direction) by the target upper body support portion motion determination unit 141b.

In this case, the target upper body support portion motion determination unit 141b acquires (receives) the observed value of the actual slave upper body lateral position viewed in the slave side global coordinate system Cs from the slave control unit 131 of the slave device 101 via the communication device 142. Then, the target upper body support portion motion determination unit 141b determines the target upper body support portion lateral position which is the lateral position in the target upper body support portion position in response to the observed value of the actual slave upper body lateral position acquired from the slave control unit 131 so that the actual slave upper body lateral position and the virtual upper body support portion lateral position as the lateral position of the upper body support portion 65 according to the virtual motion of the upper body support portion 65 in the virtual floor coordinate system Cvir satisfy a predetermined relationship represented by the following formulas (61a) and (61b) (so that the predetermined relationship becomes a target corresponding relationship).

P_mb_x_vir=Kpmb*P_sb_x_act+Cpmb_x (61a)

P_mb_y_vir=Kpmb*P_sb_y_act+Cpmb_y (61b)

Here, Kpmb, Cpmb_x, and Cpmb_y of the formulas (61a) and (61b) are constants of predetermined values. Additionally, Cpmb_x and Cpmb_y may be respectively zero.

Further, P_mb_x_act and P_mb_y_act are respectively the Xvir-axis direction position and the Yvir-axis direction position in the virtual upper body support portion lateral position viewed in the virtual floor coordinate system Cvir and P_sb_x_act and P_sby_act are respectively the Xs-axis direction position and the Ys-axis direction position in the actual slave upper body lateral position viewed in the slave side global coordinate system Cgs.

Thus, the target upper body support portion motion determination unit 141b determines the target upper body support portion lateral position (P_mb_x_aim, P_mb_y_aim) by the following formulas (62a) and (62b) from the observed value of the current actual slave upper body lateral position (P_sb_x_act, P_sb_y_act) acquired from the slave control unit 131.

P_mb_x_aim=Kpmb*P_sb_x_act+Cpmb_x (62a)

P_mb_y_aim=Kpmb*P_sb_y_act+Cpmb_y (62b)

Here, P_mb_x_aim and P_mb_y_aim are respectively the Xvir-axis direction position and the Yvir-axis direction position in the target upper body support portion lateral position viewed in the virtual floor coordinate system Cvir.

Additionally, in this embodiment, for convenience of description, it is assumed that the Xvir-axis direction (or the Yvir-axis direction) of the virtual floor coordinate system Cvir and the Xs-axis direction (or the Ys-axis direction) of the slave side global coordinate system Cs are initially set so that the direction in the yaw direction of the Xvir-axis direction (or the Yvir-axis direction) of the virtual floor coordinate system Cvir with respect to the front-rear direction of the master device 51 and the direction in the yaw direction of the Xs-axis direction (or the Ys-axis direction) of the slave side global coordinate system Cs with respect to the front-rear direction of the slave device 101 are the same direction at the time of starting the manipulation of the movement of the slave device 101 by the master device 51. For example, it is set so that the Xvir-axis direction of the virtual floor coordinate system Cvir matches the front-rear direction of the master device 51 and the X-axis direction of the slave side global coordinate system Cs matches the front-rear direction of the slave device 101.

However, the direction in the yaw direction of the Xvir-axis direction (or the Yvir-axis direction) of the virtual floor coordinate system Cvir with respect to the front-rear direction of the master device 51 and the direction in the yaw direction of the Xs-axis direction (or the Ys-axis direction) of the slave side global coordinate system Cs with respect to the front-rear direction of the slave device 101 may be different from each other at the time of starting the manipulation of the movement of the slave device 101 by the master device 51. In this case, the coordinate of the observed value of the actual slave upper body lateral position viewed in the slave side global coordinate system Cgs may be converted into the lateral position viewed in the virtual floor coordinate system Cvir based on these directions.

Supplementally, the lateral position obtained by the calculation on the right sides of the above formulas (62a) and (62b) may be determined as the target operator upper body lateral position which is the target lateral position (the target lateral position viewed in the virtual floor coordinate system Cvir) of the upper body of the operator P and the target upper body support portion lateral position may be determined in response to the target lateral position.

In this case, a process of determining the target upper body support portion lateral position by the above formulas (62a) and (62b) can be, in other words, a process of determining the target operator upper body lateral position by the calculation on the right sides of the formulas (62a) and (62b) and directly determining the target operator upper body lateral position as the target upper body support portion lateral position.

On the other hand an elastic member such as a pad is interposed between the upper body support portion 65 and the upper body of the operator P is elastically deformed by a force acting between the upper body support portion 65 and the upper body of the operator P and the lateral position of the upper body support portion 65 and the lateral position of the upper body of the operator P are relatively displaced by the elastic deformation.

Here, in consideration of this, the target upper body support portion lateral position may be determined by correcting the target operator upper body lateral position determined by the calculation on the right sides of the above formulas (62a) and (62b) in response to the translational force in the lateral direction (the translational force in the Xvir-axis direction and the Yvir-axis direction) in the actual upper body support portion reaction force detected by the upper body force detector 64.

Specifically, for example, the target upper body support portion lateral position (P_mb_x_aim, P_mb_y_aim) may be determined by the following formulas (62a-1) and (62b-1).

P_mb_x_aim =P_opb_x_aim+kspring_fx*F_mb_x_act =(Kpmb*P_sb_x_act+Cpmb_x)+kspring_fx*F_mb_x_act (62a-1)

P_mb_y_aim =P_opb_y_aim+kspring_fy*F_mb_y_act =(Kpmb*P_sb_y_act+Cpmb_y)+kspring fy*F_mb_y_act (62b-1)

Here, P_opb_x_aim and P_opb_y_aim are respectively the Xvir-axis direction position and the Yvir-axis direction position in the target lateral position of the upper body of the operator P, F_mb_x_act and F_mb_y_act are respectively the translational force in the Xvir-axis direction and the translational force in the Yvir-axis direction in the actual upper body support portion reaction force detected by the upper body force detector 64, kspring fx is a value set in advance as the reciprocal of the spring constant (rigidity) related to the translational force in the Xvir-axis direction generated between the upper body of the operator P and the upper body support portion 65, and kspring_fy is a value set in advance as the reciprocal of the spring constant (rigidity) related to the translational force in the Yvir-axis direction generated between the upper body of the operator P and the upper body support portion 65.

Further, in this embodiment, the target upper body support portion motion determination unit 141b acquires the observed value of the actual upper body support portion up-down direction reaction force F_mb_z_act which is the translational force in the up-down direction (the Zvir-axis direction) in the actual upper body support portion reaction force detected by the upper body force detector 64 and the observed value of the actual upper body support portion yaw direction moment M_mb_z_act which is the moment in the yaw direction (the direction around the Zvir axis) in the actual upper body support portion reaction force.

Then, the target upper body support portion motion determination unit 141b determines the target upper body support portion height P_mb_z_aim which is the position (the height from the floor surface) in the up-down direction in the target upper body support portion position using the observed value of the actual upper body support portion up-down direction reaction force F_mb_z_act and determines the target upper body support portion direction θ_mb_z_aim using the observed value of the actual upper body support portion yaw direction moment M_mb_z_act.

More specifically, in the process of determining the target upper body support portion height P_mb_z_aim, the target upper body support portion motion determination unit 141b determines the target upper body support portion height P_mb_z_aim so that the actual upper body support portion up-down direction reaction force F_mb_z_act satisfies the relationship of the following formula (63) (so that F_mb_z_act converges to Cz).

F_mb_z_act−Cz=0 (63)

Here, Cz is a target value (a predetermined value) of an upward translational force applied from the upper body support portion 65 to the operator P to reduce the load of the leg of the operator P. The target value Cz can be set to, for example, a predetermined ratio of gravity applied to the operator P. However, the target value Cz may be zero.

Specifically, the target upper body support portion motion determination unit 141b determines the target translation velocity V_mb_z_aim in the up-down direction of the upper body support portion 65 so that the deviation between the observed value of the actual upper body support portion up-down direction reaction force F_mb_z_act and the target value thereof (=Cz) (a value on the left side of the formula (3)) converges to zero by a feedback control law (for example, a P law, a PD law, a PID law, or the like) in response to the deviation.

Then, the target upper body support portion motion determination unit 141b determines the target upper body support portion height P_mb_z_aim by integrating the determined target translation velocity V_mb_z_aim. Accordingly, the target upper body support portion height P_mb_z_aim is determined so that the actual upper body support portion up-down direction reaction force F_mb_z_act converges to the target value (=Cz).

Further, in the process of determining the target upper body support portion direction θ_mb_z_act, the target upper body support portion motion determination unit 141b determines the target upper body support portion direction θ_mb_z_act so that the actual upper body support portion yaw direction moment M_mb_z_act converges to zero.

In this case, the target upper body support portion motion determination unit 81b determines the target angular velocity ω_mb_z_aim in the yaw direction of the upper body support portion 65 in response to the observed value of the actual upper body support portion yaw direction moment M_mb_z_act so that the actual upper body support portion yaw direction moment M_mb_z_act converges to zero by a feedback control law (for example, a P law, a PD law, a PID law, or the like).

Then, the target upper body support portion motion determination unit 141b determines the target upper body support portion direction θ_mb_z_aim by integrating the determined target angular velocity ω_mb_z_aim. Accordingly, the target upper body support portion direction θ_mb_z_aim is determined so that the actual upper body support portion yaw direction moment M_mb_z_act converges to zero.

In STEP 31, the target upper body support portion position ↑P_mb_aim (P_mb_x_aim, P_mb_y_aim, P_mb_z_aim) and the target upper body support portion direction θ_mb_z_aim are determined as the target upper body support portion motion viewed in the virtual floor coordinate system Cvir as described above.

Supplementally, a method of determining the target upper body support portion direction θ_mb_z_aim in the target upper body support portion motion is not limited to the above-described method. For example, an actual operator upper body direction which is an actual direction of the upper body of the operator P (a direction viewed in the master side global coordinate system Cgm or the master upper body coordinate system Cmb) is estimated by a motion capture process using a camera photographing the operator P or an inertia sensor attached to the upper body of the operator P and a result obtained by convering the coordinate of the estimated value of the actual operator upper body direction into the direction viewed in the virtual floor coordinate system Cvir may be determined as the target upper body support portion direction θ_mb_z_aim. Additionally, in this case, the actual operator upper body direction may be estimated by the operator motion detector 78.

Further, a method of determining the target upper body support portion height P_mb_z_aim is not limited to the above-described method. For example, the target upper body support portion height P_mb_z_aim may be determined based on the translational force in the up-down direction in the grounding reaction force detected for each foot of the operator P by the foot force detector 74 of the master device 51.

Specifically, the target upper body support portion motion determination unit 141b obtains the observed value of the resultant force (hereinafter, referred to as the operator total floor reaction force) of the grounding reaction force of each foot of the operator P based on the grounding reaction force detected by the foot force detector 74.

Next, the target upper body support portion motion determination unit 141b determines the target upper body support portion height P_mb_z_aim so that the up-down direction translational force F_opf_total_z_act of the actual operator total floor reaction force satisfies the relationship of the following formula (63-1) (so that F_opf_total_z_act converges to Ctotalfz).

F_opf_total_z_act−Ctotalfz=0 (63-1)

Here, Ctotalfz is a target value (a predetermined value) of the up-down direction translational force component of the total floor reaction force applied from the floor to the leg of the operator P. The target value Ctotalfz can be set to, for example, a predetermined ratio of gravity applied to the operator P.

Specifically, the target upper body support portion motion determination unit 141b determines the target translation velocity V_mb_z_aim in the up-down direction of the upper body support portion 65 so that the deviation between the observed value of the up-down direction translational force F_opf_total_z_act of the actual operator total floor reaction force and the target value thereof (=Ctotalfz) (a value on the left side of the formula (3-1)) converges to zero by a feedback control law (for example, a P law, a PD law, a PID law, or the like) in response to the deviation.

Then, the target upper body support portion motion determination unit 141b determines the target upper body support portion height P_mb_z_aim by integrating the determined target translation velocity V_mb_z_aim. Accordingly, the target upper body support portion height P_mb_z_aim is determined so that the up-down direction translational force F_opf_total_z_act of the actual operator total floor reaction force converges to the target value thereof (=Ctotalfz).

Next, the master control unit 141 executes processes of STEP 32 to STEP 38 by the master movement control unit 141a. In STEP 32, the master movement control unit 141a determines the virtual upper body support portion motion and the correction target upper body support portion motion. Here, similarly to the case of the first embodiment, the virtual upper body support portion motion means the motion of the upper body support portion 65 virtually realized with respect to the virtual floor on the assumption that the motion of the upper body support portion 65 on the virtual floor follows the target upper body support portion motion determined by the target upper body support portion motion determination unit 141b.

Further, similarly to the case of the first embodiment, the correction target upper body support portion motion means the target motion for correcting the target upper body support portion motion so that the position (the position of the master reference point Qm) of the master device 51 viewed in the master side global coordinate system Cm is suppressed from deviating from a predetermined reference position and the direction (the posture angle in the yaw direction) of the upper body support portion 65 is suppressed from deviating from a predetermined reference direction.

In this embodiment, the virtual upper body support portion motion obtained in STEP 32 includes the virtual upper body support portion position ↑P_mb_vir which is the position of the upper body support portion 65 and the virtual upper body support portion direction θ_mb_z_vir which is the direction (the posture angle in the yaw direction) of the upper body support portion 65. In this case, the virtual upper body support portion direction θ_mb_z_vir is determined to match the target upper body support portion direction θ_mb_z_aim. Additionally, in STEP 32, the virtual upper body support angular velocity ω_mb_z_vir which is the angular velocity in the yaw direction obtained by first-order differentiation of the target upper body support portion direction may be obtained as the component of the virtual upper body support portion motion.

Alternatively, in STEP 32, the virtual upper body support angular velocity ω_mb_z_vir and the virtual upper body support portion direction θ_mb_z_vir may be obtained by executing the same process as that of the processing unit 92a of FIG. 13 described in the first embodiment from the angular acceleration (the target upper body support portion angular acceleration β_mb_z_aim) obtained by second-order differentiation of the target upper body support portion direction θ_mb_z_aim.

Further, the virtual upper body support portion position ↑P_mb_vir in the virtual upper body support portion motion is determined to match the target upper body support portion position ↑P_mb_vir. Additionally, in STEP 32, the virtual upper body support portion translational velocity ↑V_mb_vir which is the translational velocity obtained by first-order differentiation of the target upper body support portion position ↑P_mb_aim may be obtained as the component of the virtual upper body support portion motion.

Alternatively, in STEP 32, the virtual upper body support portion translational velocity ↑V_mb_vir and the virtual upper body support portion position ↑Pmb_vir may be obtained by executing the same process as that of the processing unit 92c of FIG. 14 described in the first embodiment from the translational acceleration (the target upper body support portion translational acceleration ↑Acc_mb_aim) obtained by second-order differentiation of the target upper body support portion position ↑P_mb_aim.

Further, in this embodiment, the correction target upper body support portion motion obtained in STEP 32 includes the correction target upper body support portion position ↑P_mb_mdfd_aim which is the target position of the upper body support portion 65 and the correction target upper body support portion direction θ_mb_z_mdfd_aim which is the target direction (the target posture angle in the yaw direction) of the upper body support portion 65.

In this case, in the process of obtaining the correction target upper body support portion direction θ_mb_z_mdfd_aim, for example, the correction target upper body support portion direction θ_mb_z_mdfd_aim (=θ_mb_z_mdfd shown in FIG. 13) is obtained by executing the process of the processing unit 92b of FIG. 13 described in the first embodiment (specifically, the process of obtaining the correction posture angle θ_mb_z_mdfd) using the target upper body support portion angular acceleration β_mb_z_aim which is the angular acceleration in the yaw direction obtained by second-order differentiation of the target upper body support portion direction θ_mb_z_aim. Additionally, in this case, the correction target upper body support angular velocity ω_mb_z_mdfd_aim (=ω_mb_z_mdfd shown in FIG. 13) in the yaw direction is also obtained.

Further, in the process of obtaining the correction target upper body support portion position ↑P_mb_mdfd_aim in the correction target upper body support portion motion, for example, the correction target upper body support portion position ↑P_mb mdfd_aim is obtained by executing the process of the processing unit 92d of FIG. 14 described in the first embodiment using the target upper body support portion translational acceleration ↑Acc_mb_aim which is the translational acceleration obtained by second-order differentiation of the target upper body support portion position ↑P_mb_aim. Additionally, in this case, the correction target upper body support portion translational velocity ↑V_mb mdfd_aim is also obtained.

Next, the master movement control unit 141a executes processes of STEP 33 to STEP 37. The processes of STEP 33 to STEP 37 are executed in the same manner as those of STEP 22 to STEP 26 of the first embodiment.

Next, in STEP 38, the master movement control unit 141a obtains the virtual operator upper body inclination which is the posture angle (direction and inclination) of the upper body of the operator P in the motion of the operator P on the virtual floor and the virtual operator foot position posture which is the position posture (position and posture angle) of each of the left and right feet of the operator P.

In this case, in the process of obtaining the virtual operator upper body inclination in the virtual operator upper body posture angle, the master movement control unit 141a acquires the actual operator upper body inclination (the inclination viewed in the master upper body coordinate system Cmb) detected by the operator motion detector 78. Then, the master movement control unit 141a obtains the virtual operator upper body inclination by converting the coordinate of the acquired actual operator upper body inclination into the inclination viewed in the virtual floor coordinate system Cvir using the virtual upper body support portion direction obtained in STEP 32 (or the target upper body support portion direction obtained in STEP 31) and the virtual upper body support portion position obtained in STEP 32 (or the target upper body support portion position obtained in STEP 31).

Further, in the process of obtaining the virtual operator upper body direction in the virtual operator upper body posture angle, the master movement control unit 141a obtains the virtual operator upper body direction θ_opb_z_vir by the following formula (65), for example, from the virtual upper body support portion direction θ_mb_z_vir obtained in STEP 32 and the moment M_mb_z_act (the actual upper body support portion yaw direction moment) in the yaw direction in the actual upper body support portion reaction force detected by the upper body force detector 64.

θ_opb_z_vir=θ_mb_z_vir−kspring_mz*M_mb_z_act (65)

Here, kspring_mz is a value set in advance as the reciprocal of the spring constant (rigidity) related to the rotating force in the yaw direction generated between the upper body of the operator P and the upper body support portion 65. Supplementally, a method of estimating the virtual operator upper body direction is not limited to the above-described method and other methods may be used. For example, the virtual operator upper body direction may be obtained by estimating the actual operator upper body direction by a motion capture process using an inertia sensor attached to the upper body of the operator P or the like or a camera photographing the operator P and converting the coordinate of the actual operator upper body direction into the direction viewed in the virtual floor coordinate system Cvir. Additionally, the actual operator upper body direction may be estimated by the operator motion detector 78.

Alternatively, for example, the virtual operator upper body direction can be also obtained by detecting the relative displacement (the relative rotation angle) in the yaw direction of the upper body of the operator P with respect to the upper body support portion 65 using an appropriate displacement sensor provided in the upper body support portion 65 or the like and adding the observed value of the relative displacement to the virtual upper body support portion direction θ_mb_z_vir.

Alternatively, for example, the virtual operator upper body direction can be also obtained by using a distance measurement device capable of measuring a distance to a plurality of positions of the upper body of the operator P, estimating the actual operator upper body direction based on the observed value of the distance obtained by the distance measurement device, and converting the coordinate of the actual operator upper body direction into the direction viewed in the virtual floor coordinate system Cvir.

Further, in the process of obtaining the virtual operator foot position posture, the master movement control unit 141a acquires the actual operator foot position posture (the position posture viewed in the master upper body coordinate system Cmb) detected by the operator motion detector 78 and obtains the virtual operator foot position posture by converting the coordinate of the actual operator foot position posture into the position posture viewed in the virtual floor coordinate system Cvir using the virtual upper body support portion direction obtained in STEP 32 (or the target upper body support portion direction obtained in STEP 31) and the virtual upper body support portion position obtained in STEP 32 (or the target upper body support portion position obtained in STEP 31).

The master control unit 141 executes a process of the master movement control unit 141a as described above and then transmits command information related to the operation of the slave device 101 to the slave control unit 31 in next STEP 39. Specifically, the master control unit 141 transmits the virtual operator upper body posture (direction and inclination) and the virtual operator foot position posture obtained in STEP 38, the virtual upper body support portion height in the virtual upper body support portion motion obtained in STEP 32, and the actual operator foot grounding reaction force detected by the foot force detector 74 for each of the left and right feet of the operator P to the slave control unit 131 as the components of the command information.

In this case, each of the virtual operator upper body posture, the virtual operator foot position posture, and the virtual upper body support portion height in each command information output from the master control unit 141 to the slave control unit 131 is a state quantity viewed in the virtual floor coordinate system Cvir.

Regarding the actual operator foot grounding reaction force, the master control unit 141 converts the coordinate of the observed value of the grounding reaction force viewed in the sensor coordinate system set for each foot force detector 74 into the actual operator foot grounding reaction force viewed in the virtual floor coordinate system Cvir using the actual mount displacement detected by the mount displacement 76, the virtual upper body support portion direction obtained in STEP 32 (or the target upper body support portion direction obtained in STEP 31), and the virtual upper body support portion position obtained in STEP 32 (or the target upper body support portion position obtained in STEP 31) and outputs the actual operator foot grounding reaction force to the slave control unit 131.

Additionally, each command information output (transmitted) from the master control unit 141 to the slave control unit 131 may be filtering values subjected to a filtering process such as a low-pass filter.

In this embodiment, the control process of the master control unit 141 is executed as described above.

[Control Process of Slave Control Unit]

Next, a control process of the slave control unit 131 will be described. The slave control unit 131 sequentially executes a process of each of the above-described function units in a predetermined control process cycle. Additionally, in the description below, the actual value or the target value of the state quantity related to the slave device 1 are referred to as “actual” or “target” and “slave” may be appropriately added between the names of the state quantity.

[Process of Slave Operation Target Determination Unit]

First, a process of the slave operation target determination unit 131a of the slave control unit 131 will be described. As shown in FIG. 21, the observed values of the virtual operator upper body posture (direction and inclination), the virtual upper body support portion height (or the virtual operator upper body height), the virtual operator foot position posture, and the actual operator foot floor reaction force received from the master control unit 141 via the communication device 133 are sequentially input to the slave operation target determination unit 131a and the observed values of the actual slave upper body lateral position estimated as described below by the upper body lateral position estimation unit 131d are sequentially input thereto.

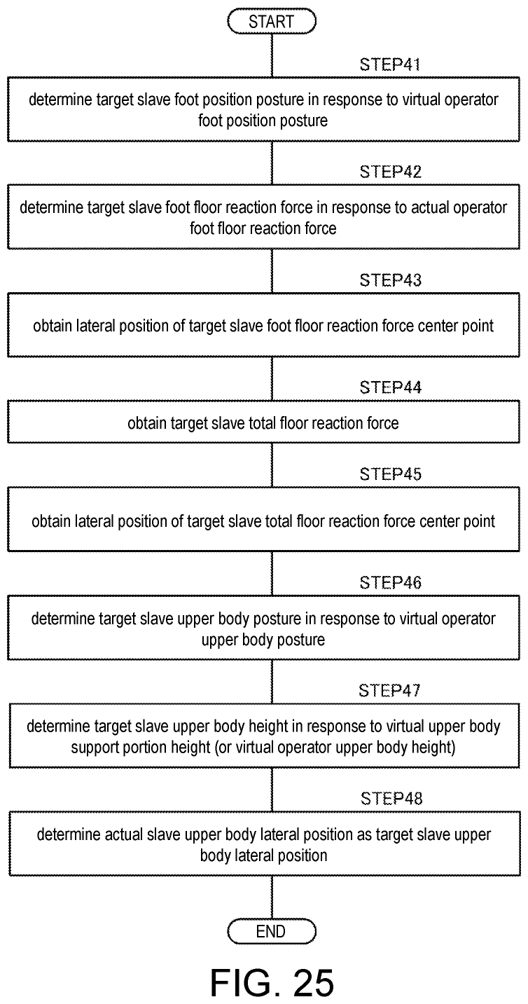

Then, the slave operation target determination unit 131a executes a process shown in the flowchart of FIG. 25 in a predetermined control process cycle. In STEP 41, the slave operation target determination unit 131a determines the target slave foot position posture of each of the left and right feet 106L and 106R of the slave device 101 in response to the virtual operator foot position posture of each of the left and right feet of the operator P received from the master control unit 141 so that the virtual operator foot position posture (the virtual operator foot position posture viewed in the virtual floor coordinate system Cvir) of each of the left and right feet of the operator P and the actual slave foot position posture (the actual slave foot position posture viewed in the slave side global coordinate system Cs) of each of the left and right feet 106L and 106R of the slave device 101 satisfy a predetermined relationship represented by the following formulas (71a) to (71d).

That is, the slave operation target determination unit 131a determines the target slave foot position posture of each of the left and right feet 106L and 106R of the slave device 101 by the following formulas (71a-1) to (71d-1) from the virtual operator foot position posture of each of the left and right feet of the operator P.

↑P_sf_act_L=Kpsf*↑P_opf_vir_L+↑Cpsf (71a)

↑P_sf_act_R=Kpsf*↑P_opf_vir_R+↑Cpsf (71b)

↑θ_sf_act_L=↑θ_opf_vir_L (71c)

↑θ_sf_act_R=↑θ_opf_vir_R (71d)

↑P_sf_aim_L=Kpsf*↑P_opf_vir_L+↑Cpsf (71a-1)

↑P_sf_aim_R=Kpsf*↑P_opf_vir_R+↑Cpsf (71b-1)

↑θ_sf_aim_L=↑θ_opf_vir_L (71c-1)

↑θ_sf_aim_R=↑θ_opf_vir_R (71d-1)

Here, ↑P_sf_act_L and ↑P_sf_act_R are respectively the actual positions (the actual slave foot positions) of the left and right feet 106L and 106R of the slave device 101, ↑θ_sf_act_L and ↑θ_sf_act_R are respectively the actual postures (the actual slave foot postures) of the left and right feet 106L and 106R of the slave device 101, and ↑P_sf_aim_L and ↑P_sf_aim_R are respectively the target positions (the target slave foot positions) of the left and right feet 106L and 106R of the slave device 101.

Further, ↑θ_sf_act_L and Cu_sf_act_R are respectively the actual postures (the actual slave foot postures) of the left and right feet 106L and 106R of the slave device 101 and Tθ_sf_aim_L and ↑θ_sf_aim_R are respectively the target postures (the target slave foot postures) of the left and right feet 106L and 106R of the slave device 101.

Further, ↑P_opf_vir_L and ↑P_opf_vir_R are respectively the virtual operator foot positions on the left and right sides of the operator P and ↑θ_opf_act_L and ↑θ_opf_act_R are respectively the virtual operator foot postures on the left and right sides of the operator P.

Further, Kpsf is a coefficient of a predetermined value (scalar or diagonal matrix) and ↑Cpsf is a constant vector having a component of a predetermined value. ↑Cpsf may be a zero vector. Additionally, a predetermined relationship between each of ↑θ_sf_aim_L and ↑θ_sf_aim_R and each of ↑θ_opf_act_L and ↑θ_opf_act_R may be, for example, a relationship represented by a linear function of the same form as the formula (71a) or formula (71b).

Next, in STEP 42, the slave operation target determination unit 131a determines the target slave foot position posture of each of the left and right feet 106L and 106R of the slave device 101 in response to the actual operator foot grounding reaction force (the observed value) of each of the left and right feet of the operator P received from the master control unit 141 so that the actual operator foot grounding reaction force (the actual operator foot grounding reaction force viewed in the virtual floor coordinate system Cvir) of each of the left and right feet of the operator P and the actual slave foot floor reaction force (the actual slave foot reaction force viewed in the slave side global coordinate system Cs) of each of the left and right feet 6L and 6R of the slave device 1 satisfy a predetermined relationship represented by the following formulas (72a) to (72d).

That is, the slave operation target determination unit 131a determines the target slave foot floor reaction force of each of the left and right feet 106L and 106R of the slave device 101 by the following formulas (72a-1) to (72d-1) from the observed value of the actual operator foot grounding reaction force of each of the left and right feet of the operator P.

↑F_sf_act_L=mtotal_ratio*↑F_opf_act_L (72a)

↑F_sf_act_R=mtotal_ratio*↑F_opf_act_R (72b)

↑M_sf_act_L=mtotal_ratio*↑F_opf_act_R (72c)

↑F_sf_act_L=mtotal_ratio*↑F_opf_act_R (72d)

↑F_sf_aim_L=mtotal_ratio*↑F_opf_act_L (72a-1)

↑F_sf_aim_R=mtotal_ratio*↑F_opf_act_R (72b-1)

↑M_sf_aim_L=mtotal_ratio*↑F_opf_act_R (72c-1)

↑F_sf_aim_L=mtotal_ratio*↑F_opf_act_R (72d-1)

Here, ↑F_sf_act_L and ↑F_sf_act_R are respectively the translational forces (the actual slave foot translational forces) in the actual slave foot floor reaction forces of the left and right feet 106L and 106R of the slave device 101 and ↑F_sf_aim_L and ↑F_sf_aim_R are respectively the translational forces (the target slave foot translational forces) in the target slave foot floor reaction forces of the left and right feet 106L and 106R of the slave device 101.

Further, ↑M_sf_act_L and ↑M_sf_act_R are respectively the moments (the actual slave foot moments) in the actual slave foot floor reaction forces of the left and right feet 106L and 106R of the slave device 101 and M_sf_aim_L and ↑M_sf_aim_R are respectively the moments (the target slave foot moments) in the target slave foot floor reaction forces of the left and right feet 106L and 106R of the slave device 101.

Further, ↑F_opf_act_L and ↑F_opf_act_R are respectively the translational forces (the actual operator foot translational forces) in the actual operator foot floor reaction force of each of the left and right feet of the operator P and ↑M_opf_act_L and ↑M_opf_act_R are respectively the moments (the actual operator foot moments) in the actual operator foot floor reaction forces on the left and right sides of the operator P.

Further, mtotal ratio is a mass ratio (=total slave mass/total operator mass) between the total slave mass which is the total mass of the slave device 101 and the total operator mass which is the total mass of the operator P.

Next, in each of STEP 43 to STEP 45, the slave operation target determination unit 131a determines each of the target slave foot floor reaction force center point, the target slave total floor reaction force, and the target slave total floor reaction force center point in the target slave floor reaction force.

Specifically, in STEP 43, the slave operation target determination unit 131a obtains the lateral position of the target slave foot floor reaction force center point of each of the left and right feet 106L and 106R of the slave device 101 from the target slave foot floor reaction force (↑F_sf_aim_L, ↑F_sf_aim_R, ↑M_sf_aim_L, ↑M_sf_aim_R) determined in STEP 42. In this case, the floor reaction force center point (COP) of each foot 106 is a point in which the moment around the axis in the lateral direction (the Xs-axis direction and the Ys-axis direction of the slave side global coordinate system Cs) becomes zero. Thus, the lateral position of the target slave foot floor reaction force center point of each of the left and right feet 106L and 106R is calculated by the following formulas (73a) to (73d).

COP_sf_x_aim_L=M_sf_y_aim_L/F_sf_z_aim_L (73a)

COP_sf_x_aim_R=M_sf_y_aim_R/F_sf_z_aim_R (73 b)

COP_sf_y_aim_L=−M_sf_x_aim_L/F_sf_z_aim_L (73c)

COP_sf_y_aim_R=−M_sf_x_aim_R/F_sf_z_aim_R (73d)

Here, COP_sf_x_aim_L and COP_sf_x_aim_R are respectively the target positions in the Xs-axis direction of the target slave foot floor reaction force center points of the left and right feet 106L and 106R of the slave device 101 and COP_sf_y_aim_L and COP_sf_y_aim_R are respectively the target positions in the Ys-axis direction of the target slave foot floor reaction force center points of the left and right feet 106L and 106R of the slave device 101.

Further, Msf_y_aim_L and Msf_y_aim_R are respectively the components in the direction around the Ys axis of the target slave foot moments ↑M_sf_aim_L and ↑M_sf_aim_R of the left and right feet 106L and 106R of the slave device 101, Msf_x_aim_L and Msf_x_aim_R are respectively the components in the direction around the Xs axis of the target slave foot moments ↑M_sf_aim_L and ↑M_sf_aim_R of the left and right feet 106L and 106R of the slave device 101, and F_sf_z_aim_L and F_sf_z_aim_R are respectively the components in the Zs-axis direction (the up-down direction) of the target slave foot translational forces ↑F_sf_aim_L and ↑F_sf_aim_R of the left and right feet 106L and 106R of the slave device 101.

In STEP 44, the slave operation target determination unit 131a obtains the target slave total floor reaction force (the translational force ↑F_sf_total_aim and the moment ↑M_sf_total_aim) by the following formulas (74a) and (74b) from the target slave foot floor reaction force (↑F_sf_aim_L, ↑F_sf_aim_R, ↑M_sf_aim_L, ↑M_sf_aim_R) determined in STEP 42. That is, the slave operation target determination unit 131a obtains the resultant force of the target slave foot floor reaction forces of the left and right feet 106L and 106R as the target slave total floor reaction force. Additionally, ↑F_sf_total_aim and ↑M_sf_total_aim are respectively the target slave total floor reaction force translational force and the moment.

↑F_sf_total_aim=↑F_sf_aim_L+↑F_sf_aim_R (74a)

↑M_sf_total_aim=↑M_sf_aim_L+↑M_sf_aim_R (74b)

In STEP 45, the slave operation target determination unit 131a obtains the lateral position of the target slave total floor reaction force center point by the following formulas (75a) and (75b) which are the same formulas as the formulas (73a) to (73d) used in STEP 43 from the target slave total floor reaction force (↑F_sf_total_aim, ↑M_sf_total_aim) obtained from STEP 44. Additionally, COP_sf_total_x_aim and COP_sf_total_y_aim are respectively the Xs-axis direction position and the Ys-axis direction position of the target slave total floor reaction force center point.

COP_sf_total_x_aim=M_sf_total_y_aim/F_sf_total_z_aim (75a)

COP_sf_total_y_aim=−M_sf_total_x_aim_L/F_sf_total_z_aim (75b)

Next, in STEP 46, the slave operation target determination unit 131a determines the target slave upper body posture in response to the virtual operator upper body posture (the virtual operator upper body direction and the virtual operator upper body inclination) received from the master control unit 141 so that the virtual operator upper body posture (direction and inclination) viewed in the virtual floor coordinate system Cvir and the actual slave upper body posture (direction and inclination) viewed in the slave side global coordinate system Cs satisfy a predetermined relationship represented by, for example, the following formula (76).

That is, the slave operation target determination unit 131a determines the target slave upper body posture, for example, by the following formula (76-1) from the virtual operator upper body posture.

↑θ_sb_act=↑θ_opb_vir (76)

↑θ_sb_aim=↑θ_opb_vir (76-1)

Here, ↑θ_sb_act is the actual slave upper body posture, ↑θ_sb_aim is the target slave upper body posture, and ↑θ_opb_vir is the virtual operator upper body posture. Additionally, a predetermined relationship between ↑θ_sb_act and ↑θ_opb_vir may be, for example, a relationship represented by a linear function of the same form as the above formula (71a) or (71b).

Next, in STEP 47, the slave operation target determination unit 131a determines the height (the target slave upper body height) in the target slave upper body position in response to the virtual upper body support portion height received from the master control unit 141 so that the virtual upper body support portion height of the master device 51 (the up-down direction position of the upper body support portion 65) viewed in the virtual floor coordinate system Cvir and the actual slave state height (the up-down direction position of the upper body 102 of the slave device 101) viewed in the slave side global coordinate system Cs satisfy a predetermined relationship represented by, for example, the following formula (77).

That is, the slave operation target determination unit 131a determines the target slave upper body height from the virtual upper body support portion height by the following formula (77-1).

P_sb_z_act=Kpsb_z*P_mb_z_act+Cpsb_z (77)

P_sb_z_aim=Kpsb_z*P_mb_z_act+Cpsb_z (77-1)

Here, P_sb_z_act is the actual slave upper body height, P_sb_z_aim is the target slave upper body height, P_mb_z_vir is the virtual upper body support portion height, and Kpsb_z and Cpsb_z are constants of predetermined values. Additionally, Cpsb_z may be zero.

Supplementally, when the master control unit 141 is configured to obtain the virtual operator upper body height P_opb_z_vir from the actual operator upper body height (the actual height of the upper body of the operator P), the target slave upper body height P_sb_z_aim may be determined in response to P_opb_z_vir so that the virtual operator upper body height P_opb_z_vir and the actual slave upper body height P_sb_z_act satisfy, for example, a relationship in which P_mb_z_vir of the above formula (77) is replaced with P_opb_z_vir. That is, the target slave upper body height P_sb_z_aim may be determined by a formula in which P_mb_z_vir of the formula (77-1) is replaced with P_opb_z_vir.

Next, in STEP 48, the slave operation target determination unit 131a determines an updated value of the actual slave upper body lateral position estimated as described below by the upper body lateral position estimation unit 131d as the target slave upper body lateral position which is the lateral position of the target slave upper body position. That is, the slave operation target determination unit 131a determines the target slave upper body lateral position by the following formulas (78a) and (78b) from the observed value (updated value) of the actual slave upper body lateral position.

P_sb_x_aim=P_sb_x_act (78a)

P_sb_y_aim=P_sb_y_act (78b)

Here, P_sb_x_aim is the Xs-axis direction position in the target slave upper body lateral position, P_sb_y_aim is the Ys-axis direction position in the target slave upper body lateral position, P_sb_x_act is the Xs-axis direction position in the actual slave upper body lateral position, and P_sb_y_act is the Ys-axis direction position in the actual slave upper body lateral position.

The process of the slave operation target determination unit 131a is executed as described above. Thus, in this embodiment, the target slave foot position posture of each of the left and right feet 106L and 106R of the slave device 101 is determined in response to the virtual operator foot position posture to aim at a constant linear relationship represented by the above formulas (71a) to (71d).

Further, the target slave upper body posture and the target slave upper body height are respectively determined in response to the virtual operator upper body posture and the virtual upper body support portion height (or the virtual operator upper body height) to aim at a constant linear relationship represented by the above formulas (76) and (77).

On the other hand regarding the target slave upper body lateral position, the actual slave upper body lateral position is directly determined as the target slave upper body lateral position regardless of the lateral position of the upper body of the operator P or the upper body support portion 65.

Further, the target slave foot floor reaction force (the translational force and the moment) of each of the left and right feet 106L and 106R in the target slave floor reaction force is determined to be proportional to the actual operator foot grounding reaction force of each of the left and right feet of the operator P at a mass ratio between the slave device 101 and the operator P (=total slave mass/total operator mass). Then, the target slave foot floor reaction force center point, the target slave total floor reaction force, and the target slave total floor reaction force center point are determined to satisfy a predetermined necessary relationship with the target slave foot floor reaction force of each of the feet 106L and 106R.

Thus, the target slave upper body motion, the target slave leg motion, and the target slave floor reaction force other than the target slave upper body lateral position are respectively determined to change in the same pattern as the actual motion of the upper body of the operator P and the actual motion of each foot of the operator P with respect to the virtual floor and the actual grounding reaction force applied to each foot of the operator P.

Supplementally, in this embodiment, the target slave upper body height P_sb_z_aim is determined in response to the observed value of the virtual upper body support portion height P_mb_z_vir (or the virtual operator upper body height P_opb_z_vir). However, the target slave upper body height P_sb_z_aim may be set to a predetermined value regardless of, for example, the virtual upper body support portion height P_mb_z_vir (or the virtual operator upper body height P_opb_z_vir). In this case, the observed value of the virtual upper body support portion height P_mb_z_virt (or the virtual operator upper body height P_opb_z_vir) does not need to be output (transmitted) from the master control unit 141 to the slave control unit 131.

Although the description in the flowchart of FIG. 25 is omitted, since the slave device 101 includes the arm 110 and the head portion 117 which are movable with respect to the upper body 102 in this embodiment, the slave operation target determination unit 131a also determines the target motion of each arm 110 and the head portion 117. In this case, the target motion of each arm 110 and the head portion 117 can be determined, for example, so that the hand portion 113 of each arm 110 and the head portion 117 are maintained in the uniform position posture with respect to the upper body 102 at the time of moving the slave device 101 by the manipulation of the operator P.

However, for example, the target motion of each arm 110 may be determined so that each arm 110 is made to perform a motion such as swinging back and forth with respect to the upper body 102 in synchronization with the motion of the leg 103. Further, the target motion of the head portion 117 may be determined so that the head portion 117 appropriately moves with respect to the upper body 102. Further, for example, the actual motion of each arm or the head of the operator P (the motion with respect to the upper body of the operator P) may be estimated by the same detector as the operator motion detector 78 and the target motion of the head portion 117 or each arm 110 of the slave device 101 (the target motion with respect to the upper body 102) may be determined as the same motion as the actual motion of each arm or the head of the operator P.

[Process of Upper Body Lateral Position Estimation Unit]

Next, a process of the upper body lateral position estimation unit 131d will be described. As shown in FIG. 21, the actual upper body inclination which is detected by the upper body posture detector 123, the inclination (the target upper body inclination) in the target slave upper body position posture which is determined by the slave operation target determination unit 131a, and the lateral position (the target upper body lateral position) are sequentially input to the upper body lateral position estimation unit 131d. Then, the upper body lateral position estimation unit 131d estimates the actual slave upper body lateral position by using these input values.

Here, the slave device 101 is basically operated to substantially follow the target slave upper body position posture and the target slave foot position posture determined by the slave operation target determination unit 131a. However, the inclination of the actual posture of the upper body 102 may deviate from the target slave upper body inclination due to the unevenness state of the floor surface, the correction of the target slave foot position posture, or the like even by the compliance control to be described later. Then, when the inclination of the upper body 102 deviates, the actual lateral position of the upper body 102 deviates from the target slave upper body lateral position.

Here, the upper body lateral position estimation unit 131d estimates the actual slave upper body lateral position, for example, by the following formulas (79a) and (79b).

P_sb_x_act=P_sb_x_aim+P_sb_z_act*sin(θ_sb_y_act−θ_sb_y_aim) (79a)

P_sb_y_act=P_sb_y_aim−P_sb_z_act*sin(θ_sb_x_act−θ_sb_x_aim) (79b)

Here, P_sb_x_act and P_sb_y_act are respectively the observed values of the Xs-axis direction position and the Ys-axis direction position in the actual slave upper body lateral position, P_sb_x_aim and P_sb_y_aim are respectively the Xs-axis direction position and the Ys-axis direction position in the target slave upper body lateral position, P_sb_z_act is the actual slave upper body height, θ_sb_x_aim and θ_sb_y_aim are respectively the inclination in the direction around the Xs axis and the inclination in the direction around the Ys axis in the target slave upper body inclination, and θ_sb_x_act and θ_sb_y_act are respectively the observed values of the inclination in the direction around the Xs axis and the inclination in the direction around the Ys axis in the actual slave upper body inclination.

In this case, the target values which are determined by the slave operation target determination unit 131a in the control process cycle before the current control process of the upper body lateral position estimation unit 131d are used as the values of the target slave upper body lateral positions P_sb_x_aim and P_sb_y_aim. Further, the estimated value of the upper body posture detector 123 is used as the values of the actual slave upper body inclinations θ_sb_x_act and θ_sb_y_act.

Further, for example, an estimated value which is estimated by kinematics calculation from the actual joint displacement detected value of each joint of one of the grounded legs 103 in the left and right legs 103L and 103R of the slave device 101 is used as the value of the actual slave upper body height P_sb_z_act. Additionally, when both legs 103L and 103R are grounded, for example, the height of the upper body 102 is estimated by kinematics calculation for each of the legs 103L and 103R and an average value of the estimated values for each of the legs 103L and 103R may be used as the value of the actual slave upper body height P_sb_z_act. Alternatively, for example, the target slave upper body height P_sb_z_aim determined by the slave operation target determination unit 131a may be used instead of the actual slave upper body height P_sb_z_act.

Additionally, when an absolute value of the deviation (=θ_sb_y_act−θ_sb_y_aim) in the direction around the Ys axis or the deviation (=θ_sb_x_act−θ_sb_x_aim) in the direction around the Xs axis between the target slave upper body inclination and the actual slave upper body inclination is sufficiently small, the right side of the formula (79a) or the formula (79b) may be calculated by using an approximate relationship that sin (θ_sb_y_act−θ_sb_y_aim) θ_sb_y_act−θ_sb_y_aim or sin (θ_sb_x_act−θ_sb_x_aim) θ_sb_x_act−θ_sb_x_aim.

Supplementally, a method of estimating the actual slave upper body lateral position is not limited to the above-described method. For example, the actual slave upper body lateral position can be estimated by integration (second-order integration) of the lateral translational acceleration detected by the acceleration sensor 123a of the upper body posture detector 123.

Further, the actual slave upper body lateral position can be estimated, for example, by a process of fusing the estimation method based on the above formulas (79a) and (79b) and the estimation method using the acceleration sensor 123 a by a Kalman filter. In addition, the actual slave upper body lateral position can be estimated by various known methods capable of estimating the own position of the object.

[Process of Composite Compliance Operation Determination Unit]

Next, a process of the composite compliance operation determination unit 131b will be described. As shown in FIG. 21, the target slave leg motion (the target slave foot position posture) determined by the slave operation target determination unit 131a and the target slave floor reaction force (the target slave foot floor reaction force, the target slave foot floor reaction force center point, the target slave total floor reaction force, the target slave total floor reaction force center point) are sequentially input to the composite compliance operation determination unit 131b. Then, the composite compliance operation determination unit 131b determines the correction target slave leg motion (the correction target slave foot position posture) by correcting the target slave foot position posture by a compliance control process using these input values.

Generally, the process of the composite compliance operation determination unit 131b (compliance control process) is a process of correcting the target slave foot position posture in the entire target motion of the slave device 101 so that a necessary state quantity (a translational force in a predetermined direction, a moment in the direction around a predetermined axis, a position of a floor reaction force center point of each foot 106, a position of a total floor reaction force center point, and the like) related to an actual slave floor reaction force corresponding to a floor reaction force actually applied to the slave device 101 approaches a necessary target value defined by the target slave floor reaction force determined by the slave operation target determination unit 131a in order to prevent an excessive floor reaction force from being applied to each foot 106 or prevent the entire posture of the slave device 101 from collapsing due to an unexpected unevenness or obstacle on the floor surface where the slave device 101 moves.

In this embodiment, as a process of such a composite compliance operation determination unit 131b, for example, a known control process described in Paragraphs 0123 to 0207 of Japanese Patent Application Laid-Open No. H10-277969 is executed. For this reason, a detailed description of the process of the composite compliance operation determination unit 131b in the present specification will be omitted. However, in the process of the composite compliance operation determination unit 131b of this embodiment, the “compensation total floor reaction force moment Mdmd” described in Japanese Patent Application Laid-Open No. H10-277969 is set to zero.

In the process of such a composite compliance operation determination unit 131b, the target slave foot position posture of each foot 106 (the target slave foot position posture determined by the slave operation target determination unit 131a) is corrected so that the moment (the moment in the direction around the Xs axis and the direction around the Ys axis) of the actual floor reaction force generated around the target slave total floor reaction force center point approaches zero by a composite operation of an operation of rotating both feet 106L and 106R of the slave device 101 in the direction around the Xs axis and the direction around the Ys axis by using the target slave total floor reaction force center point (in other words, the target ZMP) as a center and an operation of moving each of the feet 106L and 106R in a translational manner in the opposite directions in the direction around the Xs axis and the direction around the Ys axis by using the target slave total floor reaction force center point as a center. Accordingly, the correction target slave foot position posture of each foot 106 is determined.

In this case, the correction amount of the target slave foot position posture is determined by using the observed value of the actual slave foot floor reaction force detected by the floor reaction force detector 125 and the target slave floor reaction force (the target slave foot floor reaction force, the target slave foot floor reaction force center point, the target slave total floor reaction force, and the target slave total floor reaction force center point) determined by the slave operation target determination unit 131a.

[Process of Joint Displacement Determination Unit]

Next, a process of the joint displacement determination unit 131c will be described. As shown in FIG. 21, the target slave upper body motion (the target slave upper body position posture) determined by the slave operation target determination unit 131a and the correction target slave leg motion (the correction target slave foot position posture) determined by the composite compliance operation determination unit 131b are sequentially input to the joint displacement determination unit 131c. Then, the joint displacement determination unit 131c determines the target joint displacement of each joint of each leg 103 of the slave device 101 by inverse kinematics calculation from the target slave upper body position posture and the target slave foot position posture of each foot 106.

Further, although not shown in FIG. 21, in this embodiment, the target motion of the head portion 117 and the target motion of each arm 110 of the slave device 101 determined by the slave operation target determination unit 131a are further input to the joint displacement determination unit 131c. Then, the joint displacement determination unit 131c determines the target joint displacement of each joint of each arm 110 in response to the target motion of each arm 110 and determines the target joint displacement of each joint of the neck joint mechanism 118 in response to the target motion of the head portion 117.

In this case, when the target motion of each arm 110 is, for example, the target position posture of the hand portion 113 of each arm 110 (the relative target position posture with respect to the upper body 102), the target joint displacement of each joint of each arm 110 can be determined by an inverse kinematics calculation process. Further, when the target motion of each arm 110 is configured by, for example, the target joint displacement of each joint of each arm 110, the target joint displacement is directly determined as the target joint displacement of each joint. The same applies to the head portion 117.

The control process of each function unit of the slave control unit 131 is executed as described above. Then, the slave control unit 131 outputs the target joint displacement of each joint determined by the joint displacement determination unit 131c to the joint control unit 132.

Further, the slave control unit 131 outputs (transmits) the actual slave upper body lateral position estimated by the upper body lateral position estimation unit 131d to the master control unit 141 via the communication device 133.

Additionally, in this embodiment, since the target slave upper body lateral position is determined to match the actual slave upper body lateral position, the target slave upper body lateral position may be output to the master control unit 141 instead of outputting (transmitting) the observed value of the actual slave upper body lateral position to the master control unit 141.

Additionally, in this embodiment, a process in which the target upper body support portion motion determination unit 141b determines the target upper body support portion motion in STEP 31 corresponds to the A process of the disclosure and all of this process and the control process of the master movement control unit 141a include processes corresponding to the A process, the C process, the D process, and the E process of the disclosure. Further, the control process of the slave control unit 131 corresponds to the B process of the disclosure.

[Operation and Effect]

According to the manipulation system of this embodiment described above, as described in the first embodiment with reference to FIG. 17, the operator P can perform the walking operation on the virtual floor surface as if walking on the actual floor while smoothly grounding the foot on the free leg side to the corresponding foot mount 70.

Further, as described in the first embodiment with reference to FIG. 16, the lateral position of the upper body support portion 65 (or the lateral position of the master base 53) can be suppressed from deviating from the reference position (the lateral reference position) and the master device 51 can be moved to stay in the movable range AR_lim even when the operator P performs the continuous walking operation.

Further, since the operation of the master device 51 is controlled so that the up-down direction position of the upper body support portion 65 also does not deviate from the up-down direction reference position, the operator P can perform the walking operation as if going up and down a staircase or a slope so that the up-down direction position of the upper body support portion 65 does not greatly change from the up-down direction reference position even when a difference between the up-down direction positions of the foot mounts 70L and 70R in the target foot mounts is set so that the virtual floor becomes a staircase or a slope in response to the slave floor shape.

Further, as described in the first embodiment with reference to FIG. 18, since all of the master base 53, the upper body support portion 65, and the foot mounts 70L and 70R are tilted in response to the upper body support portion acceleration correction amount (the feedback correction amount) ↑Acc_mb_fb, the operator P can perform the walking operation as if the upper body support portion acceleration correction amount ↑Acc_mb_fb is not added.

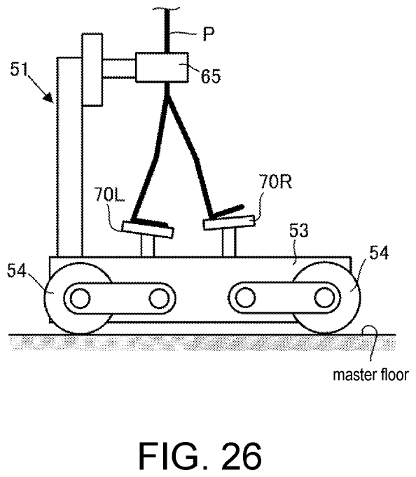

Further, in this embodiment, as shown in FIG. 26, since each of the foot mounts 70L and 70R is tilted in response to the inclination of the slave floor below the foot 106 of the corresponding slave device 101, the operator P can perform the walking operation in a suitable manner while sensibly recognizing the inclination of the slave floor surface below the foot 106 for each foot 106 of the slave device 1.

Thus, the operator P can perform the walking operation on the master device 51 in the same manner as on the actual floor with the virtual floor having a shape conforming to the floor shape of the slave floor. Further, the slave device 101 can be easily moved in a desired manner on the slave floor.

Further, in this embodiment, the target upper body support portion lateral position is determined so that the actual upper body support portion lateral position (or the actual operator upper body lateral position) and the actual slave upper body lateral position satisfy a relationship represented by the above (61a) and (61b) (or a relationship represented by a formula in which the left side of the above (61a) and (61b) is replaced with the virtual operator lateral position). Further, in the process of the slave operation target determination unit 131a of the slave control unit 131, the target slave upper body lateral position is determined to match the observed value of the actual slave upper body lateral position regardless of the lateral position of the upper body support portion 65 or the upper body of the operator P.

For this reason, when the posture of the slave device 1 is collapsed, the target upper body support portion lateral position is determined in response to the actual slave upper body lateral position in the collapsed posture. Further, the upper body of the operator P receives a lateral translational force (a translational force that tries to collapse the posture of the operator P in the same manner as the slave device 1) in response to the collapse of the posture of the slave device 1 from the upper body support portion 65. For example, when the slave device 1 collapses the posture in the forward leaning direction, a translational force is applied from the upper body support portion 65 to the upper body of the operator P in the forward direction.

Accordingly, the operator P can appropriately, quickly, and sensibly recognize the collapsed posture of the slave device 1 or the posture collapsing direction in the slave device 1.

### Third Embodiment

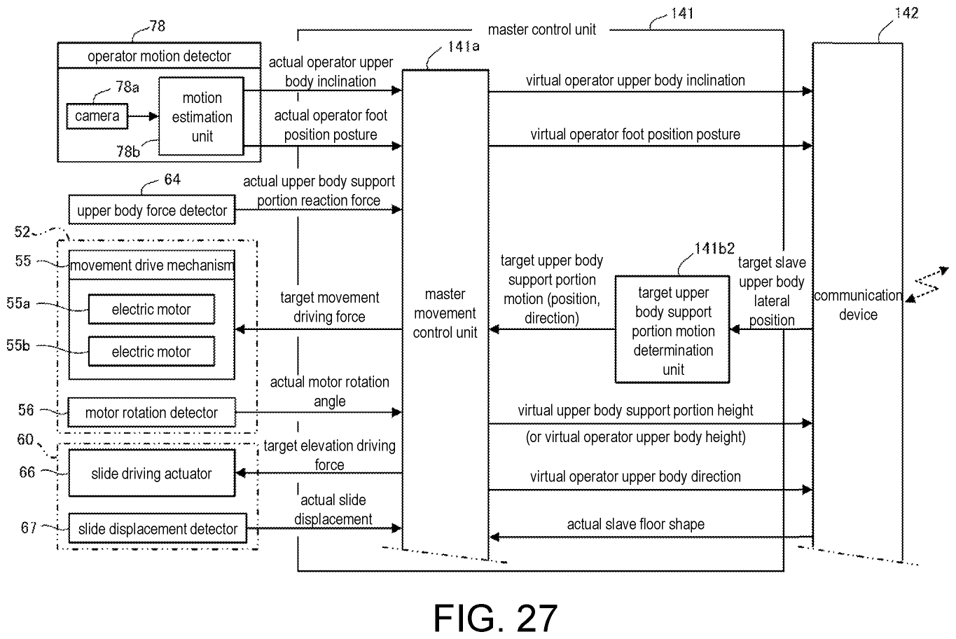

Next, a third embodiment of the disclosure will be described with reference to FIGS. 27 to 30. Additionally, this embodiment is different from the second embodiment only in the control process of a part of the master control unit 141 and the slave control unit 131. For this reason, in the description of this embodiment, the description of the same parts as those of the second embodiment will be omitted.

First, referring to FIG. 27, in this embodiment, the master control unit 141 receives the target slave upper body lateral position in the target upper body motion of the upper body 102 of the slave device 101 determined by the slave control unit 131 via the communication device 142 instead of the actual slave upper body lateral position. Additionally, the target slave upper body position posture is determined by a process (to be described later in detail) different from that of the second embodiment.

Then, in this embodiment, a target upper body support portion motion determination unit 141b2 of the master control unit 141 determines the target upper body support portion lateral position in the target upper body support portion motion in response to the target slave upper body lateral position received from the slave control unit 131. Specifically, the target upper body support portion motion determination unit 141b2 determines the target upper body support portion lateral position so that the target upper body support portion lateral position satisfies the relationship of the above formulas (71a) and (71b) with respect to the target slave upper body lateral position. That is, the target upper body support portion motion determination unit 141b2 determines the target upper body support portion lateral position (P_mb_x_aim, P_mb_y_aim) by the following formulas (71a-2) and (71b-2).

P_mb_x_aim=Kpmb*P_sb_x_aim+Cpmb_x (71a-2)

P_mb_y_aim=Kpmb*P_sb_y_aim+Cpmb_y (71b-2)

In this embodiment, the control process of the master control unit 141 is the same as the second embodiment except for the above-described parts.

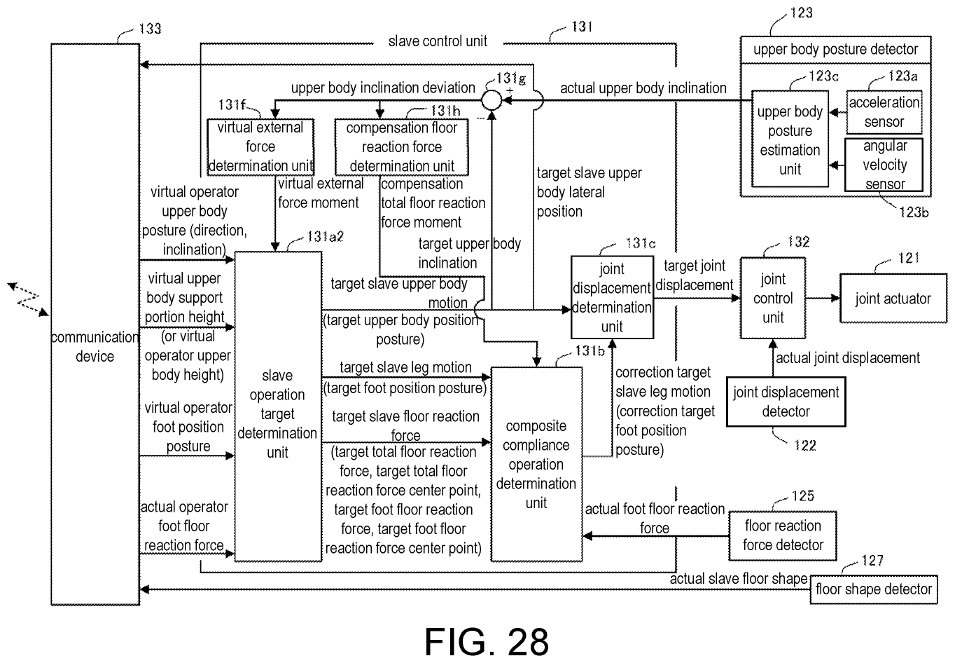

Next, referring to FIG. 28, in this embodiment, the slave control unit 131 includes a slave operation target determination unit 131a2 which determines the operation target (the target slave upper body motion, the target slave leg motion, and the target slave floor reaction force) of the slave device 101 by a process (a process using the dynamics model of the slave device 101) different from the slave operation target determination unit 131a of the second embodiment, a virtual external force determination unit 131f which determines a virtual external force virtually applied to the slave device 101 on the dynamics model used in the slave operation target determination unit 131a2, a compensation floor reaction force determination unit 131h which determines a floor reaction force additionally applied to the slave device 101, a calculation unit 131g which calculates an input to the virtual external force determination unit 131f and the compensation floor reaction force determination unit 131h, and the composite compliance operation determination unit 131b and the joint displacement determination unit 131c which are described in the first embodiment.

Then, in this embodiment, the slave control unit 131 transmits the target slave upper body lateral position in the target slave upper body motion determined by the slave operation target determination unit 131a2 to the master control unit 141 via the communication device 133 instead of the estimated value of the actual slave upper body lateral position. For this reason, in the slave control unit 131 of this embodiment, the upper body lateral position estimation unit 131d described in the first embodiment is omitted.

The processes of the calculation unit 131g, the virtual external force determination unit 131f, the slave operation target determination unit 131a2, and the compensation floor reaction force determination unit 131h will be described in detail below. These processes are executed as below in a predetermined control process cycle. The actual slave upper body inclination estimated by the upper body posture detector 123 and the target slave upper body inclination in the target slave upper body motion determined by the slave operation target determination unit 131a2 are input to the calculation unit 131g. Then, the calculation unit 131g calculates an upper body inclination deviation which is a deviation between the actual slave upper body inclination and the target slave upper body inclination (=actual slave upper body inclination−target slave upper body inclination). The upper body inclination deviation includes an inclination deviation in the direction around the Xs axis and an inclination deviation in the direction around the Ys axis in the slave side global coordinate system Cs.

The upper body inclination deviation which is calculated by the calculation unit 131g is input to the virtual external force determination unit 131f. Then, the virtual external force determination unit 131f determines the virtual external force so that the upper body inclination deviation converges to zero by known feedback control laws (for example, a P law, a PD law, a PID law, and the like) from the input upper body inclination deviation.

Here, in this embodiment, the virtual external force is, for example, a moment generated around a target slave total floor reaction force center in the direction around the axis in the lateral direction (the direction around the Xs axis and the direction around the Ys axis) and is hereinafter referred to as a virtual external force moment. Then, a component in the direction around the Xs axis and a component in the direction around the Ys axis of the virtual external force moment are respectively determined by a feedback control law from a component in the direction around the Xs axis and a component in the direction around the Ys axis of the upper body inclination deviation.

Similarly to the second embodiment, the command information (the observed values of the virtual operator upper body posture (direction and inclination), the virtual upper body support portion height (or the virtual operator upper body height), the virtual operator foot position posture, and the actual operator foot floor reaction force) received by the slave control unit 131 from the master control unit 141 is input to the slave operation target determination unit 131a2. Further, in this embodiment, the virtual external force moment determined by the virtual external force determination unit 131f is input to the slave operation target determination unit 131a2 instead of the actual slave upper body lateral position.

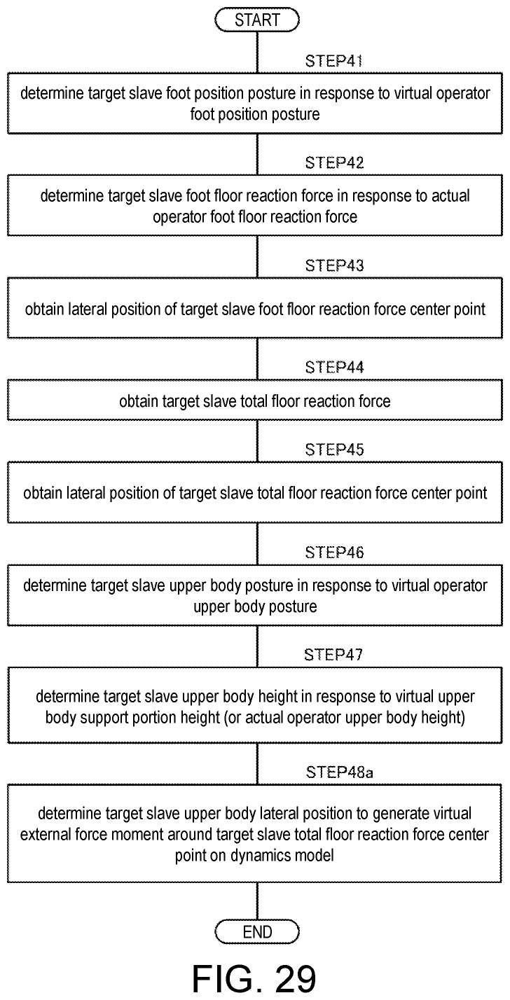

Then, the slave operation target determination unit 131a2 executes a process shown in the flowchart of FIG. 29 in a predetermined control process cycle. In this case, the slave operation target determination unit 131a2 executes the same process as that of the slave operation target determination unit 131a of the second embodiment in STEP 41 to STEP 47. Accordingly, the target slave upper body motion, the target slave leg motion, and the target slave floor reaction force other than the target slave upper body lateral position are determined.

Next, in STEP 48a, the slave operation target determination unit 131a2 determines the target slave upper body lateral position to generate the virtual external force moment determined by the virtual external force determination unit 131f around the target slave total floor reaction force center point (target ZMP) on the dynamics model of the slave device 101.

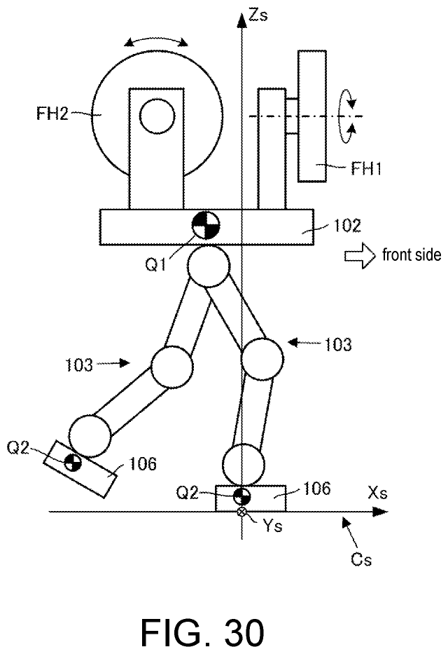

As the dynamics model of the slave device 101, for example, a dynamics model described in Paragraphs 0128 to 0134 and FIG. 10 of Japanese Patent No. 4246638, a dynamics model described in, for example, Paragraphs 0163 to 0168 and FIG. 12 of Japanese Patent No. 4126061, or a dynamics model equivalent thereto can be used. FIG. 30 schematically shows a dynamics model as an example used in this embodiment. Additionally, the dynamics model is the same as that described in Japanese Patent No. 4246638.

This dynamics model includes an upper body mass point Q1 which is a mass point moving in a translational manner in response to the translational motion of the upper body 102 of the slave device 101, a leg mass point Q2 which is a mass point moving in a translational manner in response to the translational motion of the foot 106 of each leg 103, a flywheel FH1 which rotates in the roll direction in response to the tilting motion of the upper body 102 in the roll direction (the direction around the axis in the front-rear direction) of the slave device 101, and a flywheel FH2 which rotates in the pitch direction in response to the tilting motion of the upper body 102 in the pitch direction (the direction around the axis in the left-right direction) of the slave device 101.

The mass is defined in advance for the upper body mass point Q1 and each leg mass point Q2 and the inertia is defined for the flywheels FH1 and FH2. In this case, the mass of the upper body mass point Q1 and the masses of two leg mass points Q2 and Q2 are set so that the total mass thereof matches the total mass of the slave device 101. Further, the position of the upper body mass point Q1 is defined in response to the position (or the position and posture) of the upper body 102 and the position of each leg mass point Q2 is defined in response to the position (or the position and posture) of the foot 106 of each leg 103. Additionally, the flywheels FH1 and FH2 do not have a mass.

The dynamics of the slave device 101 in this dynamics model is represented by a formula expressing a relationship that the total resultant force (translational force) of the gravity acting on each of the upper body mass point Q1 and each leg mass point Q2 and the inertia force (translational inertia force) generated in response to the translational acceleration of each of the upper body mass point Q1 and each leg mass point Q2 is balanced with the translational force in the total floor reaction force acting on the slave device 101 and a formula expressing a relationship that the total moment generated around an arbitrary_action point (for example, the target slave total floor reaction force center point or the like) due to the resultant force and the inertia force moment generated in response to the rotational angular acceleration of each of the flywheels FH1 and FH2 is balanced with the moment generated around the action point due to the total floor reaction force acting on the slave device 101.

In this case, the process of STEP 48a can be executed, for example, as below. Additionally, in the description herein, for convenience of description, the direction in the Xs-axis direction of the slave side global coordinate system Cs is appropriately updated, for example, so that the Xs-axis direction is the same direction or substantially the same direction as the front-rear direction of the slave device 101 (the direction around the Xs axis and the direction around the Ys axis of the slave side global coordinate system Cs are respectively the roll direction and the pitch direction of the slave device 101 as shown in FIG. 30). However, the coordinate can be appropriately converted between the slave side global coordinate system Cs and the coordinate system in which the coordinate-axis direction is aligned to the front-rear direction of the slave device 101.

Based on the time series of the target slave upper body inclination, the rotational angular acceleration of each of the flywheels FH1 and FH2 of the dynamics model is calculated and the upper body inclination corresponding moment which is the inertia moment (the inertia moment in the direction around the Xs axis and the direction around the Ys axis) generated by the flywheels FH1 and FH2 in response to the rotational angular acceleration is calculated.

Further, the translational acceleration of each leg mass point Q2 of the dynamics model is calculated based on the time series of the target slave foot position posture of each foot 106 of the slave device 101 and the leg motion corresponding moment which is the moment generated around the target slave total floor reaction force center point due to the resultant force of the gravity acting on each leg mass point Q2 and the inertia force generated at each leg mass point Q2 in response to the translational acceleration is calculated.

Further, the translational acceleration in the up-down direction (the Zs-axis direction) of the upper body mass point Q1 of the dynamics model is calculated based on the time series of the target slave upper body height. Additionally, the translational acceleration in the up-down direction of the upper body mass point Q1 may be calculated, for example, so that the resultant force of the inertia force in the up-down direction generated at the upper body mass point Q1 in response to the translational acceleration, the inertia force in the up-down direction generated at each leg mass point Q2 in response to the translational acceleration in the up-down direction of each leg mass point Q2 and calculated from the time series of the target slave foot position posture, and the gravity acting on the entire center of gravity of the slave device 101 is balanced with the translational force in the up-down direction of the target slave total floor reaction force.

Then, the lateral translational acceleration of the upper body mass point Q1 is calculated so that the components in the direction around the Xs axis and the direction around the Ys axis in the resultant force moment of the leg motion corresponding moment, the upper body inclination corresponding moment, and the upper body motion corresponding moment which is the moment generated around the target slave total floor reaction force center point due to the resultant force of the gravity acting on the upper body mass point Q1, the inertia force generated in response to the translational acceleration in the up-down direction of the upper body mass point Q1, and the lateral translational acceleration of the upper body mass point on the assumption that the lateral translational acceleration of the upper body mass point Q1 is a unknown number matches the virtual external force moment determined by the virtual external force determination unit 131f.

Then, the lateral position of the upper body mass point is determined by integration (second-order integration) of the lateral translational acceleration of the upper body mass point Q1 and the target slave upper body lateral position is determined from the lateral position of the upper body mass point Q1.

In STEP 48a, the target slave upper body lateral position is determined by the above-described process so that the virtual external force moment determined by the virtual external force determination unit 131f is generated around the target slave total floor reaction force center point (target ZMP) (specifically, the moment generated around the target slave total floor reaction force center point (target ZMP) due to the resultant force of the inertia force generated by the motion of the slave device 1 and the gravity acting on the slave device 101 matches the virtual external force moment) on the dynamics model. As a result, the target slave upper body lateral position is determined to approach the actual slave upper body lateral position.

Next, in this embodiment, the compensation floor reaction force determination unit 131h is a processing unit which determines a floor reaction force to be additionally applied to the slave device 101 to reduce a deviation generated when the actual slave upper body inclination estimated by the upper body posture detector 123 deviates from the target slave upper body inclination determined by the slave operation target determination unit 131a2.

In this embodiment, the floor reaction force to be additionally applied to the slave device 101 is a moment generated around the target total floor reaction force center point (target ZMP) in the direction around the axis in the lateral direction (the direction around the Xs axis and the direction around the Ys axis). Here, even in this embodiment, the floor reaction force determined by the compensation floor reaction force determination unit 131h is referred to as a compensation total floor reaction force moment.

The upper body inclination deviation calculated by the calculation unit 131g is input to the compensation floor reaction force determination unit 131h of this embodiment as the deviation amount of the actual slave upper body inclination with respect to the target slave upper body inclination determined by the slave operation target determination unit 131a2. Then, the compensation floor reaction force determination unit 131h determines the compensation total floor reaction force moment (the compensation total floor reaction force moment in the direction around the Xs axis and the direction around the Ys axis) so that the upper body inclination deviation converges to zero by feedback control laws such as a proportional/differential law (PD law) in response to the input upper body inclination deviation.

Then, the compensation total floor reaction force moment determined by the compensation floor reaction force determination unit 131h is input to the composite compliance operation determination unit 131b. In the composite compliance operation determination unit 131b, the target slave foot position posture (the target slave foot position posture determined by the slave operation target determination unit 131a2) of each foot 106 is corrected so that the moment of the actual floor reaction force generated around the target slave total floor reaction force center point (the moment in the direction around the Xs axis and the direction around the Ys axis) approaches the compensation total floor reaction force moment.

This embodiment is the same as the second embodiment except for the matters described above. Supplementally, in this embodiment, both the master control unit 141 and the slave control unit 131 correspond to the control device of the disclosure. Further, the target upper body support portion motion determination unit 141b2, the slave operation target determination unit 131a2, and the composite compliance operation determination unit 131b correspond to the operation target determination unit of the disclosure, the joint control unit 132 corresponds to the slave side control unit of the disclosure, and the master movement control unit 141a corresponds to the master side control unit of the disclosure.

Further, in this embodiment, a process in which the target upper body support portion motion determination unit 141b2 determines the target upper body support portion motion corresponds to the A1 process of the disclosure and all of this process and the control process of the master movement control unit 141a include processes corresponding to the A process, the C process, the D process, and the E process of the disclosure. Further, the control process of the slave control unit 131 corresponds to the B process of the disclosure.

According to the above-described embodiment, it is possible to obtain the same effect as that of the second embodiment.

### Other Embodiments

The disclosure is not limited to the above-described embodiments and can employ still other embodiments. Hereinafter, some other embodiments will be described. In the above-described embodiments, the tilt posture or the up-down direction position of each foot mount 70 of the master device 51 is changed in response to the slave floor shape, but when the slave floor is a flat surface or a floor surface substantially equivalent thereto, the foot mount 70 may be mounted on the base 53 so as not to change the tilt posture or the up-down direction position of each foot mount 70 or to prevent the tilt posture or the up-down direction position from being changed.

Further, in the above-described embodiments, the posture angle (direction) in the yaw direction of the foot mount on the free leg side 70 is changed in response to the direction in the yaw direction of the foot of the operator P, but each foot mount 70 may be mounted on the base 53 so as not to change the yaw direction or not to be rotatable in the yaw direction. Then, in this case, each foot mount 70 may be formed in a disk shape or may be formed to have an area sufficiently wider than the bottom surface of the foot of the operator P so that the foot can be easily grounded to the foot mount 70 regardless of the direction in the yaw direction of the foot of the operator P.

Further, in the above-described embodiments, a process of suppressing the direction in the yaw direction of the upper body support portion 65 (or the master base 53) from deviating from a predetermined reference direction may be omitted or a process of changing the tilt posture of the master base 53 may be omitted. Further, when the slave floor is a floor in which a change in height is relatively small, a process of suppressing the up-down direction position of the upper body support portion 65 from deviating from a predetermined up-down direction reference position may be omitted.

Further, in the first embodiment, the target upper body support portion motion and the target slave upper body motion are determined by the bilateral control on the upper body side are determined, but the target upper body support portion motion and the target slave upper body motion may be determined by using, for example, a formula in which all coefficients Ratio_fsb and Ratio_msb of the formulas (1a) and (1b) are zero. Further, for example, the target upper body support portion motion may be determined in response to the observed value of the actual upper body support portion reaction force and the target motion of the slave device 1 may be determined to satisfy a predetermined target relationship for the target upper body support portion motion.

Further, in the second embodiment and the third embodiment, a case is shown in which the lateral position of the upper body support portion 65 or the lateral position of the upper body of the operator P is used as the master side reference portion lateral position of the disclosure and the lateral position of the upper body 102 of the slave device 1 is employed as the slave side reference portion lateral position of the disclosure.

However, for example, an operator gravity center lateral position which is a lateral position of a center of gravity of the operator P may be employed as a master side reference portion lateral position and a slave gravity center lateral position which is a lateral position of a center of gravity of the slave device 101 may be employed as a slave side reference portion lateral position. Then, the movement of the master device 51 may be controlled in response to the observed value or the target value of the slave gravity center lateral position so that a relationship between the actual operator gravity center lateral position and the actual slave gravity center lateral position satisfies, for example, a relationship in the formulas (61a) and (61b).

In this case, for example, the actual slave gravity center lateral position can be estimated by the position posture (the position posture viewed in the slave side global coordinate system Cs) for any part such as the upper body 102 of the slave device 101 estimated by a known method such as a motion capture method, the observed value of the actual joint displacement of each joint of the slave device 101, and the rigid link model of the slave device 101. Further, the target value of the slave gravity center lateral position can be calculated by using, for example, the target motion of the entire slave device 1 including the target slave upper body motion and the target slave leg motion and the rigid link model of the slave device 1.

Further, for example, the actual operator gravity center lateral position can be estimated by using the observed values of the position posture (the position posture viewed in the master side global coordinate system Cgm) for any part such as the upper body of the operator P and the bending angle of each joint estimated by a known method such as a motion capture method and can be estimated by using the observed values of the estimated position posture and the estimated bending angle and the rigid link model of the operator P. Additionally, the bending angle of each joint or a part of the joints of the operator P may be detected by the displacement sensor or the inertia sensor (the acceleration sensor and the angular velocity sensor) attached to the operator P.

Further, the moving body (slave device) of the disclosure is not limited to an actual moving body and may be a virtual (imaginary) moving body.

According an embodiment, since the operations of the first actuator and the second actuator are controlled so that the lateral position of the foot mount on the free leg side follows the lateral position of the foot on the free leg side of the manipulator and the upper body support portion relatively moves in the lateral direction with respect to the foot mount on the support leg side together with the base in accordance with the movement of the upper body of the manipulator in the lateral direction with respect to the foot mount on the support leg side grounding the foot on the support leg side of the manipulator when the manipulator wearing the upper body support portion moves each foot to perform the walking operation of intermittently grounding each foot to the corresponding foot mount, the manipulator can perform the walking operation in the same manner as the normal walking operation.

In addition, since the operation of the first actuator is controlled to suppress the lateral position of the base or upper body support portion in the movement environment of the base from deviating from the predetermined lateral reference position, the base moves so that the lateral position of the base or the upper body support portion is not too far from the predetermined lateral reference position.

Then, the moving body (the slave device) is controlled to move in response to the movement of the upper body support portion with respect to the foot mount on the support leg side. Thus, according to an embodiment, the manipulator can smoothly perform the continuous walking operation so that the moving body can move in a wide range even when the environment (the movement environment of the base) for performing the manipulator's walking operation for moving the moving body is a relatively narrow environment.

In an embodiment, when the upper body support portion and the two foot mounts are mounted on the base to be tiltable together with the base and the master device further includes a third actuator capable of generating a driving force for tilting the base, the control device can be configured to further execute a C process. The C process determines an additional translation acceleration which is a lateral translation acceleration to be added to the upper body support portion so that a deviation between a lateral position of the base or the upper body support portion in the movement environment of the base and the predetermined lateral reference position approaches zero in response to the deviation when executing the A process, and the C process controls an operation of the third actuator so that a combined acceleration with an acceleration component generated in the base tilted direction in the additional translation acceleration and a gravity acceleration acting on the manipulator becomes zero or approaches zero.

Accordingly, since the lateral position deviation approaches zero, it is possible to prevent or suppress the manipulator from receiving a reaction force from the upper body support portion in response to the additional translation acceleration added to the motion of the upper body support portion. Further, the manipulator can perform the walking operation without sensibly recognizing the generation of the additional translation acceleration.

In an embodiment, when executing the A process, the control device can be configured to execute the A process by a process including an A1 process, an A2 process, an A3 process and an A4 process and an A5 process. The A1 process generates a target upper body support portion motion which is a target motion of the upper body support portion with respect to a virtual floor formed in a pseudo manner by the foot mount on the support leg side so that the upper body support portion moves with respect to the virtual floor together with the upper body of the manipulator. The A2 process is a process of determining a correction target upper body support portion motion which is a target motion of the upper body support portion in the movement environment of the base by correcting the target upper body support portion motion and includes at least a process of correcting the target upper body support portion motion so that the lateral position deviation corresponding to the deviation between the actual lateral position of the base or the upper body support portion in the movement environment of the base and the predetermined lateral reference position approaches zero in response to an observed value of the lateral position deviation. The A3 process controls the operation of the first actuator so that the base moves in response to the correction target upper body support portion motion. The A4 process is a process of determining a target foot mount motion which is a target motion of each of the two foot mounts with respect to the virtual floor and determines the target foot mount motion so that the foot mount on the support leg side stops with respect to the virtual floor and a target lateral position of the foot mount on the free leg side matches an actual lateral position of the foot on the free leg side of the manipulator. The A5 process controls the operation of the second actuator so that a relationship between an actual lateral position of the upper body support portion and an actual lateral position of each of the two foot bases matches a relationship defined by the target upper body support portion motion and the target foot mount motion.

Accordingly, it is possible to preferably operate the first actuator and the second actuator so that the lateral position of the foot mount on the free leg side follows the lateral position of the foot on the free leg side of the manipulator and the upper body support portion relatively moves in the lateral direction with respect to the foot mount on the support leg side together with the base in accordance with the movement of the upper body of the manipulator in the lateral direction with respect to the foot mount on the support leg side while suppressing the lateral position of the base or the upper body support portion in the movement environment of the base from deviating from the predetermined lateral reference position.

Additionally, in an embodiment, a process of determining the additional translation acceleration can be included in, for example, the A3 process.

In an embodiment, when the first actuator is an actuator configured to generate a driving force for allowing the base to move in a translation manner and rotate in a yaw direction, the control device can be configured to execute a process of controlling the operations of the first actuator and the second actuator so that the upper body support portion relatively rotates in the yaw direction with respect to the foot mount on the support leg side together with the base while suppressing a direction in the yaw direction of the base or the upper body support portion in the movement environment of the base from deviating from a predetermined reference direction in accordance with the rotation in the yaw direction of the upper body of the manipulator with respect to the foot mount on the support leg side when executing the A process.

Additionally, the yaw direction means the direction around the axis in the up-down direction (the vertical direction or the substantially vertical direction).

According to an embodiment, it is possible to prevent the direction in the yaw direction of the base or the upper body support portion in the movement environment of the base from largely changing from the predetermined reference direction even when the manipulator wearing the upper body support portion performs the walking operation to turn. Further, it is possible to smoothly perform the walking operation to turn the manipulator without any disturbance even when a change in the direction in the yaw direction of the base in limited due to wiring or the like connected to the master device. Further, it is possible to control the operation of the slave device so that the slave device turns in response to the turning operation of the manipulator.

In an embodiment, when executing the A process, the control device can be configured to execute the A process by a process including an A1 process, an A2 process, an A3 process and an A4 process and an A5 process. The A1 process generates a target upper body support portion motion which is a target motion of the upper body support portion with respect to a virtual floor formed in a pseudo manner by the foot mount on the support leg side so that the upper body support portion moves with respect to the virtual floor together with the upper body of the manipulator. The A2 process is a process of determining a correction target upper body support portion motion which is a target motion of the upper body support portion in the movement environment of the base by correcting the target upper body support portion motion and includes at least a process of correcting the target upper body support portion motion so that the lateral position deviation corresponding to the deviation between the actual lateral position of the base or the upper body support portion in the movement environment of the base and the predetermined lateral reference position and a yaw-direction direction deviation corresponding to the deviation between an actual direction in the yaw direction of the base or the upper body support portion in the movement environment of the base and the predetermined reference direction approach zero in response to observed values of the lateral position deviation and the yaw-direction direction deviation. The A3 process controls the operation of the first actuator so that the base moves in response to the correction target upper body support portion motion. The A4 process is a process of determining a target foot mount motion which is a target motion of each of the two foot mounts with respect to the virtual floor and determines the target foot mount motion so that the foot mount on the support leg side stops with respect to the virtual floor and a target lateral position of the foot mount on the free leg side matches the actual lateral position of the foot on the free leg side of the manipulator. The A5 process controls the operation of the second actuator so that a relationship between the actual lateral position of the upper body support portion and the actual lateral position of each of the two foot bases matches a relationship defined by the target upper body support portion motion and the target foot mount motion.

Accordingly, it is possible to preferably operate the first actuator and the second actuator so that the lateral position of the foot mount on the free leg side follows the lateral position of the foot on the free leg side of the manipulator and the upper body support portion relatively moves in the lateral direction with respect to the foot mount on the support leg side together with the base in accordance with the movement of the upper body of the manipulator in the lateral direction with respect to the foot mount on the support leg side while suppressing the lateral position of the base or the upper body support portion in the movement environment of the base from deviating from the predetermined lateral reference position and suppressing the direction in the yaw direction of the base or the upper body support portion in the movement environment of the base from deviating from the predetermined reference direction.

In an embodiment, each of the two foot mounts is further mounted on the base to be rotatable in the yaw direction with respect to the base and the second actuator can be configured to further generate a driving force for rotating each foot mount in the yaw direction with respect to the base. In this case, the control device can be configured to further execute a process of controlling the operation of the second actuator so that a direction in the yaw direction of the foot mount on the free leg side with respect to the foot mount on the support leg side follows a direction in the yaw direction of the foot on the free leg side of the manipulator with respect to the foot mount on the support leg side when executing the A process.

Accordingly, when the manipulator wearing the upper body support portion appropriately changes the direction in the yaw direction of the foot on the free leg side with respect to the foot mount on the support leg side for grounding the foot on the support leg side, the direction in the yaw direction of the foot mount on the free leg side changes in accordance with the change. Thus, in any one of the right and left feet of the manipulator, the foot on the free leg side can be easily grounded to the foot mount on the free leg side.

In an embodiment, wherein when executing the A process, the control device can be configured to execute the A process by a process including an A1 process, an A2 process, an A3 process and an A4 process and an A5 process. The A1 process generates a target upper body support portion motion which is a target motion of the upper body support portion with respect to a virtual floor formed in a pseudo manner by the foot mount on the support leg side so that the upper body support portion moves with respect to the virtual floor together with the upper body of the manipulator. The A2 process is a process of determining a correction target upper body support portion motion which is a target motion of the upper body support portion in the movement environment of the base by correcting the target upper body support portion motion and includes at least a process of correcting the target upper body support portion motion so that the lateral position deviation corresponding to the deviation between the actual lateral position of the base or the upper body support portion in the movement environment of the base and the predetermined lateral reference position approaches zero in response to an observed value of the lateral position deviation. The A3 process controls the operation of the first actuator so that the base moves in response to the correction target upper body support portion motion. The A4 process is a process of determining a target foot mount motion which is a target motion of each of the two foot mounts with respect to the virtual floor and determines the target foot mount motion so that the foot mount on the support leg side stops with respect to the virtual floor and a target lateral position and a target yaw-direction direction of the foot mount on the free leg side respectively match an actual lateral position and an actual yaw-direction direction of the foot on the free leg side of the manipulator. The A5 process controls the operation of the second actuator so that each of a relationship between the actual lateral position of the upper body support portion and the actual lateral position of each of the two foot bases and a relationship between the actual yaw-direction direction of the upper body support portion and the actual yaw-direction direction of each of the two foot bases matches a relationship defined by the target upper body support portion motion and the target foot mount motion.

Accordingly, it is possible to preferably operate the first actuator and the second actuator so that the lateral position of the foot mount on the free leg side and the direction in the yaw direction thereof respectively follow the lateral position of the foot on the free leg side of the manipulator and the direction in the yaw direction thereof and the upper body support portion relatively moves in the lateral direction with respect to the foot mount on the support leg side together with the base in accordance with the movement of the upper body of the manipulator in the lateral direction with respect to the foot mount on the support leg side while suppressing at least the lateral position of the base or the upper body support portion in the movement environment of the base from deviating from the predetermined lateral reference position.

In an embodiment, each of the two foot mounts is further mounted on the base to be tiltable with respect to the base and the second actuator can be configured to further generate a driving force for tilting each of the two foot mounts with respect to the base. In this case, the control device can be configured to further execute a D process that controls the operation of the second actuator so that a tilt posture of each of the foot mounts changes in response to an actual floor surface shape of a movement environment of a slave device.

Accordingly, the manipulator can sensibly and easily recognize the floor shape of the movement environment of the slave device by the tilt posture of the foot mount grounding the foot. Further, the walking operation can be performed in the master device in a manner that matches the floor shape of the movement environment of the slave device.

In an embodiment, when the slave device is a leg type moving body which includes an upper body and a pair of two left and right legs extending from the upper body, the control device can be configured to control the operation of the second actuator so that the tilt posture of the foot mount corresponding to a left foot of the manipulator changes in response to a floor surface shape below a front end portion of a left leg of the slave device and the tilt posture of the foot mount corresponding to a right foot of the manipulator changes in response to a floor surface shape below a front end portion of a right leg of the slave device when executing the D process.

Accordingly, the manipulator can easily and sensibly recognize a local floor shape (tilted state) below the front end portion of the leg for each leg of the slave device by the tilt posture of the foot mount for grounding the foot of the corresponding manipulator to the leg.

In an embodiment, when executing the A process, the control device can be configured to execute the A process by a process including an A1 process, an A2 process, an A3 process and an A4 process and an A5 process. The A1 process generates a target upper body support portion motion which is a target motion of the upper body support portion with respect to a virtual floor formed in a pseudo manner by the foot mount on the support leg side so that the upper body support portion moves with respect to the virtual floor together with the upper body of the manipulator. The A2 process is a process of determining a correction target upper body support portion motion which is a target motion of the upper body support portion in the movement environment of the base by correcting the target upper body support portion motion and includes at least a process of correcting the target upper body support portion motion so that the lateral position deviation corresponding to the deviation between the actual lateral position of the base or the upper body support portion in the movement environment of the base and the predetermined lateral reference position approaches zero in response to an observed value of the lateral position deviation. The A3 process controls the operation of the first actuator so that the base moves in response to the correction target upper body support portion motion. The A4 process is a process of determining a target foot mount motion which is a target motion of each of the two foot mounts with respect to the virtual floor and determines the target foot mount motion so that the foot mount on the support leg side stops with respect to the virtual floor, the target lateral position of the foot mount on the free leg side matches the actual lateral position of the foot on the free leg side of the manipulator, and a target tilt posture of each of the two foot mounts matches a tilt posture set in response to a floor shape of the movement environment of the slave device. The A5 process controls the operation of the second actuator so that a relationship between the actual lateral position of the upper body support portion and the actual lateral position of each of the two foot bases matches a relationship defined by the target upper body support portion motion and the target foot mount motion and an actual tilt posture of each of the two foot mounts matches a target tilt posture defined by the target motion of the target foot mount.

Accordingly, it is possible to preferably operate the first actuator and the second actuator so that the lateral position of the foot mount on the free leg side follows the lateral position of the foot on the free leg side of the manipulator and the upper body support portion relatively moves in the lateral direction with respect to the foot mount on the support leg side together with the base in accordance with the movement of the upper body of the manipulator in the lateral direction with respect to the foot mount on the support leg side while suppressing the lateral position of the base or the upper body support portion in the movement environment of the base from deviating from the predetermined lateral reference position and changing the tilt posture of each foot mount in response to the floor shape of the movement environment of the slave device.

In an embodiment, each of the two foot mounts is further mounted on the base to be movable up and down with respect to the base and the second actuator can be configured to further generate a driving force for moving each foot mount up and down with respect to the base. In this case, the control device can be configured to further execute an E process that controls the operation of the second actuator so that a difference between up-down direction positions of the two foot mounts changes in response to the actual floor surface shape of the movement environment of each slave device.

Accordingly, the manipulator can easily and sensibly recognize the floor shape of the movement environment of the slave device by a difference between the up-down direction positions of both foot mounts when the left and right feet are respectively grounded to the corresponding foot mounts. For example, the manipulator can recognize whether the floor of the movement environment of the slave device has a step. Further, the walking operation can be performed in the master device in a manner that matches the floor shape of the movement environment of the slave device.

In an embodiment, when the slave device is a leg type moving body which includes an upper body and a pair of two left and right legs extending from the upper body, the control device can be configured to control the operation of the second actuator so that a difference between the up-down direction position of the foot mount corresponding to the left foot of the manipulator and the up-down direction position of the foot mount corresponding to the right foot of the manipulator changes in response to a difference between an up-down direction position of the floor surface below the front end portion of the left leg of the slave device and an up-down direction position of the floor surface below the front end portion of the right leg of the slave device when executing the E process.

Accordingly, the manipulator can easily and sensibly recognize a local floor shape (tilted state) below the front end portion of the leg for each leg and a difference between the up-down walking position of the floor surface below the left leg of the slave device and the up-down walking position of the floor surface below the left leg of the manipulator corresponding to the leg of the slave device by the difference between the up-down direction position of the foot mount for grounding the left foot of the manipulator and the up-down direction position of the foot mount for grounding the right foot.

In an embodiment, the upper body support portion is further mounted on the base to be movable up and down with respect to the two foot mounts together with the base and the master device can further include a fourth actuator capable of generating a driving force for moving the upper body support portion up and down. In this case, when executing the A process, the control device can be configured to further execute an F process that controls the operations of the second actuator and the fourth actuator so that the upper body support portion relatively moves with respect to the foot mount on the support leg side while suppressing an up-down direction position of the upper body support portion in the movement environment of the base from deviating from a predetermined up-down direction reference position in accordance with the upward and downward movement of the upper body of the manipulator with respect to the foot mount on the support leg side.

Accordingly, the manipulator can continuously perform the walking operation in a manner of going up and down a step, a staircase, or a slope so that the up-down direction position of the upper body support portion in the movement environment of the base does not greatly deviate from a predetermined up-down direction reference position. Further, the operation of the slave device can be controlled so that the slave device performs an operation of going up and down a step, a staircase, or a slope existing in the movement environment of the slave device.

In an embodiment, when executing the A process, the control device can be configured to execute the A process by a process including an A1 process, an A2 process, an A3 process and an A4 process and an A5 process. The A1 process generates a target upper body support portion motion which is a target motion of the upper body support portion with respect to a virtual floor formed in a pseudo manner by the foot mount on the support leg side so that the upper body support portion moves with respect to the virtual floor together with the upper body of the manipulator. The A2 process is a process of determining a correction target upper body support portion motion which is a target motion of the upper body support portion in the movement environment of the base by correcting the target upper body support portion motion and includes at least a process of correcting the target upper body support portion motion so that the lateral position deviation corresponding to the deviation between the actual lateral position of the base or the upper body support portion in the movement environment of the base and the predetermined lateral reference position and an up-down direction position deviation corresponding to a deviation between an actual up-down direction position of the upper body support portion in the movement environment of the base and the predetermined up-down direction reference position respectively approach zero in response to observed values of the lateral position deviation and the up-down direction position deviation. The A3 process controls the operations of the first actuator and the fourth actuator so that the upper body support portion moves in response to the correction target upper body support portion motion. The A4 process is a process of determining a target foot mount motion which is a target motion of each of the two foot mounts with respect to the virtual floor and determines the target foot mount motion so that the foot mount on the support leg side stops with respect to the virtual floor, the target lateral position of the foot mount on the free leg side matches the actual lateral position of the foot on the free leg side of the manipulator, and a difference between the target up-down direction positions of the two foot mounts matches an up-down direction position difference set in response to a floor shape of the movement environment of the slave device. The A5 process controls the operation of the second actuator so that each of a relationship between the actual lateral position of the upper body support portion and the actual lateral position of each of the two foot bases and a relationship between an actual up-down direction position of the upper body support portion and an actual up-down direction position of each of the two foot bases matches a relationship defined by the target upper body support portion motion and the target foot mount motion.

Accordingly, it is possible to preferably operate the first actuator, the second actuator, and the fourth actuator so that the lateral position of the foot mount on the free leg side follows the lateral position of the foot on the free leg side of the manipulator and the upper body support portion relatively moves in the lateral direction with respect to the foot mount on the support leg side together with the base in accordance with the movement of the upper body of the manipulator in the lateral direction with respect to the foot mount on the support leg side while suppressing the lateral position of the base or the upper body support portion in the movement environment of the base and the up-down direction position of the upper body support portion from respectively deviating from the predetermined lateral reference position and the up-down direction reference position and changing a difference between the up-down direction positions of two foot mounts in response to the floor shape of the movement environment of the slave device.

Additionally, the A2 process, the A3 process, the A4 process, and the A5 process of an embodiment are processes respectively included in the A2 process, the A3 process, the A4 process, and the A5 process of another embodiment.

In an embodiment, when the slave device is a leg type moving body which includes an upper body and two legs extending from the upper body, the control device includes: an operation target determination unit which determines a slave side operation target including a target slave leg motion corresponding to a target motion of each leg of the slave device and a target slave upper body motion corresponding to a target motion of the upper body of the slave device and a target upper body support portion motion corresponding to a target motion of the upper body support portion with respect to the virtual floor formed in a pseudo manner by the foot mount on the support leg side of the master device when the manipulator wearing the upper body support portion performs the walking operation.

And the control device includes: a master side control unit which determines a correction target upper body support portion motion corresponding to a target motion of the upper body support portion in the movement environment of the base by correcting the target upper body support portion motion by a process including at least an operation of correcting the target upper body support portion motion so that the lateral position deviation corresponding to the deviation between the actual lateral position of the base or the upper body support portion in the movement environment of the base and the predetermined lateral reference position approaches zero in response to an observed value of the lateral position deviation, controls the operation of the first actuator so that the base moves in response to the correction target upper body support portion motion, determines a target foot mount motion corresponding to a target motion of each of the foot mounts in response to an observed value of a motion state of at least each foot of the manipulator, and controls the operation of the second actuator in response to the target foot mount motion, and a slave side control unit which controls the operation of the slave device in response to the determined slave side operation target. When a lateral position of any one of the upper body support portion, the upper body of the manipulator, and the center of gravity of the manipulator is defined as a master side reference portion lateral position and a lateral position of any one of the upper body and the center of gravity of the slave device is defined as a slave side reference portion lateral position, the operation target determination unit can be configured to have a function of executing a first process and a second process. The first process determines the target slave leg motion by using at least an observed value of a motion state of each foot of the manipulator with respect to the virtual floor formed in a pseudo manner by the foot mount on the support leg side. The second process determines the target slave upper body motion and the target upper body support portion motion by using an observed value of each of the master side reference portion lateral position and the slave side reference portion lateral position with respect to the virtual floor so that a relationship between the actual slave side reference portion lateral position and the master side reference portion lateral position with respect to the virtual floor close to satisfy a predetermined target corresponding relationship and a target value of the slave side reference portion lateral position defined by the slave side operation target matches or approaches the actual slave side reference portion lateral position.

Additionally, in the present specification, an “observed value” of an arbitrary state quantity such as a motion or a force of an arbitrary object means a detection value of a state quantity that is detected by an appropriate detector or sensor, an estimation value that is estimated based on a correlated relationship from detection values of one or more other state quantities having a certain correlated relationship with the state quantity, or a pseudo-estimation value that can be considered to match or almost match an actual value of the state quantity.

Further, in an embodiment, a process of determining the target upper body support portion motion in the process of the operation target determination unit corresponds to the Al process, a process of determining the correction target upper body support portion motion in the process of the master side control unit corresponds to the A2 process, and a process of determining the target foot mount motion corresponds to the A4 process.

According to an embodiment, when the manipulator wearing the upper body support portion performs the walking operation, the target slave leg motion in the slave side operation target is determined so that the slave device moves by the motion of the leg in accordance with the walking operation.

Further, in the slave side operation target, the target slave upper body motion and the target upper body support portion motion with respect to the virtual floor are determined so that a relationship between the actual slave side reference portion lateral position and the master side reference portion lateral position with respect to the virtual floor almost satisfies a predetermined target corresponding relationship and the target value of the slave side reference portion lateral position defined by the slave side operation target matches or approaches the actual slave side reference portion lateral position.

Additionally, as the target corresponding relationship, for example, a relationship in which the master side reference portion lateral position and the slave side reference portion lateral position match each other, a relationship in which one of these is proportional to the other of these, or a relationship in which one of these is represented by a linear function of the other of these can be employed.

Then, the operation of the slave device is controlled in response to the slave side operation target including the target slave leg motion and the target slave upper body motion described as described above.

Further, the operation of the first actuator is controlled in response to the correction target upper body support portion motion obtained by correcting the target upper body support portion motion determined as described above so that at least the lateral position deviation approaches zero and the operation of the second actuator is controlled in response to the target foot mount motion determined in response to at least the observed value of the motion state of each foot of the manipulator.

In this case, the slave device basically moves by the walking operation in a manner of following the walking operation of the manipulator. However, even when the manipulator performs the walking operation in a normal posture without collapsing the posture, the posture of the slave device may be changed in some cases due to the influence of disturbance such as the unevenness of the floor surface in the movement environment of the slave device or the contact between the slave device and the obstacle. Further, in some cases, the actual slave side reference portion lateral position may deviate from the master side reference portion lateral position with respect to the virtual floor so that the target corresponding relationship cannot be satisfied.

At this time, the target slave upper body motion is determined so that the target value of the slave side reference portion lateral position matches or approaches the actual slave side reference portion lateral position regardless of the lateral position of the upper body of the manipulator or the upper body support portion with respect to the virtual floor. On the other hand, the target upper body support portion motion is determined so that a relationship between the actual slave side reference portion lateral position and the master side reference portion lateral position with respect to the virtual floor approaches the target corresponding relationship.

For this reason, when the posture of the slave device is collapsed, the operation of the master device can be controlled so that a lateral translational force that attempts to displace the master side reference portion lateral position with respect to the virtual floor toward a position that satisfies a target relationship with respect to the actual slave side reference portion lateral position of the slave device having a collapsed posture is applied from the upper body support portion to the manipulator.

For this reason, when the posture of the slave device is collapsed during the movement of the slave device in accordance with the walking operation of the manipulator, the manipulator receives a lateral translational force that attempts its posture from the upper body support portion to the upper body. Accordingly, the manipulator can appropriately and promptly recognize the collapsed posture of the slave device or the posture collapsing direction of the slave device. Thus, according to an embodiment, when the posture of the slave device (the moving body) is collapsed, the manipulator can promptly and appropriately recognize that collapsing state.

Supplementally, as a process of the first processing unit for determining the target slave leg motion, it is possible to employ, for example, a process of determining the target position of the front end portion of each leg of the slave device in response to the observed value of the position of the foot of the leg of the manipulator with respect to the virtual floor so that a relationship between the position of the foot of each leg of the manipulator with respect to the virtual floor and the position of the front end portion of each leg of the slave device (the leg corresponding to the leg of the manipulator) satisfies a target corresponding relationship such as a target corresponding relationship between the master side reference portion lateral position and the slave side reference portion lateral position.

Regarding the posture of the front end portion of each leg of the slave device in the target slave leg motion, it is possible to employ, for example, a process of determining the target posture of the front end portion of each leg of the slave device in response to the observed value of the posture of the foot of the leg of the manipulator with respect to the virtual floor so that a relationship between the posture of the foot of each leg of the manipulator with respect to the virtual floor and the posture of the front end portion of each leg of the slave device (the leg corresponding to the leg of the manipulator) satisfies a predetermined target corresponding relationship.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents

What is claimed is:

1. A moving body manipulation system capable of manipulating a slave device which is a moving body to move, the moving body manipulation system comprising:
a master device which comprises a base movable on a floor surface, a first actuator capable of generating a driving force for moving the base on the floor surface, an upper body support portion mounted on the base to be movable together with the base and attachable to an upper body of a manipulator, two foot mounts mounted on the base to be movable in a lateral direction with respect to the base and capable of grounding two feet of the manipulator wearing the upper body support portion, and a second actuator capable of generating a driving force for moving each of the two foot mounts with respect to the base in the lateral direction; and
a control device which has a function of controlling operations of the slave device and the master device,
wherein the control device is configured to comprise a function of executing an A process and a B process,
the A process controls operations of the first actuator and the second actuator so that when the manipulator wearing the upper body support portion moves each foot to perform a walking operation of intermittently grounding each foot to a corresponding foot mount, a lateral position of the foot mount on a free leg side which is the foot mount corresponding to the foot on a free leg side of the manipulator follows a lateral position of the foot on the free leg side of the manipulator, and the upper body support portion relatively moves in the lateral direction with respect to the foot mount on a support leg side together with the base while suppressing a lateral position of the base or the upper body support portion in a movement environment of the base from deviating from a predetermined lateral reference position in accordance with a movement of the upper body of the manipulator in the lateral direction with respect to the foot mount on the support leg side which is the foot mount for grounding the foot on a support leg side of the manipulator,
the B process controls an operation of the slave device so that the slave device moves in response to a movement of the upper body support portion with respect to the foot mount on the support leg side.

2. The moving body manipulation system according to claim 1,
wherein the upper body support portion and the two foot mounts are mounted on the base to be tiltable together with the base and the master device further comprises a third actuator capable of generating a driving force for tilting the base, and
wherein the control device is configured to further execute a C process,
the C process determines an additional translation acceleration which is a lateral translation acceleration to be added to the upper body support portion so that a lateral position deviation corresponding to a deviation between the lateral position of the base or the upper body support portion in the movement environment of the base and a predetermined lateral reference position approaches zero in response to the lateral position deviation when executing the A process, and the C process controls an operation of the third actuator so that a combined acceleration with an acceleration component generated in a base tilted direction in the additional translation acceleration and a gravity acceleration acting on the manipulator becomes zero or approaches zero.

3. The moving body manipulation system according to claim 1,
wherein when executing the A process, the control device is configured to execute the A process by a process comprising an A1 process, an A2 process, an A3 process and an A4 process and an A5 process,
the A1 process generates a target upper body support portion motion which is a target motion of the upper body support portion with respect to a virtual floor formed in a pseudo manner by the foot mount on the support leg side so that the upper body support portion moves with respect to the virtual floor together with the upper body of the manipulator,
the A2 process is a process of determining a correction target upper body support portion motion which is a target motion of the upper body support portion in the movement environment of the base by correcting the target upper body support portion motion and comprises at least a process of correcting the target upper body support portion motion so that the lateral position deviation corresponding to the deviation between an actual lateral position of the base or the upper body support portion in the movement environment of the base and the predetermined lateral reference position approaches zero in response to an observed value of the lateral position deviation,
the A3 process controls the operation of the first actuator so that the base moves in response to the correction target upper body support portion motion,
the A4 process is a process of determining a target foot mount motion which is a target motion of each of the two foot mounts with respect to the virtual floor and determines the target foot mount motion so that the foot mount on the support leg side stops with respect to the virtual floor and a target lateral position of the foot mount on the free leg side matches an actual lateral position of the foot on the free leg side of the manipulator, and
the A5 process controls the operation of the second actuator so that a relationship between an actual lateral position of the upper body support portion and an actual lateral position of each of the two foot bases matches a relationship defined by the target upper body support portion motion and the target foot mount motion.

4. The moving body manipulation system according to claim 2,
wherein when executing the A process, the control device is configured to execute the A process by a process comprising an A1 process, an A2 process, an A3 process and an A4 process and an A5 process,
the A1 process generates a target upper body support portion motion which is a target motion of the upper body support portion with respect to a virtual floor formed in a pseudo manner by the foot mount on the support leg side so that the upper body support portion moves with respect to the virtual floor together with the upper body of the manipulator,
the A2 process is a process of determining a correction target upper body support portion motion which is a target motion of the upper body support portion in the movement environment of the base by correcting the target upper body support portion motion and comprises at least a process of correcting the target upper body support portion motion so that the lateral position deviation corresponding to the deviation between an actual lateral position of the base or the upper body support portion in the movement environment of the base and the predetermined lateral reference position approaches zero in response to an observed value of the lateral position deviation,
the A3 process controls the operation of the first actuator so that the base moves in response to the correction target upper body support portion motion,
the A4 process is a process of determining a target foot mount motion which is a target motion of each of the two foot mounts with respect to the virtual floor and determines the target foot mount motion so that the foot mount on the support leg side stops with respect to the virtual floor and a target lateral position of the foot mount on the free leg side matches an actual lateral position of the foot on the free leg side of the manipulator, and
the A5 process controls the operation of the second actuator so that a relationship between an actual lateral position of the upper body support portion and an actual lateral position of each of the two foot bases matches a relationship defined by the target upper body support portion motion and the target foot mount motion.

5. The moving body manipulation system according to claim 1,
wherein the first actuator is an actuator configured to generate a driving force for allowing the base to move in a translation manner and rotate in a yaw direction, and
wherein when executing the A process, the control device is configured to further execute a process of controlling the operations of the first actuator and the second actuator so that the upper body support portion relatively rotates in the yaw direction with respect to the foot mount on the support leg side together with the base while suppressing a direction in the yaw direction of the base or the upper body support portion in the movement environment of the base from deviating from a predetermined reference direction in accordance with the rotation in the yaw direction of the upper body of the manipulator with respect to the foot mount on the support leg side.

6. The moving body manipulation system according to claim 2,
wherein the first actuator is an actuator configured to generate a driving force for allowing the base to move in a translation manner and rotate in a yaw direction, and
wherein when executing the A process, the control device is configured to further execute a process of controlling the operations of the first actuator and the second actuator so that the upper body support portion relatively rotates in the yaw direction with respect to the foot mount on the support leg side together with the base while suppressing a direction in the yaw direction of the base or the upper body support portion in the movement environment of the base from deviating from a predetermined reference direction in accordance with the rotation in the yaw direction of the upper body of the manipulator with respect to the foot mount on the support leg side.

7. The moving body manipulation system according to claim 3,
wherein the first actuator is an actuator configured to generate a driving force for allowing the base to move in a translation manner and rotate in a yaw direction, and
wherein when executing the A process, the control device is configured to further execute a process of controlling the operations of the first actuator and the second actuator so that the upper body support portion relatively rotates in the yaw direction with respect to the foot mount on the support leg side together with the base while suppressing a direction in the yaw direction of the base or the upper body support portion in the movement environment of the base from deviating from a predetermined reference direction in accordance with the rotation in the yaw direction of the upper body of the manipulator with respect to the foot mount on the support leg side.

8. The moving body manipulation system according to claim 5,
wherein when executing the A process, the control device is configured to execute the A process by a process comprising an A1 process, an A2 process, an A3 process and an A4 process and an A5 process,
the A1 process generates a target upper body support portion motion which is a target motion of the upper body support portion with respect to a virtual floor formed in a pseudo manner by the foot mount on the support leg side so that the upper body support portion moves with respect to the virtual floor together with the upper body of the manipulator,
the A2 process is a process of determining a correction target upper body support portion motion which is a target motion of the upper body support portion in the movement environment of the base by correcting the target upper body support portion motion and comprises at least a process of correcting the target upper body support portion motion so that the lateral position deviation corresponding to the deviation between an actual lateral position of the base or the upper body support portion in the movement environment of the base and the predetermined lateral reference position and a yaw-direction direction deviation corresponding to the deviation between an actual direction in the yaw direction of the base or the upper body support portion in the movement environment of the base and the predetermined reference direction approach zero in response to observed values of the lateral position deviation and the yaw-direction direction deviation,
the A3 process controls the operation of the first actuator so that the base moves in response to the correction target upper body support portion motion,
the A4 process is a process of determining a target foot mount motion which is a target motion of each of the two foot mounts with respect to the virtual floor and determines the target foot mount motion so that the foot mount on the support leg side stops with respect to the virtual floor and a target lateral position of the foot mount on the free leg side matches an actual lateral position of the foot on the free leg side of the manipulator, and
the A5 process controls the operation of the second actuator so that a relationship between an actual lateral position of the upper body support portion and an actual lateral position of each of the two foot bases matches a relationship defined by the target upper body support portion motion and the target foot mount motion.

9. The moving body manipulation system according to claim 1,
wherein each of the two foot mounts is further mounted on the base to be rotatable in the yaw direction with respect to the base, the second actuator is configured to further generate a driving force for rotating each of the foot mounts in the yaw direction with respect to the base, and the control device is configured to further execute a process of controlling the operation of the second actuator so that a direction in the yaw direction of the foot mount on the free leg side with respect to the foot mount on the support leg side follows a direction in the yaw direction of the foot on the free leg side of the manipulator with respect to the foot mount on the support leg side when executing the A process.

10. The moving body manipulation system according to claim 2,
wherein each of the two foot mounts is further mounted on the base to be rotatable in the yaw direction with respect to the base, the second actuator is configured to further generate a driving force for rotating each of the foot mounts in the yaw direction with respect to the base, and the control device is configured to further execute a process of controlling the operation of the second actuator so that a direction in the yaw direction of the foot mount on the free leg side with respect to the foot mount on the support leg side follows a direction in the yaw direction of the foot on the free leg side of the manipulator with respect to the foot mount on the support leg side when executing the A process.

11. The moving body manipulation system according to claim 3,
wherein each of the two foot mounts is further mounted on the base to be rotatable in the yaw direction with respect to the base, the second actuator is configured to further generate a driving force for rotating each of the foot mounts in the yaw direction with respect to the base, and the control device is configured to further execute a process of controlling the operation of the second actuator so that a direction in the yaw direction of the foot mount on the free leg side with respect to the foot mount on the support leg side follows a direction in the yaw direction of the foot on the free leg side of the manipulator with respect to the foot mount on the support leg side when executing the A process.

12. The moving body manipulation system according to claim 9,
wherein when executing the A process, the control device is configured to execute the A process by a process comprising an A1 process, an A2 process, an A3 process and an A4 process and an A5 process,
the A1 process generates a target upper body support portion motion which is a target motion of the upper body support portion with respect to a virtual floor formed in a pseudo manner by the foot mount on the support leg side so that the upper body support portion moves with respect to the virtual floor together with the upper body of the manipulator,
the A2 process is a process of determining a correction target upper body support portion motion which is a target motion of the upper body support portion in the movement environment of the base by correcting the target upper body support portion motion and comprises at least a process of correcting the target upper body support portion motion so that the lateral position deviation corresponding to the deviation between an actual lateral position of the base or the upper body support portion in the movement environment of the base and the predetermined lateral reference position approaches zero in response to an observed value of the lateral position deviation,
the A3 process controls the operation of the first actuator so that the base moves in response to the correction target upper body support portion motion,
the A4 process is a process of determining a target foot mount motion which is a target motion of each of the two foot mounts with respect to the virtual floor and determines the target foot mount motion so that the foot mount on the support leg side stops with respect to the virtual floor and a target lateral position and a target yaw-direction direction of the foot mount on the free leg side respectively match an actual lateral position and an actual yaw-direction direction of the foot on the free leg side of the manipulator, and
the A5 process controls the operation of the second actuator so that each of a relationship between an actual lateral position of the upper body support portion and an actual lateral position of each of the two foot bases and a relationship between the actual yaw-direction direction of the upper body support portion and the actual yaw-direction direction of each of the two foot bases matches a relationship defined by the target upper body support portion motion and the target foot mount motion.

13. The moving body manipulation system according to claim 1,
wherein each of the two foot mounts is further mounted on the base to be tiltable with respect to the base and the second actuator is configured to further generate a driving force for tilting each of the two foot mounts with respect to the base, and
wherein the control device is configured to further execute a D process that controls the operation of the second actuator so that a tilt posture of each of the foot mounts changes in response to an actual floor surface shape of a movement environment of the slave device.

14. The moving body manipulation system according to claim 13,
wherein the slave device is a leg type moving body which comprises an upper body and a pair of two left and right legs extending from the upper body, and
wherein the control device is configured to control the operation of the second actuator so that the tilt posture of the foot mount corresponding to a left foot of the manipulator changes in response to a floor surface shape below a front end portion of a left leg of the slave device and the tilt posture of the foot mount corresponding to a right foot of the manipulator changes in response to a floor surface shape below a front end portion of a right leg of the slave device when executing the D process.

15. The moving body manipulation system according to claim 13,
wherein when executing the A process, the control device is configured to execute the A process by a process comprising an A1 process, an A2 process, an A3 process and an A4 process and an A5 process,
the A1 process generates a target upper body support portion motion which is a target motion of the upper body support portion with respect to a virtual floor formed in a pseudo manner by the foot mount on the support leg side so that the upper body support portion moves with respect to the virtual floor together with the upper body of the manipulator,
the A2 process is a process of determining a correction target upper body support portion motion which is a target motion of the upper body support portion in the movement environment of the base by correcting the target upper body support portion motion and comprises at least a process of correcting the target upper body support portion motion so that the lateral position deviation corresponding to the deviation between an actual lateral position of the base or the upper body support portion in the movement environment of the base and the predetermined lateral reference position approaches zero in response to an observed value of the lateral position deviation,
the A3 process controls the operation of the first actuator so that the base moves in response to the correction target upper body support portion motion,
the A4 process is a process of determining a target foot mount motion which is a target motion of each of the two foot mounts with respect to the virtual floor and determines the target foot mount motion so that the foot mount on the support leg side stops with respect to the virtual floor, the target lateral position of the foot mount on the free leg side matches an actual lateral position of the foot on the free leg side of the manipulator, and a target tilt posture of each of the two foot mounts matches a tilt posture set in response to a floor shape of the movement environment of the slave device, and
the A5 process controls the operation of the second actuator so that a relationship between an actual lateral position of the upper body support portion and an actual lateral position of each of the two foot bases matches a relationship defined by the target upper body support portion motion and the target foot mount motion and an actual tilt posture of each of the two foot mounts matches a target tilt posture defined by the target motion of the target foot mount.

16. The moving body manipulation system according to claim 1,
wherein each of the two foot mounts is further mounted on the base to be movable up and down with respect to the base and the second actuator is configured to further generate a driving force for moving each foot mount up and down with respect to the base, and
wherein the control device is configured to further execute an E process that controls the operation of the second actuator so that a difference between up-down direction positions of the two foot mounts changes in response to the actual floor surface shape of the movement environment of each slave device.

17. The moving body manipulation system according to claim 16,
wherein the slave device is a leg type moving body which comprises an upper body and a pair of two left and right legs extending from the upper body, and
wherein when executing the E process, the control device is configured to control the operation of the second actuator so that a difference between the up-down direction position of the foot mount corresponding to a left foot of the manipulator and the up-down direction position of the foot mount corresponding to a right foot of the manipulator changes in response to a difference between an up-down direction position of the floor surface below the front end portion of the left leg of the slave device and an up-down direction position of the floor surface below the front end portion of the right leg of the slave device.

18. The moving body manipulation system according to claim 16,
wherein the upper body support portion is further mounted on the base to be movable up and down with respect to the two foot mounts together with the base and the master device further comprises a fourth actuator capable of generating a driving force for moving the upper body support portion up and down, and
wherein when executing the A process, the control device is configured to further execute an F process that controls the operations of the second actuator and the fourth actuator so that the upper body support portion relatively moves up and down with respect to the foot mount on the support leg side while suppressing an up-down direction position of the upper body support portion in the movement environment of the base from deviating from a predetermined up-down direction reference position in accordance with the upward and downward movement of the upper body of the manipulator with respect to the foot mount on the support leg side.

19. The moving body manipulation system according to claim 18,
wherein when executing the A process, the control device is configured to execute the A process by a process comprising an A1 process, an A2 process, an A3 process and an A4 process and an A5 process,
the A1 process generates a target upper body support portion motion which is a target motion of the upper body support portion with respect to a virtual floor formed in a pseudo manner by the foot mount on the support leg side so that the upper body support portion moves with respect to the virtual floor together with the upper body of the manipulator,
the A2 process is a process of determining a correction target upper body support portion motion which is a target motion of the upper body support portion in the movement environment of the base by correcting the target upper body support portion motion and comprises at least a process of correcting the target upper body support portion motion so that the lateral position deviation corresponding to the deviation between an actual lateral position of the base or the upper body support portion in the movement environment of the base and the predetermined lateral reference position and an up-down direction position deviation corresponding to a deviation between an actual up-down direction position of the upper body support portion in the movement environment of the base and a predetermined up-down direction reference position respectively approach zero in response to observed values of the lateral position deviation and the up-down direction position deviation,
the A3 process controls the operations of the first actuator and the fourth actuator so that the upper body support portion moves in response to the correction target upper body support portion motion,
the A4 process is a process of determining a target foot mount motion which is a target motion of each of the two foot mounts with respect to the virtual floor and determines the target foot mount motion so that the foot mount on the support leg side stops with respect to the virtual floor, the target lateral position of the foot mount on the free leg side matches an actual lateral position of the foot on the free leg side of the manipulator, and a difference between the target up-down direction positions of the two foot mounts matches an up-down direction position difference set in response to a floor shape of the movement environment of the slave device, and
the A5 process controls the operation of the second actuator so that each of a relationship between an actual lateral position of the upper body support portion and an actual lateral position of each of the two foot bases and a relationship between an actual up-down direction position of the upper body support portion and an actual up-down direction position of each of the two foot bases matches a relationship defined by the target upper body support portion motion and the target foot mount motion.

20. The moving body manipulation system according to claim 1,
wherein the slave device is a leg type moving body which comprises an upper body and two legs extending from the upper body, and
wherein the control device comprises:
an operation target determination unit which determines a slave side operation target comprising a target slave leg motion corresponding to a target motion of each leg of the slave device and a target slave upper body motion corresponding to a target motion of the upper body of the slave device and a target upper body support portion motion corresponding to a target motion of the upper body support portion with respect to the virtual floor formed in a pseudo manner by the foot mount on the support leg side of the master device when the manipulator wearing the upper body support portion performs the walking operation,
a master side control unit which determines a correction target upper body support portion motion corresponding to a target motion of the upper body support portion in the movement environment of the base by correcting the target upper body support portion motion by a process comprising at least an operation of correcting the target upper body support portion motion so that the lateral position deviation corresponding to the deviation between an actual lateral position of the base or the upper body support portion in the movement environment of the base and the predetermined lateral reference position approaches zero in response to an observed value of the lateral position deviation, controls the operation of the first actuator so that the base moves in response to the correction target upper body support portion motion, determines a target foot mount motion corresponding to a target motion of each of the foot mounts in response to an observed value of a motion state of at least each foot of the manipulator, and controls the operation of the second actuator in response to the target foot mount motion, and
a slave side control unit which controls the operation of the slave device in response to the determined slave side operation target,
wherein when a lateral position of any one of the upper body support portion, the upper body of the manipulator, and a center of gravity of the manipulator is defined as a master side reference portion lateral position and a lateral position of any one of the upper body and a center of gravity of the slave device is defined as a slave side reference portion lateral position, the operation target determination unit is configured to comprise a function of executing a first process and a second process,
the first process determines the target slave leg motion by using at least an observed value of a motion state of each foot of the manipulator with respect to the virtual floor formed in a pseudo manner by the foot mount on the support leg side. and
the second process determines the target slave upper body motion and the target upper body support portion motion by using an observed value of each of the master side reference portion lateral position and the slave side reference portion lateral position with respect to the virtual floor so that a relationship between the actual slave side reference portion lateral position and the master side reference portion lateral position with respect to the virtual floor close to satisfy a predetermined target corresponding relationship and a target value of the slave side reference portion lateral position defined by the slave side operation target matches or approaches the actual slave side reference portion lateral position.
